(19) United States
(12) Patent Application Publication
(10) Pub. No.: US 2008/0213682 A1
(43) Pub. Date: Sep. 4, 2008

(54) TONER FOR DEVELOPING ELECTROSTATIC IMAGE, METHOD FOR PRODUCING THE TONER, IMAGE FORMING METHOD, IMAGE FORMING APPARATUS AND PROCESS CARTRIDGE USING THE TONER

(76) Inventors: Akinori SAITOH, Numazu-shi (JP); Masahide Yamada, Numazu-shi (JP); Osamu Uchinokura, Mishima-shi (JP); Junichi Awamura, Numazu-shi (JP); Tomomi Suzuki, Numazu-shi (JP); Shinichiro Yagi, Numazu-shi (JP); Tomio Kondou, Numazu-shi (JP); Masashi Nagayama, Tokyo (JP); Hitoshi Iwatsuki, Numazu-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/040,451

(22) Filed: Feb. 29, 2008

(30) Foreign Application Priority Data
Mar. 2, 2007 (JP) 2007-052811
Mar. 19, 2007 (JP) 2007-071297

(51) Int. Cl. G03G 13/14; G03G 9/097; G03G 21/16

(52) U.S. Cl. 430/48; 430/108.2; 430/137.14; 399/111

(57) ABSTRACT

Provided is a toner for developing electrostatic image, comprising particles of oil phase containing at least a toner composition and/or toner composition precursor in an aqueous medium, wherein the toner composition and/or toner composition precursor comprises an organic-modified layered inorganic mineral prepared by modifying at least partially an ion of a layered inorganic mineral into an organic ion, and the organic ion-modification ratio X satisfies the relation of 100<X(%)<150 in the organic-modified layered inorganic mineral.

### BACKGROUND OF THE INVENTION

1. Field of the Invention

A first invention relates to a toner that is used for developers for developing electrostatic images in electrophotography, electrostatic recording, electrostatic printing, etc., and electrophotographic developing apparatuses that use the toner, more particularly to a toner for developing electrostatic image that is used for copiers, laser printers, and facsimiles on the basis of direct or indirect electrophotographic development systems, a method for producing the toner, and an image forming method, an image forming apparatus, and a process cartridge that use the toner.

A second invention relates to a color carrier and a developer used for developing electrostatic images in electrophotography, electrostatic recording, electrostatic printing, etc., and an image forming method, an image forming apparatus, and a process cartridge that use the toner.

2. Description of the Related Art

### First Invention

In electrophotography, latent electrostatic images are formed on latent electrostatic image bearing members through charging and exposing and then developed by developers containing toners to form toner images. The toner images are transferred onto recording media and fixed. The toners, which are out of transferring and thus remaining on the latent electrostatic image bearing members, are cleaned by cleaning members such as blades that are placed to press and contact with surfaces of the latent electrostatic image bearing members.

Milling processes have been employed heretofore for producing toners in the art. The milled toners are advantageous compared to toners on the basis of polymerization processes described later in terms of cleaning ability since the shape of toners on the basis of milling process is typically irregular, i.e. far from a certain orderly shape and non-round. However, milling processes typically exhibit a limited milling efficiency at finer particle sizes of toners, thus suffer from difficulty in forming high quality images since narrower distribution of particle sizes is unobtainable.

Toner production methods have hence been proposed on the basis of polymerization processes capable of producing toner particles with lower particle diameters and narrower particle size distribution.

However, the toners on the basis of the polymerization processes tend to be more spherical, by action of surface tension of droplets at dispersing processes, than the milled toners. Therefore, there arises a problem in blade cleaning systems that the spherical toners roll between cleaning blades and photoconductors to enter into their spaces and are hardly cleanable.

Under such circumstances, various methods have been proposed in order to improve cleaning ability by way of treating toner shape, specifically, the cleaning ability is addressed by way of changing the toner shape from spherical to irregular. The flowability of toner powder may be lowered and toners remaining on image bearing members may be easily stemmed using cleaning blades by way of making the toner shape irregular or deformed. On the other hand, excessively irregular or deformed toner shape may lead to unstable movement or behavior at developing etc., which resulting in poor reproducibility of fine dots.

Reliability as for cleaning ability may be improved by way of making the toner shape irregular as described above; on the other hand, however, there arises a problem in terms of fixability. The fixability degrades at lower temperatures from the fact that the packing density of toner decreases at the toner layer on transfer material before fixing due to irregular shape of the toner and thermal conductance delays at the toner layer during the fixing. When fixing pressure is lower than those of previous systems in particular, the thermal conductance is lower still more thus to disturb fixability at lower temperatures.

On the other hand, Japanese Patent Application Laid-Open (JP-A) Nos. 2003-202708 and 2003-515795 disclose that a charge control agent is created by way of modifying ions such as metal cations, existing between layers of layered inorganic compounds, into ions such as organic cations, and the charge control agent is used for electrophotographic toners.

In addition, Japanese Patent (JP-B) No. 3502993 discloses that quaternary ammonium ion is intercalated between layers of layered inorganic compounds, thereby the layered inorganic compounds are improved as for affinity with organic solvents and can exhibit stable dispersibility with certain organic solvents for a long period. However, these patent literatures disclose no more than a charge control agent that is effective to uniformly disperse organic-modified layered inorganic mineral substances in milled toners.

On the other hand, a method is proposed to make toner shape from spherical into irregular, in which toner ingredients as well as a toner filler are added to an organic solvent thereby to make the particles irregular (see JP-A No. 2005-49858). JP-A No. 2005-49858 describes that an organic filler, containing a layered mineral substance, is advantageously used as a filler; specifically, particles are made irregular by use of organosilica sol thereby to prepare toner resin particles that exhibit a shape with excellent blade cleaning ability and a broad range of fixable temperature. However, these proposals are still insufficient to satisfy both of cleaning ability and low temperature fixability since the filler exists at the surface layer of toner and impairs the low temperature fixability through disturbing soaking-out of waxes or inhibiting dissolving-out of binder resins.

Accordingly, such a toner and the related technologies have not been provided yet that can represent excellent low temperature fixability, form high quality images, and achieve irregular shape assurable for the cleaning ability for a long period even produced by a polymerization process, thus further improvement and development thereof are demanded currently.

### Second Invention

As an example of electrophotography, latent electrostatic images are formed on latent electrostatic image bearing members through charging and exposing and then developed by developers containing toners to form toner images. The toner images are further transferred onto recording media and fixed. On the other hand, the toners, which are out of transferring and thus remaining on the latent electrostatic image bearing members, are cleaned by cleaning members such as blades that are placed to press and contact with surfaces of the latent electrostatic image bearing members.

Meanwhile, milling processes have been employed heretofore for producing toners in the art. In the milling processes, colorants and optional additives are added to thermoplastic resins as binder resin, and the mixture is melted and kneaded and then milled and classified to prepare a toner. However, the resulting toners have larger particle diameters, which making difficult to form high quality images.

Toner production methods have been hence employed using polymerization processes or emulsion dispersion processes. The polymerization processes are exemplified by suspension polymerization processes in which a monomer, polymerization initiator, colorant, charge control agent, etc. are added to an aqueous medium with a dispersant while stirring them to form oil droplets which are then polymerized. Association processes have also been employed in which particles, produced by emulsion polymerization or suspension polymerization, are agglomerated and fused.

These processes may bring about lower particle diameters of toners; however, main ingredients of binder resins are limited to polymers obtainable through radical polymerization, thus toners cannot be produced using binder resins mainly containing polyester resins or epoxy resins that are adapted to color toners.

A method for producing toner on the basis of an emulsion dispersion process is hence proposed in which a mixture such as of a binder resin and a colorant is mixed with an aqueous medium to be emulsified (see e.g., JP-A Nos. 05-66600 and 08-211655), which may respond to the requirement for deceasing particle diameter of toner and also allow to select binder resins from a wider range. However, this method generates fine particles and thus yields an emulsion loss.

A method for producing toner is hence proposed in which a polyester resin is emulsified and dispersed, then the resulting particles are agglomerated and fused to produce a toner (see e.g., JP-A Nos. 10-020552 and 11-007156), which may mitigate the emulsion loss because of suppressing fine particles.

However, toners on the basis of the polymerization processes and the emulsion dispersion processes tend to become spherical by action of surface tension of droplets at dispersing processes. Therefore, there arises a problem in blade cleaning systems that the spherical toners roll between cleaning blades and photoconductors to enter into their spaces and are hardly cleanable.

A method is hence proposed in which particles are made into irregular by way of applying mechanical force to the particles through stirring at a high velocity before completing polymerization (see e.g., JP-A No. 62-266550).

However, there arises such a problem in this method that particles tend to coagulate each other due to unstable dispersion condition.

A method is also proposed in which coagulated particles having particle diameters of 5 to 25 μm are produced by way of coagulating particles using a polyvinyl alcohol with a certain saponification degree as a dispersant. However, the resulting coagulated particles possibly suffer from larger particle diameters.

A method is also proposed in which particles are made irregular by way of adding toner ingredients as well as a filler in organic solvents (see e.g., JP-A No. 2005-49858).

In cases of adding filler into toners, however, lower-limit fixing temperature may be adversely affected due to higher viscous elasticity of the toners. When fillers exist at surface of toners, soaking-out of waxes or dissolving-out of binder resins is possibly disturbed and also low temperature fixability and hot offset resistance are adversely affected, although there appears almost no increase of viscous elasticity of the toners.

Charge control agents have also been created by way of modifying ions such as metal cations, existing between layers of layered inorganic compounds, into ions such as organic cations, and the charge control agents are proposed to use for electrophotographic toners (see e.g., JP-A Nos. 2003-515795, 2006-500605, 2006-503313, and 2003-202708).

On the other hand, carriers are typically treated to provide a hard coating layer with higher strength by way of applying a coating etc. with an appropriate resin material in order to prevent filming of toner ingredients of carrier surface, form uniform carrier surface, prevent oxidation of surface, prevent decrease of moisture sensitivity, prolong operating life of developers, prevent carrier adhesion on photoconductor surface, protect photoconductors from flaws or ablation due to carriers, control charge polarity, adjust charge amount, or the like.

There have been proposed, for example, a carrier coated with a specific resin material (see e.g., JP-A No. 58-108548), addition of various additives to a coating layer on carrier (see e.g., JP-A Nos. 54-155048, 57-40267, 58-108549, and 59-166968, Japanese Patent Application Publication (JP-B) Nos. 01-19584 and 03-628, JP-A Nos. 06-202381 and 2003-345070), deposition of additives on carrier surface (see e.g., JP-A No. 05-273789), a carrier of which coating layer contains electrically conductive (hereinafter simply referred to as “conductive”) particles larger than the thickness of the coating layer (see e.g., JP-A No. 09-160304), or the like.

There are also proposed a carrier-coating material that contains a benzoguanamine-n-butyl alcohol-formaldehyde copolymer as a main component (see e.g., JP-A No. 08-6307), a carrier-coating material of cross-linked substance of a melamine resin and an acrylic resin (see e.g., JP-B No. 2683624), and the like.

However, all of the proposals described above are still insufficient with respect to durability and suppression of carrier adhesion. That is, it is necessary to improve the durability since there are such problems as toner-spent onto carrier surface, unstable charge amount induced therefrom, loss of coating layer due to film scraping of coating resin, and decrease of resistivity induced therefrom, specifically, proper images are initially obtainable but image quality of copied images degrades as the copy number increases.

Still further, demands for higher velocity and greater beauty have been increasing more and more, and also speed-up of machines is remarkable in recent years. Consequently, stress on developers has dramatically increased, thus carriers, being of longer operating life previously, are insufficient for operating life nowadays. In addition, carbon black has been often used heretofore as a resistance control agent; however, it is likely that the carbon black migrates into color images to cause color smear though film scraping and/or separating the carbon black, thus various methods have been proposed heretofore to address these problems and certain effects have been brought about.

For example, a carrier is proposed in which a conductive material (carbon black) exists at surface of core material and no conductive material exists within coating layer of resins (see e.g., JP-A No. 07-140723). A carrier is also proposed in which a coating layer of resin represents a gradient of carbon black concentration in the thickness direction, the concentration of carbon black decreases toward the surface of the coating layer, and no carbon black exists at the surface of the coating layer (see e.g., JP-A No. 08-179570). A carrier having two coating layers is also proposed in which an inner coating layer containing conductive carbon is provided at surface of core particles and a surface-coating resin layer containing a white-type conductive material is disposed thereon (see e.g., JP-A No. 08-286429). However, the carrier should be improved since there arises a problem of color smear due to higher stress in recent years.

It is obviously most effective in particular that no carbon black, which being the origin of color smear, is used for addressing essentially the color smear. When the carbon black is merely excluded, resistance of the carrier increases because of the property of carbon black with lower resistances as described above.

In cases where carriers with lower resistances are employed for developers, usually, the resulting images are provided sharply with a so-called edge effect such that image density is very thin at central portion and dense only at edge portions in copy images of larger area. In cases where images are characters or thin limes, the edge effect may result in clear images, but there arises such a drawback that reproducibility of images is very poor in cases of grey level images.

Titanium oxide and zinc oxide, for example, are publicly known as resistance control agent other than carbon black, however, the resistance reducing effect is insufficient for replacing the carbon black, thus the problems are still remaining.

In addition, in order to provide conductivity, a power production method is proposed in which an upper layer of indium oxide layer containing tin dioxide and a lower layer of tin dioxide are applied on surface of white inorganic pigment particles (see e.g., JP-B No. 2959927) and also a composition containing the powder and a resin is proposed (see e.g., JP-B No. 2959928).

### BRIEF SUMMARY OF THE INVENTION

The objects of the first invention are as follows:

(A-1) To provide a toner that is deformed into an appropriate shape;

(A-2) To provide a toner and an image forming apparatus that exhibit high reliability in cleaning;

(A-3) To provide a toner and an image forming apparatus that exhibit excellent low temperature fixability;

(A-4) To provide a toner and an image forming apparatus that attain the objects of (A-1) and (A-2) equivalently;

(A-5) To provide a toner and an image forming apparatus in which transfer efficiency is excellent, transfer residual toner is less, and high quality images are obtainable;

(A-6) To provide a toner that satisfies both of charge stability and low temperature fixability; and

(A-7) To provide a novel toner in which electrical power consumption is lower and high transferability necessary for color images as well as OHP transparency are satisfied at a high level.

The inventors of the first invention have completed the present invention to solve the problems described above. That is, a toner, an image forming method, and an image forming apparatus are provided in accordance with the present invention as follows:

(a-1) A toner for developing electrostatic image, comprising particles of oil phase containing at least a toner composition and/or toner composition precursor in an aqueous medium, wherein the toner composition and/or toner composition precursor comprises an organic-modified layered inorganic mineral prepared by modifying at least partially an ion of a layered inorganic mineral into an organic ion, and the organic ion-modification ratio X satisfies the relation of 100<X(%)≦150 in the organic-modified layered inorganic mineral.

(a-2) The toner for developing electrostatic image according to (a-1), wherein the oil phase comprises a kneaded mixture of the organic-modified layered inorganic mineral and a binder resin.

(a-3) The toner for developing electrostatic image according to (a-1) or (a-2), wherein the oil phase comprises an organic solvent.

(a-4) A toner for developing electrostatic image, wherein the toner is produced by way of dissolving or dispersing at least a polymer having a site capable of reacting with a compound having an active hydrogen group, a binder resin, a colorant, a releasing agent, and a kneaded mixture of an organic-modified layered inorganic mineral, prepared by modifying at least partially an ion of a layered inorganic mineral into an organic ion, and a binder resin in an organic solvent, dispersing the solution or dispersion in an aqueous medium containing resin fine particles, and removing the organic solvent while or after reacting the polymer having a site capable of reacting with the compound having an active hydrogen group, then rinsing and drying, wherein the organic ion-modification ratio X satisfies the relation of 100<X(%)<150 in the organic-modified layered inorganic mineral.

(a-5) The toner for developing electrostatic image according to any one of (a-1) to (a-4), wherein the toner has a shape factor SF-1 of 110 to 200 and a shape factor SF-2 of 110 to 300.

(a-6) The toner for developing electrostatic image according to any one of (a-1) to (a-5), wherein the content of the organic-modified layered inorganic mineral is 0.1% to 5% by mass in the toner for developing electrostatic image.

(a-7) The toner for developing electrostatic image according to any one of (a-1) to (a-6), wherein the organic ion for modifying the organic-modified layered inorganic mineral is a quaternary ammonium ion.

(a-8) The toner for developing electrostatic image according to any one of (a-1) to (a-7), wherein the toner for developing electrostatic image has a volume average particle diameter Dv of 3 μm to 7 μm.

(a-9) The toner for developing electrostatic image according to any one of (a-1) to (a-8), wherein the toner for developing electrostatic image has a ratio (volume average particle diameter Dv)/(number average particle diameter Dn) of 1.00 to 1.20.

(a-10) The toner for developing electrostatic image according to any one of (a-1) to (a-9), wherein content of particles having a particle diameter of no more than 2 μm is 1% to 10% by number.

(a-11) The toner for developing electrostatic image according to any one of (a-1) to (a-10), wherein the binder resin comprises a polyester resin.

(a-12) The toner for developing electrostatic image according to (a-11), wherein content of the polyester resin is 50% to 100% by mass in the binder resin.

(a-13) The toner for developing electrostatic image according to (a-11) or (a-12), wherein mass average molecular mass of THF soluble matter of the polyester resin is 1,000 to 30,000.

(a-14) The toner for developing electrostatic image according to any one of (a-11) to (a-13), wherein acid value of the polyester resin is 1.0 mgKOH/g to 50.0 mgKOH/g.

(a-15) The toner for developing electrostatic image according to any one of (a-11) to (a-14), wherein the polyester resin has a glass transition temperature of 35° C. to 65° C.

(a-16) The toner for developing electrostatic image according to any one of (a-1) to (a-15), wherein the polymer, having a site capable of reacting with a compound having an active hydrogen group, has a mass average molecular mass of 3,000 to 20,000.

(a-17) The toner for developing electrostatic image according to any one of (a-1) to (a-16), wherein the toner for developing electrostatic image has an acid value of 0.5 mgKOH/g to 40.0 mgKOH/g.

(a-18) The toner for developing electrostatic image according to any one of (a-1) to (a-17), wherein the toner for developing electrostatic image has a glass transition temperature of 40° C. to 70° C.

(a-19) The toner for developing electrostatic image according to any one of (a-1) to (a-18), wherein the toner for developing electrostatic image is used for a two-component developer.

(a-20) A method for producing a toner for developing electrostatic image, comprising dispersing an oil phase containing at least a toner composition and/or toner composition precursor in an aqueous medium to form particles, wherein the oil phase comprises a kneaded mixture of an organic-modified layered inorganic mineral, prepared by modifying at least partially an ion of a layered inorganic mineral into an organic ion, and a binder resin, and the organic ion-modification ratio X satisfies the relation of 100<X(%)≦150 in the organic-modified layered inorganic mineral.

(a-21) A method for producing a toner for developing electrostatic image, comprising dissolving or dispersing at least a polymer having a site capable of reacting with a compound having an active hydrogen group, a binder resin, a colorant, a releasing agent, and a kneaded mixture of an organic-modified layered inorganic mineral, prepared by modifying at least partially an ion of a layered inorganic mineral into an organic ion, and a binder resin in an organic solvent, dispersing the solution or dispersion in an aqueous medium containing resin fine particles, and removing the organic solvent while or after reacting the polymer having a site capable of reacting with a compound having an active hydrogen group, then rinsing and drying, wherein the organic ion-modification ratio X satisfies the relation of 100<X(%)≦150 in the organic-modified layered inorganic mineral.

(a-22) An image forming method, comprising a transfer step to transfer a toner image on a toner image bearing member onto a transfer material and a cleaning step to clean the toner remaining on surface of the toner image bearing member after the transfer step by use of a blade, wherein the toner is one for developing electrostatic image according to any one of (a-1) to (a-19).

(a-23) An image forming apparatus, comprising a transfer unit configured to transfer a toner image on a toner image bearing member onto a transfer material and a cleaning unit configured to clean the toner remaining on surface of the toner image bearing member after the transfer step by use of a blade, wherein the toner is one for developing electrostatic image according to any one of (a-1) to (a-19).

(a-24) A process cartridge, equipped with ones selected from a toner bearing member, a charging unit, a developing unit, and a cleaning unit, constructing together with at least the toner bearing member and the developing unit, and being detachably attached to a main body of an image forming apparatus, wherein the developing unit is provided with a toner, and the toner is one for developing electrostatic image according to any one of (a-1) to (a-19).

The toner of the first invention is characterized in that it comprises an organic-modified layered inorganic mineral prepared by modifying at least partially an ion of a layered inorganic mineral into an organic ion and the organic ion-modification ratio X satisfies the relation of 100<X(%)≦150 in the organic-modified layered inorganic mineral, thereby, a deformed toner for developing electrostatic image is provided that can exhibit excellent low temperature fixability, form high quality images, and represent stably cleaning ability for a long period, and also a method for producing the toner, a process cartridge, an image forming method, and an image forming apparatus that utilize the toner are provided.

The second invention has been made in view of the prior art described above and provides a carrier for electrophotographic developer (hereinafter sometimes referred to as “carrier”) that contains the carrier and a negative charge toner that has an average circularity of 0.925 to 0.970 and is formed into particles by way of dispersing and/or emulsifying an oil phase and/or monomer phase (containing at least a toner composition and/or toner composition precursor) into an aqueous medium and also provides an electrophotographic carrier. Specific objects are as follows.

(B-1) To provide a carrier for electrophotographic developer and an electrophotographic developer that can provide images having excellently resistance, far from edge effects, and fine texture for a long period, and also free from color smear;

(B-2) To provide an electrophotographic developer (oilless dry developer) having both of charge stability and low temperature fixability.

In addition, provided are an image forming method that uses the inventive electrophotographic developer, a process cartridge that contains the electrophotographic developer, and an image forming apparatus that mounts the process cartridge. Specifically, the objects are as follows.

(B-3) To provide an image forming method, a process cartridge, and an image forming apparatus that can represent high quality images with reproducibility of fine dots and low temperature fixability by virtue of the toner supplied by the carrier of the electrophotographic developer.

(B-4) To provide in particular an image forming method, a process cartridge, and an image forming apparatus that can exhibit high reliability in cleaning by virtue of the toner supplied by the carrier of the electrophotographic developer.

The present inventors have investigated vigorously and have found that the objects can be attained by the invention described in (b-1) to (b-12). The present invention will be explained specifically in the following.

The objects described above can be attained by the carrier for electrophotographic developer, which is used for an electrophotographic developer containing a negative charge toner and the carrier, in which the negative charge toner comprises a binder resin, a colorant, and a layered inorganic mineral of which at least a part of ions between layers being modified by an organic ion, and is formed into particles by way of dispersing and/or emulsifying an oil phase and/or monomer phase containing at least a toner composition and/or toner composition precursor into an aqueous medium, and has an average circularity of 0.925 to 0.970; and the carrier has a coating layer that contains a binder resin and conductive fine particles on core material of the carrier.

(b-2) The carrier for electrophotographic developer according to (b-1), wherein the amount ratio of the conductive fine particles to the carrier core material satisfies the value of coating ratio of 50% or more obtained from Equation (1) below, and the ratio Df/h satisfies the relation of 0.5<Df/h<1.5,

coating ratio=(Ds×ρs×W)/(4×Df×ρf)×100

in which Ds: particle diameter of carrier core material, ρs: absolute specific gravity of carrier core material, W: amount ratio of conductive fine particles to carrier core material, Df: particle diameter of conductive fine particle, h: thickness of the coating layer, ρf: absolute specific gravity of conductive fine particles.

The range of the coating ratio can prevent toner spent to carrier, suppress change of charge amount with time, and allow to charge stably.

(b-3) The carrier for electrophotographic developer according to (b-1) or (b-2), wherein volume resistivity of the carrier is no less than 10 [log(Ω·cm)] and no more than 16 [log (Ω·cm)].

The range of the volume resistivity of the carrier can lead to non-adhesion of the carrier at non-image portions and avoid edge effect.

(b-4) The carrier for electrophotographic developer according to any one of (b-1) to (b-3), wherein volume average particle diameter of the carrier is 20 μm to 65 μm.

The range of the volume average particle diameter of the carrier can lead to significant improvement in carrier adhesion and image quality.

(b-5) The carrier for electrophotographic developer according to any one of (b-1) to (b-4), wherein the binder resin of the carrier comprises a silicone resin.

The silicon resin in the binder resin of the carrier can suppress effectively spent of toner ingredients.

(b-6) The carrier for electrophotographic developer according to any one of (b-1) to (b-5), wherein the binder resin of the carrier is a mixture of an acrylic resin and a silicone resin.

The mixture of an acrylic resin and a silicone resin can improve effectively adhesive property etc. of the coating layer to suppress degradation such as scraping of the coating layer or peeling of the film.

(b-7) The carrier for electrophotographic developer according to any one of (b-1) to (b-6), wherein magnetic moment of the carrier is 40 to 90 Am²/kg in an applied magnetic field of 1000 (10³/4π·A/m).

The magnetic moment in the range can appropriately maintain retaining force between carrier particles, thus dispersing or mixing of the toner into the carrier or developer is rapid and proper and ear or spike of the developer is properly maintained at developing stage.

(b-8) The carrier for electrophotographic developer according to any one of (b-1) to (b-7), wherein the conductive fine particles are inorganic fine particles that are surface-treated with indium oxide.

The inorganic fine particles, surface-treated with indium oxide, as the conductive fine particles can avoid the problem of color smear by virtue of its approximately while color.

(b-9) The objects described above can be attained by an electrophotographic developer comprising a negative charge toner that contains a binder resin, a colorant, and a layered inorganic mineral of which at least a part of ions between layers being modified by an organic ion, is formed into particles by way of dispersing and/or emulsifying an oil phase and/or monomer phase containing at least a toner composition and/or toner composition precursor into an aqueous medium, and has an average circularity of 0.925 to 0.970 and the carrier for electrophotographic developer according to any one of (b-1) to (b-8).

The objects described above can be attained by an image forming method that comprises a step of forming a latent electrostatic image on an image bearing member, a step of forming a visible image by developing the latent electrostatic image using a developer comprising a carrier and a toner, and a step of transferring and fixing the visible image onto a recording member and uses the electrophotographic developer according to (b-9) as the developer.

(b-11) The objects described above can be attained by a process cartridge, equipped with ones selected from a photoconductor, a charging unit, a developing unit, and a cleaning unit, constructing together with at least the photoconductor and the developing unit, and being detachably attached to a main body of an image forming apparatus, wherein the developing unit is provided with the electrophotographic developer according to (b-9).

(b-12) The objects described above can be attained by an image forming apparatus that comprises a photoconductor, a developing unit configured to form an image on the photoconductor, a transfer unit configured to transfer the image on the photoconductor onto a transfer material, and a fixing unit configured to fix the image on the transfer material and mounts the process cartridge according to (b-11).

In accordance with the carrier for electrophotographic developer of the second invention, toner spent can be avoided and also charge rise can be suppressed, and images having excellently resistance, far from edge effects, and fine texture can be formed without color smear for a long period. The electrophotographic developer formed of the carrier and the negative charge toner can be favorably used as an oilless dry developer.

The electrophotographic developer of the second invention can be favorably used as an oilless dry developer that satisfies both of charge stability and low temperature fixability, and images with fine texture and excellent resistance can be formed for a long period while avoiding occurrences of edge effect and color smear.

In accordance with the image forming method of the second invention, high quality images can be formed for a long period because of high reliability in cleaning and excellent low temperature fixability and reproducibility of fine dots by virtue of the electrophotographic developer.

In accordance with the process cartridge of the second invention, the electrophotographic developer is employed, thus high quality images can be formed with superior reproducibility of fine dots, excellent low temperature fixability, and highly reliable cleaning by virtue of the toner supplied by the carrier of the electrophotographic developer.

In accordance with the image forming apparatus of the second invention, the process cartridge is mounted, thus high quality images can be formed without edge effects or color smear with fine texture for a long period.

### BRIEF DESCRIPTION OF THE SEVERAL VIEWS OF THE DRAWINGS

FIG. 1 is an exemplary view that schematically shows a cross section of an image forming apparatus.

FIG. 2 is a conceptual view that schematically shows the relation between a particle diameter Df of conductive fine particles and a thickness “h” of coating layer in an inventive carrier for electrophotographic developer.

FIG. 3 is a schematic view that shows a construction of a resistance meter to measure volume resistivity of the inventive carrier for electrophotographic developer.

FIG. 4 is an exemplary view that shows a construction of an inventive process cartridge that contains an inventive electrophotographic developer.

FIG. 5 is an exemplary view that shows a construction of an inventive image forming apparatus that mounts an inventive process cartridge.

FIG. 6 is a schematic view that shows a powder resistivity meter to measure powder resistivity of the conductive fine particles in Examples.

### DETAILED DESCRIPTION OF THE INVENTION

It is necessary that the organic ion-modification ratio X satisfies the relation of 100<X(%)≦150 in the organic-modified layered inorganic mineral. When X is no more than 100% or above 150%, the effects on toner shape and toner charging ability may be poor.

The term “organic ion-modification ratio” in the organic-modified layered inorganic mineral means the ratio of organic ion (mole) to exchangeable metal ion (mole) in layered inorganic mineral, dispersed in water, prior to organic modification, as expressed by Equation (1) below:

organic ion-modification ratio=[organic ion (mole)/metal ion (mole) between layers of layered inorganic mineral]×100 :Equation (1)

It is preferred that the oil phase contains the kneaded mixture of the organic-modified layered inorganic mineral and the binder resin in view of uniform dispersibility. The kneaded mixture of the organic-modified layered inorganic mineral and the binder resin, i.e. masterbatch thereof, may be produced by mixing and kneading the binder resin and the organic-modified layered inorganic mineral after modifying with an organic cation under high shear force. In this process, an organic solvent may be used in order to enhance interaction between the organic-modified layered inorganic mineral and the binder resin. A so-called flushing process may also be preferably employed in which an aqueous paste of the organic-modified layered inorganic mineral and water, a resin, and an organic solvent are mixed and kneaded to migrate the organic-modified layered inorganic mineral into the resin and then moisture and the organic solvent are removed, which allows to use the wet cake without drying. The mixing and kneading is favorably carried out using high-shear dispersing devices such as three-roll mills.

The production method or raw materials of the inventive toner may be properly selected from conventional ones depending on the application as long as the limitations describes above are satisfied; for the purposes of wide selectability of resins, adequate low temperature fixability, excellent granulating ability, and easy control of particle diameter, distribution, and shape, it is preferred that the toner is produced by way of dissolving or dispersing at least a polymer having a site capable of reacting with a compound having an active hydrogen group, a binder resin, a colorant, a releasing agent, and the kneaded mixture of the organic-modified layered inorganic mineral, prepared by modifying at least partially the ion of a layered inorganic mineral into an organic ion, and the binder resin in an organic solvent, dispersing the solution or dispersion in an aqueous medium containing resin fine particles, removing the organic solvent while or after reacting the polymer having a site capable of reacting with a compound having an active hydrogen group, then rinsing and drying.

Toners, having smaller particle diameters and uniform particle diameters, are problematic in terms of cleaning ability as described above, therefore, the toner has preferably a shape factor SF-1 in a range of 110 to 200 and a shape factor SF-2 in a range of 110 to 300. Initially, the relation between toner shape and transferability will be discussed. In cases where full color copiers are used that transfer on the basis of multi-color development, it is difficult to enhance transfer efficiency by virtue of merely using conventional irregular toners since toner amount on photoconductors increases compared to monochrome black toner in monochrome copiers. Furthermore, in cases where conventional irregular toners are used, fusion or filming of the toners tends to generate on surface of photoconductors or intermediate transfer bodies because of rubbing force or sliding force between photoconductors and cleaning members, between intermediate transfer bodies and cleaning members, or between photoconductors and intermediate transfer bodies, thus transfer efficiency tends to drop. When full color images are formed, four-color toner images are unlikely to be transferred uniformly; furthermore, when intermediate transfer bodies are employed, there possibly arise problems in color nonuniformity or balance, thus it is uneasy to output stably full color images with high quality.

The toner has the shape factor of 110 to 200 in view of the balance between blade cleaning and transfer efficiency, preferably 120 to 180 for satisfying both of blade cleaning and transfer efficiency. The cleaning and transferability greatly depend also on materials or contacting conditions of blades and the transfer also depends on process conditions, thus these may be designed depending on processes within the range of SF-1 described above. However, it is difficult to clean blades when SF-1 is less than 110 and the transferability tends to degrade when SF-1 is more than 200. These phenomena are derived from the fact that irregular or deformed toner shape prevents smooth transportation of toners at transfer steps such as from photoconductor surface to transfer paper, from photoconductor surface to intermediate transfer belts, and from first intermediate transfer belts to second intermediate transfer belts, these behaviors come to differ between toner particles, and thus uniform and high transfer efficiency are unobtainable. In addition, unstable charge or brittleness of particles comes to apparent; toners come to finer in developers, which is a factor to decrease durability of developers.

The milled toners have an irregular shape (far from a certain orderly shape, and non-round) and a shape factor SF-1 of above 140, but the particle diameter distribution is typically broad, thus processes to produce toners having Dv/Dn of no more than 1.30 are ineffective. As regards polymerization processes to produce toners, it is difficult to use polyester resins in suspension or emulsion processes, which suggesting no possibility to address requirements for further lower temperature fixability. JP-A Nos. 11-149180 and 2000-292981 propose a dry toner that consists of a toner binder prepared through elongation reaction and/or cross-linking reaction of an isocyanate group-containing prepolymer, and a colorant, in which the dry toner is of particles prepared from the prepolymer (A) through the elongation reaction and/or cross-linking reaction with amines (B); however, the toner shape is different from that defined in the present invention, the transferability and the cleaning ability are hence unsatisfactory at the same time.

Accordingly, the present invention employs the toner production method by way of dissolving or dispersing at least a polymer having a site capable of reacting with a compound having an active hydrogen group, a binder resin, a colorant, a releasing agent, and the kneaded mixture of the organic-modified layered inorganic mineral, prepared by modifying at least partially the ion of a layered inorganic mineral into an organic ion, and the binder resin in an organic solvent, dispersing the solution or dispersion in an aqueous medium containing resin fine particles, removing the organic solvent while or after reacting the polymer having a site capable of reacting with a compound having an active hydrogen group, then rinsing and drying, in which the organic-modified layered inorganic mineral and the binder resin are kneaded and mixed in a kneading-mixing step in order to arrange the organic-modified layered inorganic mineral, prepared by modifying at least partially the ion of a layered inorganic mineral into an organic ion, to an adequate dispersing condition in the toner, and the kneaded mixture is dissolved or dispersed, thereby toner may be easily produced having the shape factor SF-1 of 110 to 200 and the shape factor SF-2 of 110 to 300.

The shape factors SF-1 and SF-2, which expressing circularity in the present invention, may be determined, for example and not limited thereto, by way of taking SEM images of a toner by FE-SEM (S-4200, by Hitachi Ltd.), sampling randomly 300 images, inputting the image data into an image analysis apparatus (Luzex AP, by Nireco Co.) through an interface, and calculating from the equations below.

SF-1=(L²/A)×(π/4)×100

SF-2=(P²/A)×(¼π)×100

in which, L: absolute maximum length of toner, A: projected area of toner, P: maximum boundary length.

In cases where toner particles are exactly spherical, both of SF-1 and SF-2 are 100; the higher is the value apart from 100, the shape becomes more irregular. SF-1 typically represents overall shape such as ellipse or sphere, and SF-2 represents irregularity or roughness of toner surface.

It is preferred that the content of the organic-modified layered inorganic mineral modified by an organic cation is 0.1% to 5% by mass in the toner. When the content is below 0.1% by mass, the effects on toner shape and toner charging ability may be poor, and when the content is above 5% by mass, the fixability is possibly impaired.

The organic-modified layered inorganic mineral, used for the inventive toner, is desirably prepared by modifying an inorganic mineral having a basic crystal structure of smectite type by an organic ion. Examples of layered inorganic mineral, modified by an organic ion, include montmorillonite or bentonite, beidellite, nontronite, saponite, hectorite, etc.

The compounds for modifying by an organic ion to prepare the organic-modified layered inorganic mineral are exemplified by quaternary alkyl ammonium salts, phosphonium salts, and imidazolium salts; and quaternary alkyl ammonium salts are preferable. Specific examples of the quaternary alkyl ammonium salts are trimethyl stearyl ammonium, dimethyl stearyl benzylammonium, dimethyl octadecyl ammonium, oleylbis(2-hydroxyethyl)methylammonium.

It is preferred that the inventive toner has a volume average particle diameter Dv of 3.0 to 7.0 μm. It is generally said that the smaller is the particle diameter of toners the more advantageous is for forming images with high resolution and high quality, however, the smaller particle diameter is disadvantageous for transferability and cleaning ability. Furthermore, when the volume average particle diameter Dv is smaller than the range described above, toners tend to fuse to surface of carriers under prolonged stirring in developing devices to decrease charging ability of carriers in cases of two-component developers, and toners tend to generate on developing rollers or to fuse on thin-layering members such as blades in cases of one-component developers. These phenomena greatly relate to content of fine powder, and the content of above 10% by number of particle diameter no more than 2 μm may be problematic as regards carrier adhesion or charging stability at high level. When the volume average particle diameter Dv is larger than the range described above, it is difficult to form images with high resolution and high quality, and also the particle diameter of toner often fluctuates along with inflow and outflow of toners in developers.

It is preferred in the inventive toner that the ratio Dv/Dn of volume average particle diameter Dv and number average particle diameter Dn is 1.00 to 1.30. The condition is preferable to form images with high resolution and high quality, and also in two-component developers, fluctuation of particle diameter of toners in developers may be low even under inflow and outflow of toners for a long period, and proper and stable development may be carried out even under prolonged stirring at developing devices. When Dv/Dn is above 1.30, the particle diameters of toner particles tend to fluctuate considerably, toner behavior may vary at development etc., fine dots may impair reproducibility, and high quality images are difficult to obtain. More preferably, Dv/Dn is in a range of 1.00 to 1.20 to form more excellent images.

Average particle diameter and particle size distribution are measured in accordance with Coulter Counter processes. The average particle diameter and the particle diameter distribution of toners can be measured using Coulter Counter TA-IL or Coulter Multisizer II (by Beckman Coulter, Inc.). In the present invention, Coulter Counter TA-II model was used with connecting an interface (by The Institute JUSE) and a personal computer (PC9801, by NEC Co.) which outputs number distributions and volume distributions.

The measurement process will be explained in the following. Initially, 0.1 to 5 mL of a surfactant, preferably alkylbenzene sulfonate, is added as a dispersant into 100 to 150 mL of an aqueous electrolyte solution. The aqueous electrolyte solution is an about 0.1% NaCl aqueous solution, which is prepared from ISOTON-II (by Beckman Coulter, Inc.). A sample of 2 to 20 mg is added to the electrolyte solution, which is then ultrasonically dispersed for 1 to 3 minutes using a ultrasonic dispersing device, thereafter volume and number of the toner particles are measured by the Coulter counter TA-II using an aperture of 100 μm to calculate the volume distribution and the number distribution, from which the volume average particle diameter and the number average particle diameter are determined.

In order to measure particles having a particle diameter of no less than 2.00 μm to less than 40.30 μm, thirteen channels are used such as 2.00 μm≦Pd<2.52 μm, 2.52 μm≦Pd<3.17 μm, 3.17 μm≦Pd<4.00 μm, 4.00 μm≦Pd<5.04 μm, 5.04 μm≦Pd<6.35 μm, 6.35 μm≦Pd<8.00 μm, 8.00 μm≦Pd<10.08 μm, 10.08 μm≦Pd<12.70 μm, 12.70 μm≦Pd<16.00 μm, 16.00 μm≦Pd<20.20 μm, 20.20 μm≦Pd<25.40 μm, 25.40 μm≦Pd<32.00 μm and 32.00 μm≦Pd<40.30 μm. From these data, volume average particle diameter Dv and number average particle diameter Dn are determined on the basis of volume distribution and number distribution, then the ratio Dv/Dn is determined.

The rate of particles having a particle diameter of no more than 2 μm and circularity of the inventive toner may be measured using a flow-type particle image analyzer FPIA-2000 (by Sysmex Co.). Specifically, 0.1 to 0.5 mL of a surfactant, preferably alkylbenzene sulfonate, is added as a dispersant into 100 to 150 mL of pure water, to which about 0.1 to 0.5 g of a sample is added. The dispersion containing the sample is ultrasonically dispersed for about 1 to 3 minutes using an ultrasonic dispersing device, the dispersion concentration is adjusted to 3,000 to 10,000/μL, and then the shape and the distribution of the toner are measured.

On the basis of investigations of the present inventors in order to exhibit low temperature fixability more efficiently and to apply offset resistance after modifying by the prepolymer while maintaining high-temperature storage stability, it is preferred that polyester resin is used as the binder resin and the mass average molecular mass of the THF soluble matter of the polyester resin is 1,000 to 30,000. The reason is that the mass average molecular mass of less than 1,000 possibly deteriorates high-temperature storage stability due to higher content of oligomer components, and the mass average molecular mass of more than 30,000 possibly deteriorates offset resistance since modification by the prepolymer may be insufficient due to steric hindrance.

The molecular mass of the binder resin may be measured in the present inventive based on GPC (gel permeation chromatography) as follows. A column is conditioned stably within a heat chamber at 40° C., THF as a solvent is flowed into the column at 1 mL/min under the temperature, and a THF sample solution, adjusted at a concentration of 0.05% to 0.6% by mass, is injected and measured in an amount of 50 to 200 μL. The molecular mass distribution of samples is calculated and determined on the basis of a relation between logarithmic values of a calibration curve formed from a number of mono-dispersion polystyrene standards and a counted number. The polystyrene standards for the calibration curve are those having a molecular mass of 6×10², 2.1×10³, 4×10³, 1.75×10⁴, 5.1×10⁴, 1.1×10⁵, 3.9×10⁵, 8.6×10⁵, 2×10⁶, and 4.48×10⁶ (by Pressure Chemical Co. or Tosoh Co.), preferably at least about 10 samples of standard polystyrenes are utilized. The detector is a RI (refractive index) detector.

When acid value of the polyester resin is adjusted to 1.0 to 50.0 mgKOH/g, particle diameter may be possible by addition of basic compounds, and also toner properties such as particle low temperature fixability, hot offset resistance, high temperature storage stability, and charge stability may be enhanced still more. That is, when the acid value is above 50.0 mgKOH/g, elongation reaction or cross-linking reaction of modified polyester is insufficient, and the hot offset resistance may be adversely affected, and when the acid value is below 1.0 mgKOH/g, the effect to stabilize dispersion may be unobtainable from basic compounds and the elongation reaction or cross-linking reaction of modified polyester tends to excessively rapid, which being problematic for production stability.

The acid value of the polyester resin may be measured in accordance with JIS K0070 in the present invention, in which dioxane or THF is used as the solvent when the sample is insoluble.

The acid value may be determined by the following procedures.

Measuring device: Potentiometric Automatic Titrator DL-53 (by Mettler-Toledo K.K.)

Electrode: DG113-SC (Mettler-Toledo K. K.)

Analysis software: LabX Light Version 1.00.000

Correction: use of mixture solvent of toluene 120 mL and ethanol 30 mL

Measuring temperature: 23° C.
Measuring conditions are as follows:

Stir
Speed (%): 25
Time (s): 15

EQP titration
Titrant/Sensor
   Titrant: CH₃ONa
   Concentration (mole/L): 0.1
   Sensor: DG115
   Unit of measurement: mV
Predispensing to volume
   Volume (mL): 1.0
   Wait time (s): 0
Titrant addition: Dynamic
   dE (set) (mV): 8.0
   dV (min) (mL): 0.03
   dV (max) (mL): 0.5
Measure mode: Equilibrium controlled
   dE (mV): 0.5
   dt (s): 1.0
   t (min) (s): 2.0
   t (max) (s): 20.0
Recognition
   Threshold: 100.0
   Steepest jump only: No
   Range: No
   Tendency: None
Termination
   At maximum volume (mL): 10.0
   at potential: No
   at slope: No
   after number EQPs: Yes
      n=1
   comb. Termination conditions: No
Evaluation
   Procedure: Standard
   Potential 1: No
   Potential 2: No
   Stop for reevaluation: No

The acid value is measured in accordance with the procedures described in JIS K0070-1992 as follows. As regards sample preparation, a polyester sample of 0.5 g (component soluble in ethyl acetate: 0.3 g) is added to 120 mL of toluene and the sample is dissolved by stirring at room temperature (23° C.) for 10 hours, to which 30 mL of ethanol is added to prepare a sample solution.

The acid value may be calculated in the measuring device described above, specifically, the calculation is as follows. The solution is titrated with pre-determined N/10 potassium hydroxide alcohol solution and the acid value is obtained from the consumed amount of the potassium hydroxide alcohol solution in accordance with the calculation as follows.

acid value=KOH(mL)×N×56.1/sample mass

in which, N is a factor of N/10 KOH.

In the present invention, high temperature storage stability of the modified polyester resin, i.e. the main ingredient of the binder resin, depends on the glass transition temperature of the unmodified polyester resin, therefore, it is preferred to design the glass transition temperature of the polyester resin in a range of 35° C. to 65° C. The glass transition temperature of below 35° C. may lead to insufficient high temperature storage stability, and the glass transition temperature of above 65° C. may adversely affect low temperature fixability.

The glass transition temperature Tg may be measured in the present invention under a temperature rising rate of 10° C./min using Rigaku THRMOFLEX TG8110 (by Rigaku Co.).

The procedures to measure Tg will be generally explained. The system to measure Tg is TG-DSC system TAS-100 (by Rigaku Co.).

Initially, a sample of about 10 mg is filled in a sample container made of aluminum, and the sample container is placed on a holder unit and set in an electric furnace. The sample container is then heated from room temperature to 150° C. under a temperature rising rate of 10° C./min, maintained at 150° C. for 10 minutes, then is cooled to room temperature and allowed to stand for 10 minutes, then heated again in nitrogen gas atmosphere to 150° C. under a temperature rising rate of 10° C./min to measure DSC. Tg is calculated from a tangent line of an endothermic curve in the vicinity of Tg and a contact point of the base line using an analysis system in TAS-100 system.

On the basis of further investigations of the present inventors, the polymer having a site capable of reacting with a compound having an active hydrogen group is an important component of the binder resin in order to achieve low temperature fixability and high temperature offset resistance, and the mass average molecular mass is preferably 3,000 to 20,000. That is, when the mass average molecular mass is below 3,000, it is difficult to control reaction velocity, which may be problematic in production stability. When the mass average molecular mass is above 20,000, satisfactory modified polyester may be unobtainable and offset resistance may be adversely affected.

On the basis of further investigations of the present inventors, it has been found that acid value of toner is a factor more important than acid value of the binder resin with respect to low temperature fixability and high temperature offset resistance. The acid value of the inventive toner depends on terminal carboxyl group of the unmodified polyester. It is preferred that the acid value of the unmodified polyester is adjusted to 0.5 to 40.0 mgKOH/g in order to control low temperature fixability such as lower-limit fixing temperature and hot offset generating temperature. When the acid value of toner is above 40.0 mgKOH/g, elongation reaction or cross-linking reaction of modified polyester is insufficient, and the hot offset resistance may be adversely affected, and when the acid value is below 0.5 mgKOH/g, the effect to stabilize dispersion may be unobtainable from basic compounds and the elongation reaction or cross-linking reaction of modified polyester tends to excessively rapid, which being problematic for production stability.

The acid value of the inventive toner may be measured in accordance with JIS K0070, in which dioxane or THF is used as the solvent when the sample is insoluble.

The glass transition temperature of the inventive toner is preferably 40° C. to 70° C. in order to achieve low temperature fixability, high temperature storage stability, and high durability. That is, when the glass transition temperature is below 40° C., blocking in developing devices or filming on photoconductors tends to generate, and when the glass transition temperature is above 70° C., low temperature fixability may be impaired.

The polymer, having a site capable of reacting with a compound having an active hydrogen group, is exemplified by reactive modified polyester resins (RMPE) capable of reacting with active hydrogen, for example, polyester prepolymers (A) having an isocyanate group. The prepolymers (A) are exemplified by polycondensation products of polyesters, of polyols (PO) and polycarboxylic acids (PC), having active hydrogen that are further reacted with polyisocyanates (PIC). The groups having active hydrogen in the polyesters are exemplified by a hydroxyl group (alcoholic hydrogen group and phenolic hydroxyl group), amino group, carboxyl group, and mercapto group; among these, preferable is alcoholic hydroxyl group. Amines are used for a cross-linking agent of the reactive modified polyester resins, and diisocyanate compounds such as diphenylmethane diisocyanate are used for an elongating agent. The amines, described later in detail, may act as a cross-linking agent or an elongating agent for modified polyesters capable of reacting with active hydrogen.

Modified polyesters such as urea-modified polyesters, prepared by reacting polyester prepolymers (A) having an isocyanate group with amines (B), may be easily adjusted for molecular mass of the polymer ingredient and thus favorable for assuring the flow temperature fixability of dry toner, in particular oilless low temperature fixability, e.g. releasing property and fixability for fixing heating media without demolding oil-coating mechanism. Polyester prepolymers, of which terminal being urea-modified, may suppress adhesion property to the fixing heating media while maintaining high flowability and transparency of the unmodified polyester resins themselves at the fixing temperature.

The polyester prepolymer favorable in the present invention is the polyesters, which have an active hydrogen group such as acid and hydroxyl groups at terminal, to which a functional group such as isocyanate group reactive with the active hydrogen is introduced. Modified polyesters (MPE) such as urea-modified polyesters may be derived from the prepolymers; modified polyesters preferable in the present invention are urea-modified polyesters that are prepared by reacting a polyester prepolymer (A) having an isocyanate group with an amine (B) as a cross-linking agent and/or an elongating agent. The polyester prepolymers (A) having an isocyanate group may be prepared by reacting a polyester, which being a polycondensation product of polyol (PO) and polycarboxylic acid (PC) and having active hydrogen group, with a polyisocyanate (PIC). The active hydrogen group of the polyester is exemplified by a hydroxyl group (alcoholic hydrogen group and phenolic hydroxyl group), amino group, carboxyl group, and mercapto group; among these, preferable is alcoholic hydroxyl group.

Examples of the polyols (PO) include diols (DIO) and trivalent or more polyols (TO), and preferable are diols themselves and mixtures of diols with a small amount of TO. Examples of the DIO include alkylene glycols such as ethylene glycol, 1,2-propylene glycol, 1,3-propylene glycol, 1,4-bytandiol, and 1,6-hexanediol; alkylene ether glycols such as diethylene glycol, triethylene glycol, dipropylene glycol, polyethylene glycol, polypropylene glycol, and polytetramethylene ether glycol; alicyclic diols such as 1,4-cyclohexane dimethanol, and hydrogenated bisphenol A; bisphenols such as bisphenol A, bisphenol F, and bisphenol S; alkylene oxide adducts of the above-noted alicyclic diols such as ethylene oxide, propylene oxide, and butylene oxide; and alkylene oxide adducts of the above-noted bisphenols such as ethylene oxide, propylene oxide, and butylene oxide. Among these described above, alkylene glycols having a carbon number of 2 to 12 and alkylene oxide adducts of bisphenols are preferable; and alkylene oxide adducts of bisphenols and combinations of these adducts with an alkylene glycol having a carbon number of 2 to 12 are particularly preferable. Examples of the trivalent or more polyols (TO) include polyaliphatic alcohols of trivalent to octavalent or more such as glycerin, trimethylol ethane, trimethylol propane, pentaerythritol, and sorbitol; and trivalent or more phenols such as trisphenol PA, phenol novolac, and cresol novolac; and alkylene oxide adduct of the trivalent or more polyphenols.

Examples of the polycarboxylic acid (PC) include dicarboxylic acids (DIC) and trivalent or more polycarboxylic acids (TC), and dicarboxylic acids themselves and mixtures of dicarboxylic acid (DIC) with a small amount of a polyvalent carboxylic acid (TC) are preferable. Examples of the dicarboxylic acid (DIC) include alkylene dicarboxylic acids such as succinic acid, adipic acid, and sebacic acid; alkenylen dicarboxylic acids such as maleic acid and fumaric acid; aromatic dicarboxylic acids such as phthalic acid, isophthalic acid, terephthalic acid, and naphthalene dicarboxylic acid. Among these dicarboxylic acids, alkenylen dicarboxylic acids having a carbon number of 4 to 20 and aromatic dicarboxylic acids having a carbon number of 8 to 20 are preferable. Examples of the trivalent or more polyvalent carboxylic acid (TC) include aromatic polyvalent carboxylic acids having a carbon number of 9 to 20 such as trimellitic acid and pyromellitic acid. The polycarboxylic acid (PC) may be prepared by reacting an acid anhydride of the polycarboxylic acids described above or lower alkyl esters such as methyl ester, ethyl ester, and isopropyl ester with polyols (PO). The ratio of polyols (PO) to polycarboxylic acids (PC), defined as an equivalent ratio [OH]/[COOH] of a hydroxyl group [OH] to a carboxyl group [COOH], is typically 2/1 to 1/1, preferably 1.5/1 to 1/1, and more preferably 1.3/1 to 1.02/1.

Examples of the polyisocyanate compound (PIC) include aliphatic polyisocyanates such as tetramethylene diisocyanate, hexamethylene diisocyanate, and 2,6-diisocyanate; alicyclic polyisocyanates such as isophorone diisocyanate and cyclohexyl methane diisocyanate; aromatic diisocyanates such as tolylene diisocyanate and diphenylmethane diisocyanate; aromatic aliphatic diisocyanates such as α,α,α′α′-tetramethyl xylylene diisocyanate; isocyanates; these polyisocyanates blocked with a phenol derivative, an oxime, caprolactam, or the like; and combinations of two or more thereof. The ratio of the polyisocyanate compound (PIC), defined as an equivalent ratio [NCO]/[OH] of an isocyanate group [NCO] to a hydroxyl group [OH] of a polyester having a hydroxyl group, is typically 5/1 to 1/1, preferably 4/1 to 1.2/1, and more preferably 2.5/1 to 1.5/1. When [NCO]/[OH] is more than 5, low temperature fixability may be impaired. When urea-modified polyesters are used in the molar ratio of [NCO] is less than 1, the urea content of ester becomes lower, which making hot offset resistance insufficient. The content of polyisocyanate (PIC) in the prepolymer (A) having an isocyanate group at the terminal is typically 0.5% to 40% by mass, preferably 1% to 30% by mass, and more preferably 2% to 20% by mass. When the content is less than 0.5% by mass, hot offset resistance may be impaired and it may be undesirable to satisfy both of high temperature storage stability and low temperature fixability. On the other hand, when the content is more than 40% by mass, low temperature fixability may be poor.

The number of isocyanate groups per one molecule of the prepolymer (A) having an isocyanate group is typically 1 or more, preferably 1.5 to 3 on average, and more preferably 1.8 to 2.5 on average. When the number of isocyanate groups is less than 1 per one molecule, the molecular mass of the urea-modified polyester may be lower, which making hot offset resistance poor.

The amines (B) are exemplified by diamines (B1), trivalent or more polyamines (B2), amino alcohols (B3), amino mercaptans (B4), amino acids (B5), and these compounds (B1 to B5) of which amino group being blocked (B6). Examples of the diamines (B1) include aromatic diamines such as phenylene diamine, diethyl toluene diamine, and 4,4′-diamino diphenyl methane; alicyclic diamines such as 4,4′-diamino-3,3′-dimethyl dicyclohexyl methane, diamine cyclohexane, and isophorone diamine; and aliphatic diamines such as ethylene diamine, tetramethylene diamine, and hexamethylene diamine. Examples of the trivalent or more polyamines (B2) include diethylene triamine and triethylene tetramine. Examples of the amino alcohols (B3) include ethanol amine and hydroxyethyl aniline. Examples of the amino mercaptans (B4) include aminoethyl mercaptan and aminopropyl mercaptan. Examples of the amino acids (B5) include aminopropionic acid, aminocaproic acid, and the like. Examples of the compounds of which amino group being blocked (B6) include ketimine compounds between the amines B1 to B5 and ketones such as acetone, methyl ethyl ketone, and methyl isobuthyl ketone and oxazolidine compounds. Among these amines (B), preferable are diamines (B1) and mixtures of the diamines (B1) and a small amount of trivalent or more polyamines (B2).

If necessary, the molecular mass of the polyester may be controlled using an elongation terminator. Examples of the elongation terminators include monoamines such as diethylamine, dibutylamine, butylamine, and laurylamine; and block polymers thereof (e.g., ketimine compounds).

The ratio of amines (B), defined as an equivalent ratio [NCO]/[NHx] of isocyanate group [NCO] in a prepolymer having an isocyanate group (A) to amine group [NHx] in amines (B), is typically 1/2 to 2/1, preferably 1.5/1 to 1/1.5, more preferably 1.2/1 to 1/1.2. When [NCO]/[NHx] is more than 2 or less than ½, the molecular mass of urea-modified polyester becomes lower, which possibly making hot offset resistance poor. In the present invention, polyester resins are preferably urea-modified polyester resins (UMPE), and the urea-modified polyester resins may include a urethane bond as well as a urea bond. The molar ratio of the urea bond content to the urethane bond content is typically 100/0 to 10/90, preferably 80/20 to 20/80, and more preferably 60/40 to 30/70. When a molar ratio of the urea bond is less than 10%, hot offset resistance may be poor.

The modified polyesters such as urea-modified polyester resins (UMPE) may be produced by one-shot methods etc. The mass average molecular mass of the modified polyesters such as urea-modified polyester resins (UMPE) is typically 10,000 or more, preferably 20,000 to 10,000,000, and more preferably 30,000 to 1,000,000. The mass average molecular mass of below 10,000 may deteriorate hot offset resistance. The average molecular mass of the modified polyesters such as urea-modified polyester resins is not defined specifically when unmodified polyesters (PE) described later are used, and may be number average molecular mass in which the mass average molecular mass is obtainable. In cases where modified polyesters such as UMPE are used alone, the number average molecular mass is typically 2,000 to 15,000, preferably 2,000 to 10,000, and more preferably 2,000 to 8,000. The number average molecular mass of larger than 20,000 may impair low temperature fixability and glossiness in cases of full color apparatuses.

In the present invention, the modified polyesters such as urea-modified polyester resins (UMPE) may be used alone and also contain unmodified polyesters (PE) as a component of the binder resin. When an unmodified polyester (PE) is used together with, the low temperature fixability and glossiness in cases of full color apparatuses may be enhanced preferably than the cases of sole use. The unmodified polyesters (PE) are exemplified by the polycondensation products of polyols (PO) and polycarboxylic acids of the polyester components similar as those of the UMPE, and preferable unmodified polyesters (PE) are similar as those of the UMPE. The mass average molecular mass Mw of PE is 10,000 to 300,000, preferably 14,000 to 200,000. The number average molecular mass Mn is 1,000 to 10,000, preferably 1,500 to 6,000. The UMPE may be combined with chemically modified ones other than by urea bond such as urethane bond in addition to unmodified polyesters. It is preferred that the UMPE and the unmodified polyester are partially compatible in view of low temperature fixability and hot offset resistance. It is hence preferred that the polyester component of the UMPE is similar to that of the unmodified polyester (PE). The mass ratio of the UMPE to the unmodified polyester (PE), when the unmodified polyester (PE) being included, is typically 5/95 to 80/20, preferably 5/95 to 30/70, more preferably 5/95 to 25/75, and still more preferably 7/93 to 20/80. When the mass ratio of the UMPE is less than 5%, the hot offset resistance may be poor and also the high temperature storage stability and low temperature fixability may be deteriorated.

It is preferred that OH value (mgKOH/g) of the unmodified polyester (PE) is no less than 5; the acid value (mgKOH/g) of the unmodified polyester (PE) is typically 1 to 30, preferably 5 to 20. The range of the acid value allows negative charge and improves compatibility between paper and the toner at fixing steps, which enhances low temperature fixability. However, acid values higher than 30 may impair charge stability and be problematic under environmental fluctuation in particular. The fluctuation of the acid value may lead to fluctuation in granulating steps in polymerization reaction, which makes difficult to control emulsification.

The OH value and the acid value of unmodified polyesters may be determined by the following procedures.

Measuring device: Potentiometric Automatic Titrator DL-53 (by Mettler-Toledo K.K.)

Electrode: DG113-SC (Mettler-Toledo K. K.)

Analysis software: LabX Light Version 1.00.000

Correction: use of mixture solvent of toluene 120 mL and ethanol 30 mL

Measuring temperature: 23° C.
Measuring conditions are as follows:

Stir
Speed (%): 25
Time (s): 15

EQP titration
Titrant/Sensor
Titrant: CH₃ONa
Concentration (mole/L): 0.1
Sensor: DG115
Unit of measurement: mV

Predispensing to volume
Volume (mL): 1.0
Wait time (s): 0

Titrant addition: Dynamic
dE (set) (mV): 8.0
dV (min) (mL): 0.03
dV (max) (mL): 0.5

Measure mode: Equilibrium controlled
dE (mV): 0.5
dt (s): 1.0
t (min) (s): 2.0
t (max) (s): 20.0

Recognition
Threshold: 100.0
Steepest jump only: No
Range: No
Tendency: None

Termination
At maximum volume (mL): 10.0
at potential: No
at slope: No
after number EQPs: Yes
   n=1
comb. Termination conditions: No

Evaluation
Procedure: Standard
Potential 1: No
Potential 2: No
Stop for reevaluation: No

The acid value of unmodified polyesters (PE) is measured in accordance with the procedures described in JIS K0070-1992 as follows. As regards sample preparation, a polyester sample of 0.5 g (component soluble in ethyl acetate: 0.3 g) is added to 120 mL of toluene and the sample is dissolved by stirring at room temperature (23° C.) for 10 hours, to which 30 mL of ethanol is added to prepare a sample solution.

The acid value may be calculated in the measuring device described above, specifically, the calculation is as follows. The solution is titrated with pre-determined N/10 potassium hydroxide alcohol solution and the acid value is obtained from the consumed amount of the potassium hydroxide alcohol solution in accordance with the calculation as follows.

acid value=KOH(mL)×N×56.1/sample mass

in which, N is a factor of N/10 KOH.

The OH value of unmodified polyesters (PE) is measured in accordance with the procedures described in JIS K0070-1992 as follows.

A sample of 0.5 g is precisely weighed into a measuring flask of 100 mL, to which 5 mL of an acetylating reagent is correctly added, then the measuring flask is immersed into a bath at 100° C.±5° C. to heat the flask. The flask is taken out from the bath after 1 to 2 hours to allow to cool, then water is added and shaken to decompose acetic anhydride. In order to complete the decomposition, the flask is heated again in the bath for no shorter than 10 hours, then the wall of the flask is rinsed well with an organic solvent. The liquid is subjected to potentiometric titration by N/2 potassium hydroxide ethyl alcohol solution using the electrode described above to determine OH value (in accordance with JIS K0070-1966).

In the present invention, the glass transition temperature (Tg) of the binder resin is typically 40° C. to 70° C., and preferably 40° C. to 60° C. When Tg is below 40° C., heat resistance of the toner may be poor, and when above 70° C., low temperature fixability may be insufficient. The dry toner of the present invention tends to represent proper high temperature storage stability even having lower glass transition temperatures, compared to conventional toners based on polyester resins, when the modified polyester such as the urea-modified polyester resins etc. exists in combination.

As regards waxes used for the inventive toner, waxes having a lower melting point of 50° C. to 120° C. may perform effectively between fixing rollers and toner interface as a releasing agent through dispersing with binder resins and effect on hot offset resistance with no use of releasing agents such oils on fixing rollers. The melting point of waxes in the present invention indicates a maximum endothermic peak by use of a differential scanning calorimeter (DSC).

The ingredient of waxes useful in the present invention may be the substances as follows; specific examples of the waxes include vegetable waxes such as carnauba wax, cotton wax, wood wax, and rice wax; animal waxes such as bees wax and lanolin; mineral waxes such as ozokerite and selsyn; and petroleum wax such as paraffin, microcrystalline, and petrolatum. In addition to the natural waxes, synthetic hydrocarbon waxes such as Fischer-Tropsch wax and polyethylene wax and synthetic waxes such as of esters, ketones, and ethers are exemplified. Furthermore, available are fatty acid amides such as 12-hydroxystearic acid amide, stearic acid amide, phthalic anhydride imide, and chlorinated hydrocarbon; crystalline polymer resins of low molecular mass such as homopolymes or copolymers of polyacrylates of poly-n-stearyl methacrylate or poly-n-lauryl methacrylate (e.g. copolymer of n-stearyl acrylate-ethyl methacrylate); and crystalline polymers having a long alkyl group in a side chain.

The colorant in the present invention may be properly selected from conventional dyes and pigments; examples thereof include carbon black, nigrosine dyes, iron black, Naphthol Yellow S, Hansa Yellow (10G, 5G, G), cadmium yellow, yellow iron oxide, yellow ocher, chrome yellow, Titan Yellow, Polyazo Yellow, Oil Yellow, Hansa Yellow (GR, A, RN, R), Pigment Yellow L, Benzidine Yellow (G, GR), Permanent Yellow (NCG), Vulcan Fast Yellow (5G, R), Tartrazine Lake, Quinoline Yellow Lake, anthracene yellow BGL, isoindolinone yellow, colcothar, red lead oxide, lead red, cadmium red, cadmium mercury red, antimony red, Permanent Red 4R, Para Red, Fire Red, parachlororthonitroaniline red, Lithol Fast Scarlet G, Brilliant Fast Scarlet, Brilliant Carmine BS, Permanent Red (F2R, F4R, FRL, FRLL, F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Hello Bordeaux BL, Bordeaux 10B, BON Maroon Light, BON Maroon Medium, eosine lake, Rhodamine Lake B, Rhodamine Lake Y, Alizarine Lake, Thioindigo Red B, Thioindigo Maroon, Oil Red, quinacridone red, Pyrazolone Red, Polyazo Red, Chrome Vermilion, Benzidine Orange, Perynone Orange, Oil Orange, cobalt blue, cerulean blue, Alkali Blue Lake, Peacock Blue Lake, Victoria Blue Lake, metal-free phthalocyanine blue, Phthalocyanine Blue, Fast Sky Blue, Indanthrene Blue (RS, BC), indigo, ultramarine, Prussian blue, Anthraquinone Blue, Fast Violet B, Methyl Violet Lake, cobalt violet, manganese violet, dioxazine violet, Anthraquinone Violet, chrome green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc white, lithopone and combinations thereof. The amount of the colorant is typically 1% to 15% by mass based on the toner, preferably 3% to 10% by mass.

The colorant useful in the present invention may be mixed with a resin to use as a masterbatch. The binder resin, used for producing the masterbatch or mixed with the colorant, may be, in addition to modified or unmodified polyester resins described above, polymers of styrene or its derivative substitutions such as polystyrene, poly-p-chlorostyrene, and polyvinyltoluene; styrene copolymers such as styrene/p-chlorostyrene copolymer, styrene-propylene copolymer, styrene-vinyltoluene copolymer, styrene-vinylnaphthalene copolymer, styrene-methylacrylate copolymer, styrene-ethylacrylate copolymer, styrene-butylacrylate copolymer, styrene-octylacrylate copolymer, methylmethacrylate copolymer, styrene-ethylmethacrylate copolymer, styrene-butylmethacrylate copolymer, styrene-c-chloromethylmethacrylate copolymer, styrene-acrylonitrile copolymer, styrene-vinylmethylketone copolymer, styrene-butadiene copolymer, styrene-isoprene copolymer, styrene-acrylonitrile-indene copolymer, styrene-maleic acid copolymer and styrene-maleic acid ester copolymer; polymethylmethacrylate, polybutylmethacrylate, polyvinylchloride, polyvinyl acetate, polyethylene, polypropylene, polyester, epoxy resins, epoxy polyol resins, polyurethane, polyamide, polyvinylbutyral, polyacrylic acid resins, rosin, modified rosin, terpene resins, aliphatic or cycloaliphatic hydrocarbon resins, aromatic petroleum resins, chlorinated paraffin and paraffin wax. These may be used alone or in combination.

In addition, solvents capable of dissolving polyesters such as urea-modified polyester and prepolymer (A) can be used for decreasing viscosity of dispersing media containing toner ingredients. The solvent may be favorably used in order to narrow the particle diameter distribution. The solvent is volatile such that its boiling point is lower than 100° C. so as to be easily removed. The solvent may be exemplified by toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone and methyl isobutyl ketone. These may be used alone or in combination of two or more. Among these, preferable are aromatic solvents such as toluene and xylene and halogenated hydrocarbons such as methylene chloride, 1,2-dichloroethane, chloroform, and carbon tetrachloride. The amount of the solvent is typically 0 to 300 parts based on 100 parts of the prepolymer (A), preferably 0 to 100 parts, more preferably 25 to 70 parts. After the solvents are used for elongation and/or cross-linking reaction of modified polyesters (prepolymer) with amines, the solvents are removed from the resulting reaction product under normal or reduced pressure.

The process to produce the masterbatch may be properly selected; for example, a resin and a colorant for the masterbatch are mixed and kneaded under a high shear force. An organic solvent may be used in the method in order to enhance the interaction between the colorant and the resin. Such a so-called flushing process may also be available, in which an aqueous paste containing the colorant and water is mixed and kneaded with a resin and an organic solvent, the colorant is transferred toward the resin, and the water and the organic solvent are removed. The process is an appropriate process for producing the masterbatch since the wet cake of the colorant can be directly used without drying. The mixing and kneading is preferably carried out using high-shear dispersing devices such as three-roll mills.

In conventional production processes of electrophotographic toners, particles containing a colorant and a resin and particles of a charge control agent are mixed using rotating devices in vessels in order to deposit and fix the charge control agent on surface of toner particles; in the present invention, desirable toner particles may be obtained through a step of mixing at a circumferential velocity of 40 to 150 m/sec within vessels with no projections from inner wall in accordance with the production processes.

The inventive toner may contain a charge control agent as required. The charge control agent may be properly selected from conventional ones; examples thereof include nigrosine dyes, triphenylmethane dyes, chromium-containing metal complex dyes, molybdic acid chelate pigments, rhodamine dyes, alkoxy amines, quaternary ammonium salts such as fluoride-modified quaternary ammonium salts, alkylamides, elemental phosphorus or compounds thereof, elemental tungsten or compounds thereof, fluoride activators, metallic salts of salicylic acid, and metallic salts of salicylic acid derivatives. The charge control agent may be commercially available ones; examples thereof include Bontron 03 of nigrosine dye, Bontron P-51 of quaternary ammonium salt, Bontron S-34 of metal-containing azo dye, Bontron E-82 of oxynaphthoic acid metal complex, Bontron E-84 of salicylic acid metal complex, and Bontron E-89 of phenol condensate (by Orient Chemical Industries, Ltd.); TP-302 and TP-415 of quaternary ammonium salt molybdenum metal complex (by Hodogaya Chemical Co.); Copy Charge PSY VP2038 of quaternary ammonium salt, Copy Blue PR of triphenylmethane derivative, and Copy Charge NEG VP2036 and Copy Charge NX VP434 of quaternary ammonium salt (by Hoechst Ltd.); LRA-901, and LR-147 of boron metal complex (by Japan Carlit Co., Ltd.), copper phthalocyanine, perylene, quinacridone, azo pigment, and other high-molecular weight compounds having a functional group, such as sulfonic acid group, carboxyl group, and quaternary ammonium salt.

The amount of the charge control agent in the toner is unnecessary to define specifically and depends on species of the resins, existence or nonexistence of optional additives, dispersing processes, etc.; preferably, the amount is 0.1 to 10 parts by mass based on the binder resin, more preferably 0.2 to 5 parts by mass. When the amount is above 10 parts by mass, the charging ability of the toner is excessively large, which possibly decreasing the effect of the charge control agent, and lowering flowability of developers or reducing image density due to higher electrostatic attraction with developing rollers. The charge control agent and the releasing agent may be incorporated into the masterbatch or melted and kneaded mixed with resins or added to organic solvents to dissolve or disperse.

External additives may be optionally added in order to improve flowability, developing ability, or charging ability of the colored particles obtained in the present invention. The external additives may be favorably selected from inorganic fine particles. The primary particle diameter of the inorganic fine particles is preferably 5 nm to 2 μm, more preferably 5 to 500 nm. The specific surface area of the inorganic fine particles is preferably 20 to 500 m²/g measured in accordance with BET method. The amount of the inorganic fine particles is preferably 0.01% to 5.0% by mass in the toner, more preferably 0.01% to 2.0% by mass. Specific examples of the inorganic fine particles include silica, alumina, titanium oxide, barium titanate, magnesium titanate, calcium titanate, strontium titanate, zinc oxide, tin oxide, quartz sand, clay, mica, silicic pyroclastic rock, diatomaceous earth, chromic oxide, cerium oxide, iron oxide red, antimony trioxide, magnesium oxide, zirconium oxide, barium sulfate, barium carbonate, calcium carbonate, silicon carbide, silicon nitride, and the like. Among these, the combination of hydrophobic silica fine particles and hydrophobic titanium oxide fine particles is preferable as the flowability improver. It has become apparent in particular that when these particles, of which average particle diameter being no more than 50 nm, are used in combination and mixed and stirred, high quality images may be obtained while far from separating the flowability improver from toners without voids even under stirring and mixing inside developing devices to attain a desirable charge level since electrostatic force and Van der Waals force with toners are considerably enhanced and also residual toners after transfer may be reduced.

It may be considered that the titanium oxide particles adversely affect on charge rising property when the amount on the titanium oxide particles is larger than the amount of the silica fine particles since the titanium oxide particles is likely to be poor in charge rising property in contrast to excellent environmental stability and image density stability. It has been found, however, that the amount of hydrophobic silica fine particles and hydrophobic titanium oxide fine particles in a range of 0.3% to 1.5% by mass may not impair significantly the charge rising property and bring about desirable charge rising property, that is, stable image quality is obtainable and toner blowout may be suppressed even under repeated copies.

The resin for toner binder may be produced by the processes as follows. A polyol (PO) and a polycarboxylic acid (PC) are heated to 150° C. to 280° C. in the presence of conventional esterification catalysts such as tetrabutoxy titanate and dibutyltinoxide, and the generating water is distilled away under reduced pressure as required thereby to prepare a polyester having a hydroxyl group. Then the polyester is reacted with polyisocyanate (PIC) at 40° C. to 140° C. to prepare a polyester prepolymer (A) having an isocyanate group. Further, the prepolymer (A) is reacted with an amine (B) at 0° C. to 140° C., to prepare a urea-modified polyester (UMPE). The number average molecular mass of the modified polyester is 1,000 to 10,000, preferably 1,500 to 6,000. When the polyisocyanate (PIC) is reacted or the polyester prepolymer (A) and the amine (B) are reacted, a solvent may be used as required. The useful solvents are those inactive with isocyanates (PIC), and specific examples thereof include aromatic solvents such as toluene and xylene; ketones such as acetone, methyl ethyl ketone and methyl isobutyl ketone; esters such as ethyl acetate; amides such as dimethylformamide and dimethylacetoaminde; and ethers such as tetrahydrofuran. When a urea-unmodified polyester (PE) is used in combination, the polyester (PE) is produced in a similar manner as the polyester having a hydroxyl group, then which is dissolved and mixed with the solution of the reacted urea-modified polyethylene.

The inventive toner may be produced by the methods as follows, but is not limited thereto.

### Toner Production Method in Aqueous Medium

The organic solvent may be properly selected depending on the application as long as capable of dissolving or dispersing toner ingredients, the solvent is preferably volatile to have a boiling point of below 150° C. in view of easy removal thereof; specific examples of the solvent include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. Among these, toluene, xylene, benzene, methylene chloride, 1,2-dichloroethane, chloroform, and carbon tetrachloride are preferably, and ethyl acetate are particularly preferable. These may be used alone or in combination of two or more.

The amount of the solvent may be properly selected depending on the application; preferably, the amount is 40 to 300 parts by mass based on 100 parts by mass of the toner ingredients, more preferably 60 to 140 parts by mass, and still more preferably 80 to 120 parts by mass. Suitable aqueous media for use in the production method of the inventive toner may be water itself or water and solvents soluble therewith. Examples of the soluble solvent include alcohols such as methanol, isopropanol, and ethylene glycol; dimethylformamide, tetrahydrofuran; cellosolves such as methyl cellosolve; and lower ketones such as acetone and methyl ethyl ketone.

In the present invention, reactive modified polyesters such as polyester prepolymers (A) having an isocyanate group are reacted with amines (B) in aqueous media thereby to prepare urea-modified polyesters (UMPE). As regards the process to prepare stably a dispersion of modified polyesters such as urea-modified polyesters or reactive modified polyesters such as polyester prepolymers (A) in aqueous media, toner ingredients including modified polyesters such as urea-modified polyesters or reactive modified polyesters such as polyester prepolymers (A) are added to the aqueous media and dispersed by action of shear force. The reactive modified polyesters such as polyester prepolymers (A) and other toner ingredients (hereinafter referred to as “toner raw materials”) such as a colorant, colorant masterbatch, releasing agent, charge control agent, and unmodified polyester resin may be mixed while the dispersion is formed; preferably, the toner raw materials are preliminarily mixed, then the mixture is added to the aqueous medium to disperse them. The toner raw materials such as colorants, release agents, and charge controlling agents are not necessarily added to the aqueous media when particles are formed, and may be added after particles are prepared in the aqueous medium. For example, particles are previously formed with no colorant, then a colorant may be added by conventional coloring processes.

The dispersing process is not limited specifically, and conventional devices for low speed shearing, high-speed shearing, friction, high-pressure jet, and ultrasonic processes are available. The high-speed shearing processes are preferable in order to prepare dispersion having a particle diameter of 2 to 20 μm. In cases where high-speed shearing dispersing devices are employed, the rotating number is typically 1,000 to 30,000 rpm, preferably 5,000 to 20,000 rpm, but is not limited thereto. The dispersing period is typically 0.1 to 5 minutes in batch systems, but is not limited thereto. The temperature at dispersing steps is typically 0° C. to 150° C. (under pressure), and preferably 40° C. to 98° C. The higher is the temperature the lower is the viscosity of dispersion of the urea-modified polyesters or prepolymers (A), and which is more favorable since dispersing process is easier.

The amount of the aqueous media is typically 50 to 2,000 parts by mass based on 100 parts by mass of the toner composition containing urea-modified polyesters and/or polyesters such as prepolymers (A), preferably 100 to 1,000 parts by mass. The amount of below 50 parts by mass possibly leads to inferior dispersing condition of toner ingredients and toner particles are far from intended particle diameters. The amount of above 20,000 parts by mass is undesirable in view of cost. A dispersant may be added as required and favorably used to narrow the particle diameter distribution and to make the dispersion stable.

The dispersant may be selected from various ones to emulsify or disperse the liquid that contains water and an oil phase into which the toner composition being dispersed. The dispersant may be surfactants, dispersants for inorganic fine particles, or dispersants for polymer fine particles.

Examples of the surfactants include anionic surfactants such as alkylbenzene sulfonic acid salts, α-olefin sulfonic acid salts, phosphoric acid esters; cationic surfactants like amine salt surfactants such as alkyl amine salts, aminoalcohol fatty acid derivatives, polyamine fatty acid derivatives, and imidazoline, and also like quaternary ammonium salt surfactants such as alkyltrimethyl ammonium salts, dialkyldimethyl ammonium salts, alkyldimethyl benzyl ammonium salts, pyridinium salts, alkyl isoquinolinium salts, and benzethonium chloride; non-anionic surfactants such as fatty acid amide derivatives and polyhydric alcohol derivatives; and ampholytic surfactants such as alanine, dodecyldi(aminoethyl)glycin, di(octylaminoethyl) glycin, and N-alkyl-N,N-dimethylammonium betaine.

Surfactants having a fluoroalkyl group may exhibit the effect even in a very small amount. Preferable examples of anionic surfactants having a fluoroalkyl group are fluoroalkyl carboxylic acids of C₂ to C₁₀ or metal salts thereof, disodium perfluorooctane sulfonylglutamate, 3-[ω-fluoroalkyl(C₆ to C₁₁)oxy]-1-alkyl(C₃ to C₄)sodium sulfonate, 3-[ω-fluoroalkanoyl(C₆ to C₈)-N-ethylamino]-1-sodium propanesulfonate, fluoroalkyl(C₁₁ to C₂₀)carboxylic acids or metal salts thereof, perfluoroalkyl(C7 to C₁₃)carboxylic acids or metal salts thereof, perfluoroalkyl(C4 to C₁₂)sulfonic acid or metal salts thereof, perfluorooctanesulfonic acid diethanol amide, N-propyl-N-(2-hydroxyethyl)perfluorooctanesulfone amide, perfluoroalkyl(C₆ to C₁₀)sulfoneamidepropyl trimethyl ammonium salts, perfluoroalkyl(C₆ to C₁₀)-N-ethylsulfonyl glycin salts, and monoperfluoroalkyl(C₆ to C₁₆)ethylphosphate ester, and the like.

Examples of commercially available surfactants having a fluoroalkyl group are Surflon S-111, S-112 and S-113 (by Asahi Glass Co.); Frorard FC-93, FC-95, FC-98 and FC-129 (by Sumitomo 3M Ltd.); Unidyne DS-101 and DS-102 (by Daikin Industries, Ltd.); Megafac F-110, F-120, F-113, F-191, F-812 and F-833 (by Dainippon Ink and Chemicals, Inc.); ECTOP EF-102, 103, 104, 105, 112, 123A, 123B, 306A, 501, 201 and 204 (by Tohchem Products Co.); Futargent F-100 and F150 (by Neos Co.). Specific examples of the cationic surfactants are primary, secondary and tertiary aliphatic amines having a fluoroalkyl group, aliphatic quaternary ammonium salts such as of perfluoroalkyl(C₆ to C₁₀)sulfoneamide propyltrimethylammonium salts, benzalkonium salts, benzetonium chloride, pyridinium salts, imidazolinium salts, etc. Specific examples of the commercially available products thereof include SURFLON S-121 (by Asahi Glass Co.); FRORARD FC-135 (by Sumitomo 3M Co.); UNIDYNE DS-202 (by Daikin Industries, Ltd.); MEGAFACE F-150 and F-824 (by Dainippon Ink and Chemicals, Inc.); ECTOP EF-132 (by Tohchem Products Co.); FUTARGENT F-300 (by Neos Co.), and the like.

In addition, dispersants of inorganic compounds hardly soluble in water are available, such as tricalcium phosphate, calcium carbonate, titanium oxide, colloidal silica, and hydroxyapatite.

In addition, certain resin fine particles may exhibit similar effects as the inorganic dispersants; examples thereof include MMA polymer fine particles of 1 μm and 3 μm, styrene fine particles of 0.5 μm and 2 μm, and styrene-acrylonitrile polymer fine particles of 1 μm (PB-200H (by Kao Co.), SGP (JRI Solutions, Ltd.), Techno Polymer SB (Sekisui Plastics Co.), SGP-3G (JRI Solutions, Ltd.), and Micropal (Sekisui Fine Chemical Co.).

In addition, as regards dispersants available in combination with the inorganic dispersants or the resin fine particles, the dispersed liquid droplets may be stabilized by use of polymer protective colloid; specific examples of such protective colloids include acids such as acrylic acid, methacrylic acid, α-cyanoacrylic acid, α-cyanomethacrylic acid, itaconic acid, crotonic acid, fumaric acid, maleic acid, and maleic anhydride; (meth)acrylic monomers having a hydroxyl group such as β-hydroxyethyl acrylate, β-hydroxypropyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethyleneglycolmonoacrylic acid esters, diethyleneglycolmonomethacrylic acid esters, glycerinmonoacrylic acid esters, N-methylolacrylamide, and N-methylolmethacrylamide; vinyl alcohol and its ethers such as vinyl methyl ether, vinyl ethyl ether, and vinyl propyl ether; esters of vinyl alcohol with a compound having a carboxyl group such as vinyl acetate, vinyl propionate, and vinyl butyrate; acrylic amides such as acrylamide, methacrylamide, and diacetoneacrylamide and their methylol compounds; acid chlorides such as acrylic acid chloride and methacrylic acid chloride; homopolymers or copolymers of monomers having a nitrogen atom or a heterocycle having a nitrogen atom such as of vinyl pyridine, vinyl pyrrolidone, vinyl imidazole, and ethylene imine; polyoxyethylene compounds such as polyoxyethylene, polyoxypropylene, polyoxyethylenealkyl amines, polyoxypropylenealkyl amines, polyoxyethylene alkyl amides, polyoxypropylenealkyl amides, polyoxyethylene nonylphenyl ethers, polyoxyethylene laurylphenyl ethers, polyoxyethylene stearylphenyl esters, and polyoxyethylene nonylphenyl esters; and cellulose compounds such as methyl cellulose, hydroxyethyl cellulose, and hydroxypropyl cellulose.

The period for elongation and/or cross-linking reaction may be properly selected based on reactivity that depends on the combination between structure of an isocyanate group that the prepolymer (A) has and an amine (B), typically the period is 10 minutes to 40 hours, preferably 2 to 24 hours. The reaction temperature is typically 0° C. to 150° C., preferably 40° C. to 98° C. Conventional catalysts may be employed as required; examples thereof include dibutyltin laurate and dioctyltin laurate. The amines (B) are used as an elongating agent and/or cross-linking agent.

The inventive toner may be used for two-component developers. In such cases, the toner is mixed with a magnetic carrier, and the amount ratio of the toner and the carrier in developers is preferably 1 to 10 parts by mass of the toner based on 100 parts of the carrier. The magnetic carrier may be selected from conventional ones, having a particle diameter of about 20 to 200 μm, such as iron powders, ferrite powders, magnetite powders, and magnetic resin carriers. The surface of the carriers may be coated by a resin. Specific examples of the resin to be coated on the carriers include amino resins such as urea-formaldehyde resins, melamine resins, benzoguanamine resins, urea resins, and polyamide resins; epoxy resins; vinyl or vinylidene resins such as acrylic resins, polymethylmethacrylate resins, polyacrylonitirile resins, polyvinyl acetate resins, polyvinyl alcohol resins, polyvinyl butyral resins; polystyrene resins, styrene-acrylic copolymers; halogenated olefin resins such as polyvinyl chloride resins; polyester resins such as polyethylene terephthalate resins and polybutylene terephthalate resins; polycarbonate resins, polyethylene resins, polyvinyl fluoride resins, polyvinylidene fluoride resins, polytrifluoroethylene resins, polyhexafluoropropylene resins, vinylidenefluoride-acrylate copolymers, vinylidenefluoride-vinylfluoride copolymers, terpolymers of tetrafluoroethylene, vinylidenefluoride and other monomers including no fluorine atom, and silicone resins. Electroconductive powder may be included in the toner. Specific examples of the electroconductive powder include metal powders, carbon black, titanium oxide, tin oxide, and zinc oxide. The average particle diameter of the electroconductive powder is preferably no larger than 1 μm. When the average particle diameter is above 1 μm, control of resistance is difficult.

The inventive toner may also be used as a magnetic toner or a non-magnetic toner of one-component magnetic developers with no carrier.

In the inventive image forming method, the inventive toner is used for conventional image forming methods that use a toner. In the inventive image forming apparatus, the inventive toner is used for conventional image forming apparatuses that use a toner.

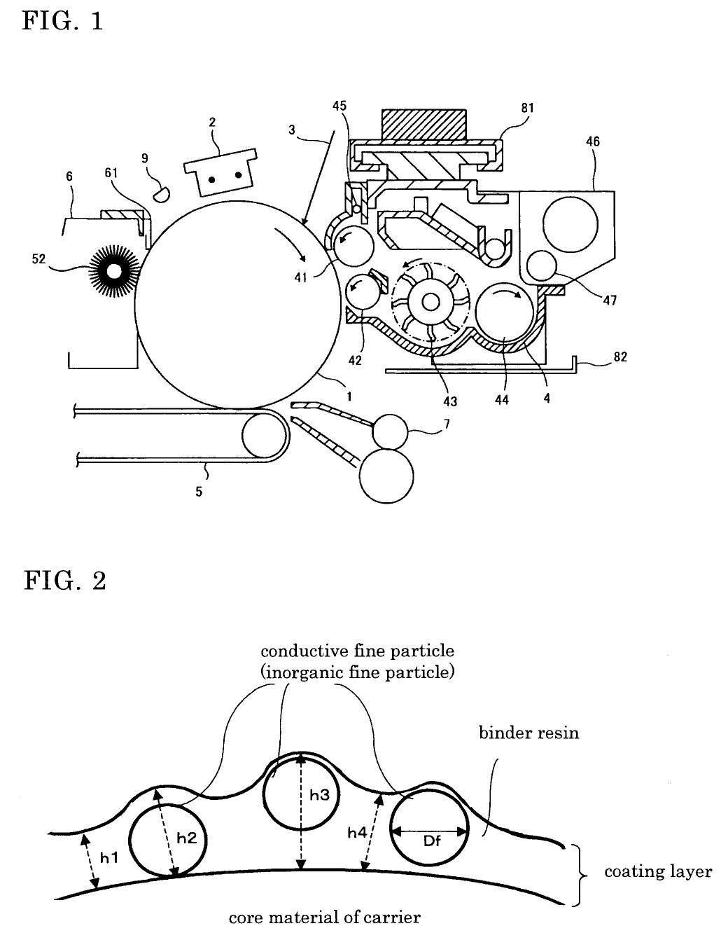

The first invention will be explained with reference to FIG. 1 in the following. FIG. 1 is an exemplary view that schematically shows a cross section of an image forming apparatus. In this example, an electrophotographic copier is illustrated as an image forming apparatus. FIG. 1 shows a photoconductor drum 1 of latent image bearing member that rotates in the arrow direction as shown, a charging device 2 is disposed outside the photoconductor drum 1, and laser light 3 is irradiated from an exposing unit correspondingly with images read from originals. Additionally, a developing device 4, a paper feeding unit 7, a transfer device 5, a cleaning device 6, and a charge eliminating device 9 are disposed around the photoconductor 1. The developing device 41 is further equipped with developing rollers 41, 42, puddle-like stirring member 43, a stirring member 44, a doctor 45, a toner supplying portion 46, and a supplying roller 47. The cleaning device 6 is equipped with a cleaning brush 62 and a cleaning blade 61. The members 81 and 82, disposed upper and lower of the developing device 4, are guide rails for attaching/detaching or supporting the developing device 4. The cleaning blade 61 of the cleaning device may also be detected for its life time. The cleaning blade 61 always contacts with photoconductors in operating period and is worn away along with the rotation of the photoconductors. When cleaning blades are worn away, the function to remove residual toners on photoconductors is impaired, and image quality of copies is degraded. When toners arenearly spherical and enhanced for flowability compared to milled toners, the nearly spherical toners easily pass through blades to cause inferior cleaning even when the blades are not worn away yet although transfer ability is improved, which is a problem for polymerization toners. The problem may be solved and the cleaning can be adequately carried out by use of the inventive irregular toner.

The best mode for working the second invention will be explained with reference to figures as required in the following. Those skilled in the art may easily change or modify the present invention within the scope of claims into other modes, therefore, the change or modification should be encompassed within claims and the descriptions below are no more than examples of the best mode to which the claims are not limited.

As described above, the inventive carrier for electrophotographic developer comprises a resin, a colorant, and a layered inorganic mineral of which at least a part of ions between layers being modified by an organic ion, and is used for an electrophotographic carrier that is comprised of the carrier and a negative charge toner that has an average circularity of 0.925 to 0.970 and is formed into particles by way of dispersing and/or emulsifying an oil phase and/or monomer phase containing at least a toner composition and/or toner composition precursor into an aqueous medium; and the carrier has a coating layer that contains a binder resin and conductive fine particles on core material of the carrier.

Hereinafter, sometimes are referred to the negative charge toner as “toner”, the carrier for electrophotographic developer as “carrier”, and the electrophotographic developer as “developer”.

The present invention will be explained in more detail below.

The toner, used for the inventive developer, will be explained in detail later; initially, the layered inorganic mineral of which at least a part of ions between layers being modified by an organic ion (modified layered inorganic mineral) will be explained.

The “modified layered inorganic mineral” indicates an inorganic mineral that is formed of laminated layers having a thickness of several nanometers; the “modified” indicates that an organic ion is introduced as the ion existing between the layers. Specific examples thereof are the layered inorganic substances described in JP-A Nos. 2006-500605, 2006-503313, and 2003-202708. The structure of these substances is encompassed into intercalation in a broad sense.

The layered inorganic mineral is publicly exemplified by smectite group (montmorillonite, saponite), kaolin group (kaolinite), magadiite, and kanemite. The hydrophilicity of the modified layered inorganic mineral depends on the modified layered structure. When the layered inorganic mineral without modification is applied to the toner to form particles by dispersing in an aqueous medium, the layered inorganic mineral migrates into the aqueous medium, thus the toner cannot be deformed (so-called non-spherical shape); meanwhile the modification enhances hydrophobicity, thus the toner can be easily deformed at forming particles and finely dispersed, exhibiting sufficiently charge adjusting function. That is, the modified layered inorganic mineral can make particles fine at producing the toner and deform the particle shape, and also performs charge adjusting function and contribute to low temperature fixability by way of existing mainly at surface of the toner particles in particular. The content of the modified layered inorganic mineral is preferably 0.05% to 5% by mass in the toner ingredients.

The modified layered inorganic mineral in the present invention is desirably obtained by modifying one having a basic crystalline structure of smectite type. Although a metal anion may be introduced by way of substituting partially a divalent metal of the layered inorganic mineral into a trivalent metal, it is desirable that a part of a metal anion of the layered inorganic mineral is modified by an organic anion since introduction of metal anion enhances hydrophilicity.

The agent to form the modified layered inorganic mineral by way of modifying at least a part of ions that the layered inorganic mineral has (a part of ions between layers) is exemplified by quaternary alkyl ammonium salts, phosphonium salts, and imidazolium salts; preferable are quaternary alkyl ammonium salts.

Examples of the quaternary alkyl ammonium salts include trimethyl stearyl ammonium, dimethyl stearyl benzylammonium, dimethyl octadecyl ammonium, oleylbis(2-hydroxyethyl)methyl ammonium.

In addition, the agent to modify by an organic ion is exemplified by sulfate salts, sulfonate salts, carboxylate salt, or phosphate salts of branched and non-blanched or cyclic alkyls (C₁ to C₄₄), alkenyls (C₁ to C₂₂), alkoxys (C₈ to C₃₂), hydroxylalkyl (C₂ to C₂₂), ethylene oxide, propylene oxide, etc. Among these, preferable are carboxylic acids having a skeleton of ethylene oxide.

By way of modifying at least a part of ions between layers of the layered inorganic mineral has (a part of ions), the layered inorganic mineral can has an adequate hydrophobicity, and thus when the modified layered inorganic mineral is incorporated into an oil phase containing a toner composition and/or toner composition precursor, the oil phase can exhibit non-Newtonian viscosity to deform the toner. In this stage, the content of the modified layered inorganic mineral is preferably 0.05% to 5% by mass in the toner ingredients as described above.

The modified layered inorganic mineral may be properly selected and exemplified by montmorillonite, bentnite, hectorite, attapulgite, sepiolite, and mixtures thereof. Among these, organic modified montmorillonite and bentnite are preferable in view of non-influence on toner properties, easy viscosity adjustability, and lower additive amount.

Examples of commercially available layered inorganic mineral, of which at least a part of ions between layers being modified by an organic cation, include quaternium 18 bentonite such as Bentone 3, Bentone 38, and Bentone 38V (by Leox Co.), Thixogel VP (United Catalyst Co.), Clayton 34, Clayton 40, and Clayton XL (Southern Clay Products, Inc.); stearalkonium bentonite such as Bentone 27 (by Leox Co.), Thixogel LG (United Catalyst Co.), and Clayton AF and Clayton APA (Southern Clay Products, Inc.); and quaternium 18/benzalkonium bentonite such as Clayton HT and Clayton PS (Southern Clay Products, Inc.). Particularly preferable are Clayton AF and Clayton APA.

As regards the layered inorganic mineral, of which at least a part of ions between layers being modified by an organic anion, are those of DHT-4A (by Kyowa Chemical Industry Co.) modified by organic anions expressed by General Formula (1) below. An exemplary compound expressed by General Formula (1) is Hightenol 330T (by Dai-ichi Kogyo Seiyaku Co.).

R¹(OR²)ₙOSO₃M :General Formula (1)

in which, R¹ represents an alkyl group of 13 carbon atoms, R² represents an alkylene group of 2 to 6 carbon atoms, “n” is an integer of 2 to 10, and M is a monovalent metal element.

When the modified layered inorganic mineral with an adequate hydrophobicity is employed, the oil phase containing a toner composition and/or toner composition precursor can exhibit non-Newtonian viscosity to deform the toner in the processes to produce the toner containing the modified layered inorganic mineral.

On the other hand, in cases of two-component developers (toner and carrier), the inventive toner containing the modified layered inorganic mineral may undergo a change of charging property as carrier with time; that is, the charge amount (electric charge) tends to increase with the amount of consumed toner. The reason is believed that toner ingredients accumulate at carrier surface (spent), but the detail mechanism to increase the charge amount is unclear still.

The charge amount typically decreases in usual spent of toner ingredients, but the charge amount increases in the inventive toner. The charge amount does not change significantly in cases of charts with lower image area such as writings, but the charge amount increases in cases of charts with higher image area such as photographs and poster images. Charts with larger image area lead to larger amount of consumed toners, and the charge amount increases along with the amount of consumed toners.

It is necessary to remove the spent materials accumulated on the carrier surface, in order to attain this object, the inventive carrier has a coating layer containing a binder resin and conductive fine particles on the core material of the carrier, and the fine particles in the carrier coating layer lead to irregularity of the carrier surface thereby the spent materials are removed by action of self-polishing between carriers. Furthermore, in order to prevent the increase of charge amount due to insufficient removal, the fine particles included into the coating layer are conductive fine particles. The inclusion of the conductive fine particles may effect a charge leak to suppress the increase of charge amount.

The conductive fine particles may be of carbon black, titanium oxide, zinc oxide, indium oxide, tin oxide-antimony oxide, tin oxide-indium oxide, and surface-treated conductive fine particles thereof. When the conductive fine particles are mixed in toners through scraping of the coating layer and the conductive fine particles are other than colorless or white, color smear is caused for color images. Carbon black and indium oxide may electively reduce the carrier resistance even in a small amount but are unable to employ due to the problem of color smear.

Zinc oxide and titanium oxide are white but impossible to effectively reduce the charge or electric resistance (hereinafter simply referred to as “resistance”) in a small amount like carbon black, thus a large amount thereof is required to add into the coating layer. When the conductive fine particles are added in a large amount, there arises a problem of uneven distribution of the conductive fine particles in the coating layer of the carrier. When the sites where the conductive fine particles unevenly exist are exposed through scraping of the coating layer, the sites act as an electric leak point to decrease resistance locally, which causing carrier adhesion on image portions and resulting in abnormal images like white voids.

The conductive fine particles may be various fine particles surface-treated with indium oxide. The fine particles surface-treated with indium oxide may be EC-500 and EC-700 (by Titankogyo. Co.) that are commercially available conductive inorganic oxide. These materials can reduce the resistivity in a small amount and are produced by surface-treating inorganic oxide thus are almost white and free from the problem of color smear.

The carrier for electrophotographic developer, used for the inventive electrophotographic developer, comprises a coating layer containing a binder resin and conductive fine particles on the core material of carrier.

The core material of carrier (hereinafter sometimes simply referred to as “core material”) may be properly selected depending on the purpose from conventional electrophotographic two-component carriers such as ferrites, Cu—Zn ferrites, Mn ferrites, Mn—Mg ferrites, Mn—Mg—Sr ferrites, magnetites, iron, and nickel, but not limited thereto.

It is preferred that the coating ratio of the conductive fine particles, contained in the coating layer of the carrier, is 50% or more based on the carrier core material. That is, as regards the amount ratio of the conductive fine particles to the carrier core material, the value of coating ratio obtained from Equation (1) satisfies 50% or more.

coating ratio=(Ds×ρs×W)/(4×Df×ρf)×100 (1)

in which Ds: particle diameter of carrier core material, ρs: absolute specific gravity of carrier core material, W: amount ratio of conductive fine particles to carrier core material, Df: particle diameter of conductive fine particle, ρf: absolute specific gravity of conductive fine particles.

Consequently, irregularity may be formed on the carrier surface, thereby contact with the binder resin along with strong impact may be mitigated through friction between the toner and the carrier or between carriers when the developer is stirred for frictionally charging, hence toner spent onto the carrier can be prevented.

The coating ratio is calculated as follows. The ρf of absolute specific gravity of conductive fine particles (inorganic fine particles) and ps of absolute specific gravity of carrier core material are measured using a dry type automatic density meter Acupic 1330 (by Shimadzu Co.). The Ds of particle diameter (volume average particle diameter) of carrier core material is measured using a Microtrack particle size analyzer of SRA type (by Nikkiso Co.); the range setting is 0.7 μm to 125 μm. Methanol is used for the dispersion liquid and the refractive index is set to 1.33, and refractive indices of carrier and core material are set to 2.42.

The Df particle diameter of conductive fine particle is measured by an automatic particle size analyzer CAPA-700 (by Horiba, Ltd.) as a volume average particle diameter. Pretreatment of the measurement is carried out in a way that 30 mL of aminosilane (SH6020, by Dow Corning Toray Silicone Co.) and 300 mL of toluene are poured into a juicer mixer; 6.0 g of a sample is added, rotation speed of the mixer is set to low to disperse three minutes; the dispersion liquid is added and diluted to 500 mL of toluene in a beaker of 1000 mL, and the diluted liquid is always stirred using a homogenizer. The diluted liquid is measured by the super-centrifugal automatic particle size analyzer CAPA-700 (by Horiba, Ltd.)

### Measuring Conditions:

rotation speed: 2000 rpm

maximum particle size: 2.0 μm

minimum particle size: 0.1 μm

pitch of particle size: 0.1 μm

viscosity of dispersion medium: 0.59 mPa·s

density of dispersion medium: 0.87 g/cm³

density of particles: density of inorganic fine particles is inputted as a value of absolute specific gravity measured using the dry type automatic density meter Acupic 1330 (by Shimadzu Co.).

Concerning the coating ratio described above, the coating ratio of below 50% is likely to expose the surface of carrier core material through film scraping with time to decrease resistance in spots, and the carrier under such a condition acts to develop solid images possibly to generate white voids in resulting images in particular in cases of the coating ratio of below 40%.

When the ratio Df/h satisfies the relation of 0.5<Df/h<1.5, the problem described above can be considerably improved, in which Df is a particle diameter of conductive fine particles (inorganic fine particles e.g. conductive inorganic oxide) in the coating layer of carrier and “h” is a thickness of the coating layer.

When the ratio Df/h between the particle diameter Df and the thickness “h” of the coating layer satisfies the relation of 0.5<Df/h<1.5, the particles project in the coating film, thereby contact with the binder resin along with strong impact may be mitigated through friction between the toner and the carrier or between carriers when the developer is stirred for frictionally charging.

Consequently, film scraping of the binder resin, which provides charge generating sites, can be suppressed. Furthermore, such numerous particles exist that project in the coating film, therefore, frictional contact between carriers can represent a cleaning effect to scrape effectively spent ingredients of the toner adhered to carrier surface to prevent toner spent.

The condition of Df/h below 0.5 is unfavorable since the inorganic fine particles tend to be buried within the binder resin, in particular the condition of Df/h below 0.4 is disadvantageous because of significantly poor effect.

The condition of Df/h above 1.5 is also unfavorable since the particles tend to escape due to insufficient binding force because of less contacting area between the particles and the binder resin. The escape of the inorganic fine particles decreases the resistance.

FIG. 2 is a conceptual view that schematically shows the relation between a particle diameter Df of conductive fine particles and a thickness “h” of coating layer in an inventive carrier for electrophotographic developer.

The thickness “h” of the coating layer of the carrier can be determined by way of observing the cross section of the carrier using a transmission electron microscope (TEM), measuring the thickness of resin portions of the coating layer on the carrier, and calculating the average. Specifically, the thicknesses of resin portions themselves are measured between the surface of carrier core material and the particles; thickness of resin portions between the particles or thickness of resin portions on the inorganic fine particles is excluded from the measurement. The thicknesses are measured for randomly selected 50 sites of the cross section of carrier to calculate the average to determine the thickness “h” (μm). The particle diameter Df of the inorganic fine particles is measured using the super-centrifugal automatic particle size analyzer CAPA-700 (by Horiba, Ltd.) in the same manner as the method to measure the particle diameter of the inorganic fine particles described above.

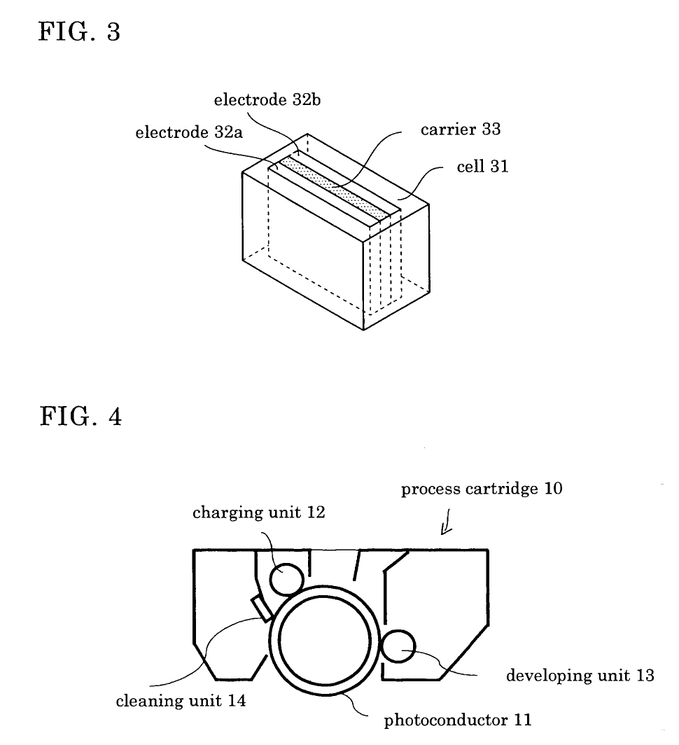

Resistance (volume resistivity value) of the inventive carrier for electrophotographic developer can be measured by the device for measuring carrier resistance schematically shown in FIG. 3; preferably, the resistance is no less than 10 [log (Ω·cm)] and no more than 16 [log (Ω·cm)]. The resistance is not defined specifically as long as in this range and may be appropriately adjusted depending on the application. The arrangement of the resistance is essential for carriers used for systems that require high quality images such as color images.

When the volume resistivity value is below 10 [log (Ω·cm)], carrier adhesion unfavorably generates at non-image portions. On the other hand, when the volume resistivity value is above 16 [log (Ω·cm)], edge effect unfavorably degrades to an unallowable level. When the volume resistivity value is below the measurable lower limit, the volume resistivity value is substantially unobtainable and regarded as breakdown.

The volume resistivity value in this specification is measured in a way that a carrier 33 is filled in a cell 31 of a fluorine resin container that houses electrodes 32a, 32b of surface area 2 cm×4 cm with distance 2 mm between the electrodes; tapping operation is carried out at a tapping speed of 30 times/min for one minutes using a tapping machine PTM-1 (by Sankyo Pio-Tech. Co.); then a DC voltage of 100 volts is applied between the electrodes, and a DC resistance is measured directly by use of a high resistance meter 4329A (4329A+LJK 5HVLVWDQFH OHWHU; by Yokokawa Hewlett-Packard Co.) to determine the resistance R (Ω·cm) and log R (Ω·cm) is calculated.

The volume average particle diameter of the inventive carrier is preferably 20 to 65 μm. When the volume average particle diameter is 20 to 65 μm, the effects to improve carrier adhesion and image quality are significant. When the volume average particle diameter is less than 20 μm, problems such as carrier adhesion unfavorably generate since uniformity of particles is decreased and technology to handle such finer particles is insufficient still. On the other hand, the volume average particle diameter of above 65 μm is unfavorable since reproducibility of fine images is poor and fine precise images are unobtainable.

The volume average particle diameter of carrier can be measured using a Microtrack particle size analyzer of SRA type (by Nikkiso Co.); the range setting is 0.7 μm or more to 125 μm or less. Methanol is used for the dispersion liquid and the refractive index is set to 1.33, and refractive indices of carrier and core material are set to 2.42.

It is preferred that the binder resin of the carrier contains at least a silicone resin. Improving effects may be significant when the binder resin of the carrier contains at least a silicone resin. The reason is that silicone resins have a lower surface energy, therefore, spent of toner ingredients hardly occurs and film scraping is likely to occur thus accumulation of spent ingredients is effectively delayed.

The silicone resin in this specification may be any conventional silicone resins, but not limited to, such as straight silicone resins having exclusively organosiloxane bond, and silicone resins which are modified with alkyd, polyester, epoxy, acrylic, and urethane, etc.

As regards commercially available ones, examples of the straight silicone resins include KR271, KR255, and KR152 (by Shin-Etsu Chemical Co.), and SR2400, SR2406, and SR2410 (by Dow Corning Toray Silicone Co.). These silicone resins may be used themselves or in combination with other ingredients for cross-linking reaction or controlling charge amount. Examples of the modified silicone resins include KR206 (alkyd modified), KR5208 (acryl modified), ES1001N (epoxy modified), KR305 (urethane modified) (by Shin-Etsu Chemical Co.), SR2115 (epoxy modified), and SR2110 (alkyd modified) (by Toray Dow Corning Co.).

The binder resin of the carrier may also be a mixture of an acrylic resin and a silicone resin. The silicone resin in addition to the acrylic resin may significantly improve adhesive property etc. of the coating layer. That is, acrylic resins exhibit strong adhesive property and low brittleness thus have very excellent abrasion resistance, therefore, degradation such as scraping or peeling of coating layer is unlikely to occur, the coating layer can be maintained stably, and particles like conductive fine particles contained in the coating layer can be firmly sustained by virtue of the strong adhesive property; in particular, powerful effect may be derived to support fine particles having a particle diameter larger than the thickness of coating layer.

The acrylic resin in this specification indicates any resins having an acrylic component without particular limitations. The acrylic resin may be used itself or in combination with other ingredients for cross-linking reaction with the acrylic resin. The other ingredients for cross-linking reaction are exemplified by, but not limited to, amino resins, acidic catalysts, etc.

The amino resins are exemplified by, but not limited to, guanamine resins, melamine resins, etc. The acidic catalysts may be any ones having a catalytic effect; examples thereof are those having a reactive group of which type being alkylated, methylol group, imino group, methylol/imino group, etc. The acrylic resins exhibit strong adhesive property and low brittleness thus have very excellent abrasion resistance, on the other hand, have a higher surface energy, therefore, there may arise such a problem as low charge amount due to spent (accumulation) of toner ingredients. Such a problem can be solved by using together with a silicone resin capable of effecting that spent of toner ingredients hardly occurs due to lower surface energy and accumulation of spent ingredients to cause film scraping is unlikely to progress. However, the silicone resins exhibit lower adhesive property and higher brittleness and thus are inferior in poor abrasion resistance, it is important to well-balance the properties of these two type resins, thereby the coating film may be unlikely to occur the spent and have abrasion resistance.

It is also preferred that magnetic moment of the inventive carrier is 40 to 90 Am²/kg in an applied magnetic field of 1000 (10³/4π·A/m).

Hereinafter, the intensity of applied magnetic field is sometimes expressed by Oe (Oersted). Above-mentioned 1000 (10³/4π·A/m) corresponds to 1 kOe (1,000 Oersted).

The magnetic moment of the range described above may appropriately maintain retaining force between carrier particles, thus dispersing or mixing of the toner into the carrier or developer is rapid and proper; however, when the magnetic moment is less than 40 Am²/kg at 1 kOe, shortage of the magnetic moment unfavorably brings about carrier adhesion. On the other hand, the magnetic moment of more than 90 Am²/kg at 1 kOe is undesirable, since the ear or spike of developer is excessively hard at developing step and thus reproducibility of fine images is poor and fine precise images are unobtainable.

The magnetic moment may be measured as follows. A B—H tracer BHU-60 (by Riken Denshi Co.) is used as a measuring device, and particles of carrier core material of 1.0 g is filled into a cylindrical cell (inner diameter: 7 mm, height: 10 mm) and set to the device. The magnetic field is gradually increased up to 3,000 Oersted, then is gradually decreased to zero, and magnetic field of the opposing direction is gradually increased up to 3,000 Oersted. Then the magnetic field is gradually decreased to zero, thereafter magnetic field is applied in the first direction. A B—H curve is figured in this way and the magnetic moment at 1,000 Oersted is determined from the figure.

The toner used for the inventive developer will be explained in detail in the following.

### Toner

The toner used for the inventive developer comprises a binder resin, a colorant, and a layered inorganic mineral of which at least a part of ions between layers being modified by an organic ion, and is formed into particles by way of dispersing and/or emulsifying an oil phase and/or monomer phase containing at least a toner composition and/or toner composition precursor into an aqueous medium; the toner has an average circularity of 0.925 to 0.970 and is a negative charge toner.

The toner may represent high reliability in cleaning, excellent low temperature fixability, and superior reproducibility of fine dots, thus provide stably high quality images.

The average circularity of the inventive toner is preferably 0.925 to 0.970 as described above, and more preferably 0.945 to 0.965. The average circularity means a value of circle circumference, having the same project area of toner particles to be measured, divided by the actual circumference of toner particles to be measured.

The content of particles having a circularity of less than 0.925 is preferably no more than 15% in the toner. When the average circularity is less than 0.925, it may be difficult to take high quality images with satisfactory transfer ability and without dusts; meanwhile, when the average circularity is above 0.970, inferior cleaning on photoconductors or transfer belts may generate in image forming systems equipped with cleaning blades and to contaminate images. In cases where images with a higher image-area rate such as photography images are to be formed, for example, toners of untransferable images due to paper-feed failure may remain on photoconductors to pollute background or to contaminate charge rollers thus inhibiting the charging capacity.

The average circularity may be measured by an optical detection zone method in which a toner-containing suspension is passed through an image-detection zone disposed on a plate, the particle images of the toner are optically detected by CCD camera, and the resulting particle images are analyzed. An available analyzing apparatus is a flow-type particle image analyzer FPIA-2100 (by Sysmex Corp.).

It is preferred in the toner of the inventive electrophotographic developer that the ratio Dv/Dn of volume average particle diameter Dv and number average particle diameter Dn is 1.00 to 1.30; the condition within this range may allow to form images with high resolution and high quality, and also in two-component developers, fluctuation of particle diameter of toners in developers may be low even under inflow and outflow of toners for a long period, and proper and stable development may be carried out even under prolonged stirring at developing devices.

When Dv/Dn is above 1.30, the particle diameters of toner particles tend to fluctuate considerably, toner behavior may vary at development etc., fine dots may impair reproducibility, and high quality images are difficult to obtain. More preferably, Dv/Dn is in a range of 1.00 to 1.20 to form more excellent images.

It is preferred that the inventive toner has a volume average particle diameter Dv of 3.0 to 7.0 μm. It is generally said that the smaller is the particle diameter of toners the more advantageous is for forming images with high resolution and high quality, however, the smaller particle diameter is disadvantageous for transferability and cleaning ability. Furthermore, when the volume average particle diameter Dv is smaller than the range described above, toners tend to fuse to surface of carriers under prolonged stirring in developing devices to decrease charging ability of carriers in cases of two-component developers, and toners tend to generate on developing rollers to form filming of toners or to fuse on thin-layering members such as blades in cases of one-component developers.

These phenomena greatly relate to content of fine powder, and the content of above 20% by number of particle diameter no more than 2 μm may be problematic as regards carrier adhesion or charging stability at high level.

On the other hand, when the volume average particle diameter Dv is larger than the range described above, it is difficult to form images with high resolution and high quality, and also the particle diameter of toner often fluctuates along with inflow and outflow of toners in developers; which being similar when the Dv/Dn is larger than 1.30.

The relation between toner shape and transferability will be discussed in the following. In cases where full color copiers are used that transfer on the basis of multi-color development, it is difficult to enhance transfer efficiency merely by virtue of using conventional irregular toners since toner amount on photoconductors increases compared to monochrome black toner in monochrome copiers.

Furthermore, in cases where conventional irregular toners are used, fusion or filming of the toners tends to generate on surface of photoconductors or intermediate transfer bodies because of rubbing force or sliding force between photoconductors and cleaning members, between intermediate transfer bodies and cleaning members, or between photoconductors and intermediate transfer bodies, thus transfer efficiency tends to drop. When full color images are formed, four-color toner images are unlikely to be transferred uniformly; furthermore, when intermediate transfer bodies are employed, there possibly arise problems in color nonuniformity or balance, thus it is uneasy to output stably full color images with high quality.

Toners, having smaller particle diameters and uniform particle diameter distribution, are problematic in terms of cleaning ability as described above, it is therefore preferred that the content of the particles having a circularity of no more than 0.950 is 20% to 80% based on entire toner particles. That is, the content of the particles having a circularity of no more than 0.950 is 20% to 80% in view of satisfying both of blade cleaning and transfer efficiency. The cleaning and transferability greatly depend also on materials or contacting conditions of the blades and the transfer also depends on process conditions, thus these may be designed depending on processes within the range described above.

However, it comes to difficult to clean blades when the content of the particles having a circularity of no more than 0.950 is less than 20%; and the transferability tends to degrade when the content of the particles having a circularity of no more than 0.950 is more than 80%. These phenomena are derived from the fact that excessively irregular toner shape prevents smooth transportation of toners at transfer steps such as from photoconductor surface to transfer paper, from photoconductor surface to intermediate transfer belts, and from first intermediate transfer belts to second intermediate transfer belts, these behaviors come to differ between toner particles, and thus uniform and high transfer efficiency are unobtainable. In addition, unstable charge or brittleness of particles comes to apparent; toners come to finer in developers, which is a factor to decrease durability of developers.

The procedures to measure the properties of the inventive toner will be explained in the following.

### Rate of Particle Diameter of 2 μm or Less, Circularity

The rate of particles having a particle diameter of no more than 2 μm, circularity and average circularity of the inventive toner may be measured using a flow-type particle image analyzer FPIA-2000 (by Sysmex Co.).

Specifically, 0.1 to 0.5 mL of a surfactant, preferably alkylbenzene sulfonate, is added as a dispersant into 100 to 150 mL of pure water, to which about 0.1 to 0.5 g of a sample is added. The dispersion containing the sample is ultrasonically dispersed for about 1 to 3 minutes using an ultrasonic dispersing device, the dispersion concentration is adjusted to 3,000 to 10,000/μL, and then the shape and the distribution of the toner are measured.

Average particle diameter and particle size distribution of toners are in accordance with Coulter Counter processes. The average particle diameter and the particle diameter distribution of toners can be measured using Coulter Counter TA-II or Coulter Multisizer II (by Beckman Coulter, Inc.). In the present invention, Coulter Counter TA-II model was used with connecting an interface (by The Institute JUSE) and a personal computer (PC9801, by NEC Co.) which outputs number distribution and volume distribution.

The measurement process will be explained in the following. Initially, 0.1 to 5 mL of a surfactant, preferably alkylbenzene sulfonate, is added as a dispersant into 100 to 150 mL of an aqueous electrolyte solution. The aqueous electrolyte solution is an about 0.1% NaCl aqueous solution, which is prepared from 1st grade sodium chloride and ISOTON-II (by Beckman Coulter, Inc.) is available for example. A sample of 2 to 20 mg is added to the electrolyte solution, which is then ultrasonically dispersed for 1 to 3 minutes using a ultrasonic dispersing device, thereafter volume and number of the toner particles are measured by the Coulter counter TA-II using an aperture of 100 μm to calculate the volume distribution and the number distribution, from which the volume average particle diameter and the number average particle diameter are determined.

In order to measure particles having a particle diameter of no less than 2.00 μm to less than 40.30 μm, thirteen channels are used such as 2.00 μm≦Pd<2.52 μm, 2.52 μm≦Pd<3.17 μm, 3.17 μm≦Pd<4.00 μm, 4.00 μm≦Pd<5.04 μm, 5.04 μm≦Pd<6.35 μm, 6.35 μm≦Pd<8.00 μm, 8.00 μm≦Pd<10.08 μm, 10.08 μm≦Pd<12.70 μm, 12.70 μm≦Pd<16.00 μm, 16.00 μm≦Pd<20.20 μm, 20.20 μm≦Pd<25.40 μm, 25.40 μm≦Pd<32.00 μm and 32.00 μm≦Pd<40.30 μm. From these data, volume average particle diameter Dv and number average particle diameter Dn are determined on the basis of volume distribution and number distribution, then the ratio Dv/Dn is determined.

The inventive toner is preferably those formed into particles by way of dispersing and/or emulsifying an oil phase and/or monomer phase containing at least a toner composition and/or toner composition precursor into an aqueous medium; the resin of the toner binder is preferably a polyester resin described later.

On the basis of investigations of the present inventors in order to exhibit low temperature fixability more efficiently and to apply offset resistance after modifying by the prepolymer while maintaining high-temperature storage stability, it is preferred that polyester resin is used as the binder resin and the mass average molecular mass of the THF soluble matter of the polyester resin is 1,000 to 30,000. The reason is that the mass average molecular mass of less than 1,000 possibly deteriorates high-temperature storage stability due to higher content of oligomer components, and the mass average molecular mass of more than 30,000 possibly deteriorates offset resistance since modification by the prepolymer may be insufficient due to steric hindrance.

The molecular mass of the binder resin may be measured in the present inventive based on GPC (gel permeation chromatography) as follows.

A column is conditioned stably within a heat chamber at 40° C., THF as a solvent is flowed into the column at 1 mL/min under the temperature, and a THF sample solution, adjusted at a concentration of 0.05% to 0.6% by mass, is injected and measured in an amount of 50 to 200 μL. The molecular mass distribution of samples is calculated and determined on the basis of a relation between logarithmic values of a calibration curve formed from a number of mono-dispersion polystyrene standards and a counted number. The polystyrene standards for the calibration curve are those having a molecular mass of 6×10², 2.1×10³, 4×10³, 1.75×10⁴, 5.1×10⁴, 1.1×10⁵, 3.9×10⁵, 8.6×10⁵, 2×10⁶, and 4.48×10⁶ (by Pressure Chemical Co. or Tosoh Co.), preferably at least about 10 samples of standard polystyrenes are utilized. The detector is a RI (refractive index) detector.

When acid value of the polyester resin of the first binder resin is adjusted to 1.0 to 50.0 mgKOH/g, particle diameter may be possible by addition of basic compounds, and also toner properties such as particle low temperature fixability, hot offset resistance, high temperature storage stability, and charge stability may be enhanced still more. That is, when the acid value is above 50.0 mgKOH/g, elongation reaction or cross-linking reaction of modified polyester is insufficient, and the hot offset resistance may be adversely affected, and when the acid value is below 1.0 mgKOH/g, the effect to stabilize dispersion may be unobtainable from basic compounds and the elongation reaction or cross-linking reaction of modified polyester tends to excessively rapid, which being problematic for production stability.

### Method to Measure Acid Value

The acid value is measured in accordance with the procedures described in JIS K0070-1992 as follows. As regards sample preparation, a polyester sample of 0.5 g is added to 120 mL of THF and the sample is dissolved by stirring at room temperature (23° C.) for 10 hours, to which 30 mL of ethanol is added to prepare a sample solution.

The acid value may be calculated in the measuring device described above, specifically, the calculation is as follows. The solution is titrated with pre-determined N/10 potassium hydroxide alcohol solution and the acid value is obtained from the consumed amount of the potassium hydroxide alcohol solution in accordance with the calculation as follows.

acid value=KOH(mL)×N×56.1/sample mass

in which, N is a factor of N/10 KOH.

When a polyester resin, which being preferable for the resin in ingredients of the inventive toner, is measured for the acid value, the specific procedures are based on JIS K0070 as follows. The solvent is THF.

The acid value is determined specifically by the following procedures.

Measuring device: Potentiometric Automatic Titrator DL-53 (by Mettler-Toledo K.K.)

Electrode: DG113-SC (Mettler-Toledo K. K.)

Analysis software: LabX Light Version 1.00.000

Correction: use of mixture solvent of toluene 120 mL and ethanol 30 mL

Measuring temperature: 23° C.
Measuring conditions are as follows:

Stir
Speed (%): 25
Time (s): 15

EQP titration
2 0 Titrant/Sensor
   Titrant: CH₃ONa
   Concentration (mole/L): 0.1
   Sensor: DG115
   Unit of measurement: mV
Predispensing to volume
   Volume (mL): 1.0
   Wait time (s): 0
Titrant addition: Dynamic
   dE (set) (mV): 8.0
   dV (min) (mL): 0.03
   dV (max) (mL): 0.5
Measure mode: Equilibrium controlled
   dE (mV): 0.5
   dt (s): 1.0
   t (min) (s): 2.0
   t (max) (s): 20.0
Recognition
   Threshold: 100.0
   Steepest jump only: No
   Range: No
   Tendency: None
Termination
   At maximum volume (mL): 10.0
   at potential: No
   at slope: No
   after number EQPs: Yes
      n=1
   comb. Termination conditions: No
Evaluation
   Procedure: Standard
   Potential 1: No
   Potential 2: No
   Stop for reevaluation: No

In the present invention, high temperature storage stability of the modified polyester resin, i.e. the main ingredient of the binder resin, depends on the glass transition temperature of the unmodified polyester resin, therefore, it is preferred to design the glass transition temperature of the polyester resin in a range of 35° C. to 65° C. The glass transition temperature of below 35° C. may lead to insufficient high temperature storage stability, and the glass transition temperature of above 65° C. adversely affects low temperature fixability.

The glass transition temperature Tg may be measured in the present invention under a temperature rising rate of 10° C./min using Rigaku THRMOFLEX TG8110 (by Rigaku Co.).

The procedures to measure Tg will be generally explained. The system to measure Tg is TG-DSC system TAS-100 (by Rigaku Co.).

Initially, a sample of about 10 mg is filled in a sample container made of aluminum, and the sample container is placed on a holder unit and set in an electric furnace. The sample container is then heated from room temperature to 150° C. under a temperature rising rate of 10° C./min, maintained at 150° C. for 10 minutes, then is cooled to room temperature and allowed to stand for 10 minutes, then heated again in nitrogen gas atmosphere to 150° C. under a temperature rising rate of 10° C./min to measure DSC. Tg is calculated from a tangent line of an endothermic curve in the vicinity of Tg and a contact point of the base line using an analysis system in TAS-100 system.

On the basis of investigations of the present inventors, the prepolymer to modify the polyester resin is an important component of the binder resin in order to achieve low temperature fixability and high temperature offset resistance, and the mass average molecular mass is preferably 3,000 to 20,000. That is, when the mass average molecular mass is below 3,000, it is difficult to control reaction velocity, which may be problematic in production stability. When the mass average molecular mass is above 20,000, satisfactory modified polyester may be unobtainable and offset resistance may be adversely affected.

On the basis of further investigations of the present inventors, it has been found that acid value of toner is a factor more important than acid value of the binder resin with respect to low temperature fixability and high temperature offset resistance. The acid value of the inventive toner depends on terminal carboxyl group of the unmodified polyester. It is preferred that the acid value of the unmodified polyester is adjusted to 0.5 to 40.0 mgKOH/g in order to control low temperature fixability such as lower-limit fixing temperature and hot offset generating temperature. When the acid value of toner is above 40.0 mgKOH/g, elongation reaction or cross-linking reaction of modified polyester is insufficient, and the hot offset resistance may be adversely affected, and when the acid value is below 0.5 mgKOH/g, the effect to stabilize dispersion may be unobtainable from basic compounds and the elongation reaction or cross-linking reaction of modified polyester tends to excessively rapid, which being problematic for production stability.

The acid value is specifically determined in accordance with the measuring method of the polyester resin described above. When there exists THF insoluble matter, the acid value of toner indicates the value measured by use of THF as the solvent.

### Method to Measure Acid Value of Toner

The acid value is measured in accordance with the procedures described in JIS K0070-1992 as follows. As regards sample preparation, a toner of 0.5 g (component soluble in ethyl acetate: 0.3 g) is used in place of the polyester.

The glass transition temperature of the toner used in the inventive developer is preferably 40° C. to 70° C. in order to achieve low temperature fixability, high temperature storage stability, and high durability. That is, when the glass transition temperature is below 40° C., blocking in developing devices or filming on photoconductors tends to generate, and when the glass transition temperature is above 70° C., low temperature fixability may be impaired.

The toner used in the inventive developer may be prepared by way of dissolving or dispersing at least a binder ingredient of modified polyester resin capable of reacting with active hydrogen and a toner ingredient of a colorant in an organic solvent to form a solution or dispersion, then the solution or dispersion is reacted with a cross-linking agent and/or an elongating agent in an aqueous medium containing a dispersant, and the solvent is removed from the resulting dispersion.

The reactive modified polyester resins (RMPE), useful in the present invention, capable of reacting with active hydrogen are exemplified by polyester prepolymers (A) having an isocyanate group. The prepolymers (A) are exemplified by polycondensation products of polyesters, of polyols (PO) and polycarboxylic acids (PC), having active hydrogen that are further reacted with polyisocyanates (PIC).

The groups having active hydrogen in the polyesters are exemplified by hydroxyl group (alcoholic hydrogen group and phenolic hydroxyl group), amino group, carboxyl group, and mercapto group; among these, preferable is alcoholic hydroxyl group.

Amines are used for a cross-linking agent of the reactive modified polyester resins, and diisocyanate compounds such as diphenylmethane diisocyanate are used for an elongating agent. The amines, described later in detail, may act as a cross-linking agent or an elongating agent for modified polyesters capable of reacting with active hydrogen.

Modified polyesters such as urea-modified polyesters, prepared by reacting polyester prepolymers (A) having an isocyanate group with amines (B), may be easily adjusted for molecular mass of the polymer ingredient and thus favorable for assuring dry toner, in particular oil-less low temperature fixability, e.g. releasing property and fixability for fixing heating media without demolding oil-coating mechanism. Polyester prepolymers, of which terminal being urea-modified, may suppress adhesion property to the fixing heating media while maintaining high flowability and transparency of the unmodified polyester resins themselves at the fixing temperature.

The polyester prepolymer favorable in the present invention is the polyesters, which have an active hydrogen group such as acid groups and a hydroxyl group at terminal, to which a functional group such as isocyanate group reactive with the active hydrogen is introduced. Modified polyesters (MPE) such as urea-modified polyesters may be derived from the prepolymers; modified polyesters preferable for the binder resin in the present invention are urea-modified polyesters that are prepared by reacting a polyester prepolymer (A) having an isocyanate group with an amine (B) as a cross-linking agent and/or an elongating agent.

The polyester prepolymers (A) having an isocyanate group may be prepared by reacting a polyester, which being a polycondensation product of polyol (PO) and polycarboxylic acid (PC) and having active hydrogen group, with a polyisocyanate (PIC).

The active hydrogen group of the polyester is exemplified by hydroxyl group (alcoholic hydrogen group and phenolic hydroxyl group), amino group, carboxyl group, and mercapto group as described above; among these, preferable is alcoholic hydroxyl group.

Examples of the polyols (PO) include diols (DIO) and trivalent or more polyols (TO), and preferable are diols themselves and mixtures of diols with a small amount of TO.

Examples of the diols (DIO) include alkylene glycols such as ethylene glycol, 1,2-propylene glycol, 1,3-propylene glycol, 1,4-bytandiol, and 1,6-hexanediol; alkylene ether glycols such as diethylene glycol, triethylene glycol, dipropylene glycol, polyethylene glycol, polypropylene glycol, and polytetramethylene ether glycol; alicyclic diols such as 1,4-cyclohexane dimethanol, and hydrogenated bisphenol A; bisphenols such as bisphenol A, bisphenol F, and bisphenol S; alkylene oxide adducts of the above-noted alicyclic diols such as ethylene oxide, propylene oxide, and butylene oxide; and alkylene oxide adducts of the above-noted bisphenols such as ethylene oxide, propylene oxide, and butylene oxide.

Among these described above, alkylene glycols having a carbon number of 2 to 12 and alkylene oxide adducts of bisphenols are preferable; and alkylene oxide adducts of bisphenols and combinations of these adducts with an alkylene glycol having a carbon number of 2 to 12 are particularly preferable. Examples of the trivalent or more polyols (TO) include polyaliphatic alcohols of trivalent to octavalent or more such as glycerin, trimethylol ethane, trimethylol propane, pentaerythritol, and sorbitol; and trivalent or more phenols such as trisphenol PA, phenol novolac, and cresol novolac; and alkylene oxide adduct of the trivalent or more polyphenols.

Examples of the polycarboxylic acid (PC) include dicarboxylic acids (DIC) and trivalent or more polycarboxylic acids (TC), and preferable are dicarboxylic acids themselves and mixtures of dicarboxylic acid (DIC) with a small amount of a polyvalent carboxylic acid (TC). Examples of the dicarboxylic acid (DIC) include alkylene dicarboxylic acids such as succinic acid, adipic acid, and sebacic acid; alkenylen dicarboxylic acids such as maleic acid and fumaric acid; aromatic dicarboxylic acids such as phthalic acid, isophthalic acid, terephthalic acid, and naphthalene dicarboxylic acid. Among these dicarboxylic acids, alkenylen dicarboxylic acids having a carbon number of 4 to 20 and aromatic dicarboxylic acids having a carbon number of 8 to 20 are preferable.

Examples of the trivalent or more polyvalent carboxylic acid (TC) include aromatic polyvalent carboxylic acids having a carbon number of 9 to 20 such as trimellitic acid and pyromellitic acid.

The polycarboxylic acid (PC) may be prepared by reacting an acid anhydride of the polycarboxylic acids described above or lower alkyl esters such as methyl ester, ethyl ester, and isopropyl ester with polyols (PO). The ratio of polyols (PO) to polycarboxylic acids (PC), defined as an equivalent ratio [OH]/[COOH] of a hydroxyl group [OH] to a carboxyl group [COOH], is typically 2/1 to 1/1, preferably 1.5/1 to 1/1, and more preferably 1.3/1 to 1.02/1.

Examples of the polyisocyanate compound (PIC) include aliphatic polyisocyanates such as tetramethylene diisocyanate, hexamethylene diisocyanate, and 2,6-diisocyanate; alicyclic polyisocyanates such as isophorone diisocyanate and cyclohexyl methane diisocyanate; aromatic diisocyanates such as tolylene diisocyanate and diphenylmethane diisocyanate; aromatic aliphatic diisocyanates such as α,α,α′α′-tetramethyl xylylene diisocyanate; isocyanates; these polyisocyanates blocked with a phenol derivative, an oxime, caprolactam, or the like; and combinations of two or more thereof.

The ratio of the polyisocyanate compound (PIC), defined as an equivalent ratio [NCO]/[OH] of an isocyanate group [NCO] to a hydroxyl group [OH] of a polyester having a hydroxyl group, is typically 5/1 to 1/1, preferably 4/1 to 1.2/1, and more preferably 2.5/1 to 1.5/1.

When [NCO]/[OH] is more than 5, low temperature fixability may be impaired. When urea-modified polyesters are used in the molar ratio of [NCO] is less than 1, the urea content of ester becomes lower, which making hot offset resistance insufficient.

The content of polyisocyanate (PIC) in the prepolymer (A) having an isocyanate group at the terminal is typically 0.5% to 40% by mass, preferably 1% to 30% by mass, and more preferably 2% to 20% by mass. When the content is less than 0.5% by mass, hot offset resistance may be impaired and it may be difficult to satisfy both of high temperature storage stability and low temperature fixability. On the other hand, when the content is more than 40% by mass, low temperature fixability may be poor.

The number of isocyanate groups per one molecule of the prepolymer (A) having isocyanate group is typically 1 or more, preferably 1.5 to 3 on average, and more preferably 1.8 to 2.5 on average. When the number of isocyanate groups is less than 1 per one molecule, the molecular mass of the urea-modified polyester may be lower, which making hot offset resistance poor.

The amines (B) are exemplified by diamines (B1), trivalent or more polyamines (B2), amino alcohols (B3), amino mercaptans (B4), amino acids (B5), and these compounds (B1 to B5) of which amino group being blocked (B6).

Examples of the diamines (B1) include aromatic diamines such as phenylene diamine, diethyl toluene diamine, and 4,4′-diamino diphenyl methane; alicyclic diamines such as 4,4′-diamino-3,3′-dimethyl dicyclohexyl methane, diamine cyclohexane, and isophorone diamine; and aliphatic diamines such as ethylene diamine, tetramethylene diamine, and hexamethylene diamine. Examples of the trivalent or more polyamines (B2) include diethylene triamine and triethylene tetramine. Examples of the amino alcohols (B3) include ethanol amine and hydroxyethyl aniline. Examples of the amino mercaptans (B4) include aminoethyl mercaptan and aminopropyl mercaptan. Examples of the amino acids (B5) include aminopropionic acid, aminocaproic acid, and the like. Examples of the compounds of which amino group being blocked (B6) include ketimine compounds between the amines B1 to B5 and ketones such as acetone, methyl ethyl ketone, and methyl isobuthyl ketone and oxazolidine compounds. Among these amines (B), preferable are diamines (B1) and mixtures of the diamines (B1) and a small amount of trivalent or more polyamines (B2).

If necessary, the molecular mass of the polyester may be controlled using an elongation terminator. Examples of the elongation terminators include monoamines such as diethylamine, dibutylamine, butylamine, and laurylamine; and block polymers thereof (e.g., ketimine compounds).

The ratio of amines (B), defined as an equivalent ratio [NCO]/[NHx] of isocyanate group [NCO] in a prepolymer having isocyanate group (A) to amine group [NHx] in amines (B), is typically 1/2 to 2/1, preferably 1.5/1 to 1/1.5, more preferably 1.2/1 to 1/1.2. When [NCO]/[NHx] is more than 2 or less than ½, the molecular mass of urea-modified polyester becomes lower, which possibly making hot offset resistance poor.

In the present invention, polyester resins are preferably urea-modified polyester resins (UMPE), and the urea-modified polyester resins may include a urethane bond as well as a urea bond. The molar ratio of the urea bond content to the urethane bond content is typically 100/0 to 10/90, preferably 80/20 to 20/80, and more preferably 60/40 to 30/70. When the molar ratio of the urea bond is less than 10%, hot offset resistance may be poor.

The modified polyesters such as urea-modified polyester resins (UMPE) may be produced by one-shot methods etc. The mass average molecular mass of the modified polyesters such as urea-modified polyester resins (UMPE) is typically 10,000 or more, preferably 20,000 to 10,000,000, and more preferably 30,000 to 1,000,000. The mass average molecular mass of below 10,000 may deteriorate hot offset resistance. The average molecular mass of the modified polyesters such as urea-modified polyester resins is not defined specifically when unmodified polyesters (PE) described later are used, and may be number average molecular mass in which the mass average molecular mass is obtainable. In cases where modified polyesters such as UMPE are used alone, the number average molecular mass is typically 2,000 to 15,000, preferably 2,000 to 10,000, and more preferably 2,000 to 8,000. The number average molecular mass of larger than 20,000 tends to impair low temperature fixability and glossiness in cases of full color apparatuses.

In the present invention, the modified polyesters such as urea-modified polyester resins (UMPE) may be used alone and also contain unmodified polyesters (PE) as a component of the binder resin. When PE is used together with, the low temperature fixability and glossiness in cases of full color apparatuses may be enhanced preferably than the cases of sole use.

The PE is exemplified by the polycondensation products of polyols (PO) and polycarboxylic acids of the polyester components similar as those of the UMPE, and preferable PE is similar as those of the UMPE.

The mass average molecular mass Mw of PE is 10,000 to 300,000, preferably 14,000 to 200,000. The number average molecular mass Mn is 1,000 to 10,000, preferably 1,500 to 6,000. The UMPE may be combined with chemically modified ones other than by urea bond such as urethane bond in addition to unmodified polyesters. It is preferred that the UMPE and the unmodified polyester are partially compatible in view of low temperature fixability and hot offset resistance. It is hence preferred that the polyester component of the UMPE is similar to that of the unmodified polyester (PE).

The mass ratio of the UMPE to the PE, when the PE being included, is typically 5/95 to 80/20, preferably 5/95 to 30/70, more preferably 5/95 to 25/75, and still more preferably 7/93 to 20/80. When the mass ratio of the UMPE is less than 5%, the hot offset resistance may be poor and also the high temperature storage stability and low temperature fixability may be deteriorated.

It is preferred that OH value (mgKOH/g) of the PE is no less than 5; the acid value (mgKOH/g) of the PE is typically 1 to 30, preferably 5 to 20. The range of the acid value allows negative charge and improves compatibility between paper and the toner at fixing steps, which enhances low temperature fixability. However, acid values higher than 30 may impair charge stability and be problematic under environmental fluctuation in particular. The fluctuation of the acid value may lead to fluctuation in granulating steps in polymerization reaction, which makes difficult to control emulsification.

### Method to Measure OH Value

The conditions of measuring devices are substantially same as those of the acid value described above.

A sample of 0.5 g is precisely weighed into a measuring flask of 100 mL, to which 5 mL of an acetylating reagent is correctly added, then the measuring flask is immersed into a bath at 100° C.±5° C. to heat the flask. The flask is taken out from the bath after 1 to 2 hours to allow to cool, then water is added and shaken to decompose acetic anhydride. In order to complete the decomposition, the flask is heated again in the bath for no shorter than 10 minutes, then the wall of the flask is rinsed well with an organic solvent. The liquid is subjected to potentiometric titration by N/2 potassium hydroxide ethyl alcohol solution using the electrode described above to determine OH value (in accordance with JIS K0070-1966).

In the present invention, the glass transition temperature (Tg) of the binder resin is typically 40° C. to 70° C., and preferably 40° C. to 60° C. When Tg is below 40° C., heat resistance of the toner is poor, and when above 70° C., low temperature fixability is insufficient. The dry toner of the present invention tends to represent proper high temperature storage stability even having lower glass transition temperatures, compared to conventional toners based on polyester resins, when the modified polyester such as the urea-modified polyester resins etc. exists in combination.

### Releasing Agent

As regards waxes used for the toner of the inventive developer, waxes having a lower melting point of 50° C. to 120° C. may perform effectively between fixing rollers and toner interface as a releasing agent through dispersing with binder resins and effect on hot offset resistance with no use of releasing agents such oils on fixing rollers.

The melting point of waxes in the present invention indicates a maximum endothermic peak by use of a differential scanning calorimeter (DSC).

The ingredient of waxes useful in the present invention may be the substances as follows; specific examples of the waxes include vegetable waxes such as carnauba wax, cotton wax, wood wax, and rice wax; animal waxes such as bees wax and lanolin; mineral waxes such as ozokerite and selsyn; and petroleum wax such as paraffin, microcrystalline, and petrolatum. In addition to the natural waxes, synthetic hydrocarbon waxes such as Fischer-Tropsch wax and polyethylene wax and synthetic waxes such as of esters, ketones, and ethers are exemplified. Furthermore, available are fatty acid amides such as 12-hydroxystearic acid amide, stearic acid amide, phthalic anhydride imide, and chlorinated hydrocarbon; crystalline polymer resins of low molecular mass such as homopolymes or copolymers of polyacrylates of poly-n-stearyl methacrylate or poly-n-lauryl methacrylate (e.g. copolymer of n-stearyl acrylate-ethyl methacrylate); and crystalline polymers having a long alkyl group in a side chain.

### Colorant

The colorant useful for the toner in the inventive developer may be properly selected from conventional dyes and pigments; examples thereof include carbon black, nigrosine dyes, iron black, Naphthol Yellow S, Hansa Yellow (10G, 5G, G), cadmium yellow, yellow iron oxide, yellow ocher, chrome yellow, Titan Yellow, Polyazo Yellow, Oil Yellow, Hansa Yellow (GR, A, RN, R), Pigment Yellow L, Benzidine Yellow (G, GR), Permanent Yellow (NCG), Vulcan Fast Yellow (5G, R), Tartrazine Lake, Quinoline Yellow Lake, anthracene yellow BGL, isoindolinone yellow, colcothar, red lead oxide, lead red, cadmium red, cadmium mercury red, antimony red, Permanent Red 4R, Para Red, Fire Red, parachlororthonitroaniline red, Lithol Fast Scarlet G, Brilliant Fast Scarlet, Brilliant Carmine BS, Permanent Red (F2R, F4R, FRL, FRLL, F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, eosine lake, Rhodamine Lake B, Rhodamine Lake Y, Alizarine Lake, Thioindigo Red B, Thioindigo Maroon, Oil Red, quinacridone red, Pyrazolone Red, Polyazo Red, Chrome Vermilion, Benzidine Orange, Perynone Orange, Oil Orange, cobalt blue, cerulean blue, Alkali Blue Lake, Peacock Blue Lake, Victoria Blue Lake, metal-free phthalocyanine blue, Phthalocyanine Blue, Fast Sky Blue, Indanthrene Blue (RS, BC), indigo, ultramarine, Prussian blue, Anthraquinone Blue, Fast Violet B, Methyl Violet Lake, cobalt violet, manganese violet, dioxazine violet, Anthraquinone Violet, chrome green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc white, lithopone and combinations thereof. The amount of the colorant is typically 1% to 15% by mass based on the toner, preferably 3% to 10% by mass.

The colorant useful in the present invention may be mixed with a resin to use as a masterbatch.

The binder resin, used for producing the masterbatch or mixed with the colorant, may be, in addition to modified or unmodified polyester resins described above, polymers of styrene or its derivative substitutions such as polystyrene, poly-p-chlorostyrene, and polyvinyltoluene; styrene copolymers such as styrene/p-chlorostyrene copolymer, styrene-propylene copolymer, styrene-vinyltoluene copolymer, styrene-vinylnaphthalene copolymer, styrene-methylacrylate copolymer, styrene-ethylacrylate copolymer, styrene-butylacrylate copolymer, styrene-octylacrylate copolymer, methylmethacrylate copolymer, styrene-ethylmethacrylate copolymer, styrene-butylmethacrylate copolymer, styrene-α-chloromethylmethacrylate copolymer, styrene-acrylonitrile copolymer, styrene-vinylmethylketone copolymer, styrene-butadiene copolymer, styrene-isoprene copolymer, styrene-acrylonitrile-indene copolymer, styrene-maleic acid copolymer and styrene-maleic acid ester copolymer; polymethylmethacrylate, polybutylmethacrylate, polyvinylchloride, polyvinyl acetate, polyethylene, polypropylene, polyester, epoxy resins, epoxy polyol resins, polyurethane, polyamide, polyvinylbutyral, polyacrylic acid resins, rosin, modified rosin, terpene resins, aliphatic or cycloaliphatic hydrocarbon resins, aromatic petroleum resins, chlorinated paraffin and paraffin wax. These may be used alone or in combination.

The process to produce the masterbatch may be properly selected; for example, a resin and a colorant for the masterbatch are mixed and kneaded under a high shear force. An organic solvent may be used in the method in order to enhance the interaction between the colorant and the resin. Such a so-called flushing process may also be available, in which an aqueous paste containing the colorant and water is mixed and kneaded with a resin and an organic solvent, the colorant is transferred toward the resin, and the water and the organic solvent are removed. The process is an appropriate process for producing the masterbatch since the wet cake of the colorant can be directly used without drying. The mixing and kneading is preferably carried out using high-shear dispersing devices such as three-roll mills.

In conventional production processes of electrophotographic toners, particles containing a colorant and a resin and particles of a charge control agent are mixed using rotating devices in vessels in order to deposit and fix the charge control agent on surface of toner particles; in the present invention, desirable toner particles may be obtained through a step of mixing at a circumferential velocity of 40 to 150 m/sec within vessels with no projections from inner wall in accordance with the production processes.

The inventive toner may contain a charge control agent as required. The charge control agent may be properly selected from conventional ones; examples thereof include nigrosine dyes, triphenylmethane dyes, chromium-containing metal complex dyes, molybdic acid chelate pigments, rhodamine dyes, alkoxy amines, quaternary ammonium salts such as fluoride-modified quaternary ammonium salts, alkylamides, elemental phosphorus or compounds thereof, elemental tungsten or compounds thereof, fluoride activators, metallic salts of salicylic acid, and metallic salts of salicylic acid derivatives. The charge control agent may be commercially available ones; examples thereof include Bontron 03 of nigrosine dye, Bontron P-51 of quaternary ammonium salt, Bontron S-34 of metal-containing azo dye, Bontron E-82 of oxynaphthoic acid metal complex, Bontron E-84 of salicylic acid metal complex, and Bontron E-89 of phenol condensate (by Orient Chemical Industries, Ltd.); TP-302 and TP-415 of quaternary ammonium salt molybdenum metal complex (by Hodogaya Chemical Co.); Copy Charge PSY VP2038 of quaternary ammonium salt, Copy Blue PR of triphenylmethane derivative, and Copy Charge NEG VP2036 and Copy Charge NX VP434 of quaternary ammonium salt (by Hoechst Ltd.); LRA-901, and LR-147 of boron metal complex (by Japan Carlit Co., Ltd.), copper phthalocyanine, perylene, quinacridone, azo pigment, and other polymer compounds having a functional group, such as sulfonic acid group, carboxyl group, and quaternary ammonium salt.

The amount of the charge control agent in the toner is unnecessary to define specifically and depends on species of the resins, existence or nonexistence of optional additives, dispersing processes, etc.; preferably, the amount is 0.1 to 10 parts by mass based on the binder resin, more preferably 0.2 to 5 parts by mass. When the amount is above 10 parts by mass, the charging ability of the toner is excessively large, which possibly decreasing the effect of the charge control agent, and lowering flowability of developers or reducing image density due to higher electrostatic attraction with developing rollers. The charge control agent and the releasing agent may be incorporated into the masterbatch or melted and kneaded mixed with resins or added to organic solvents to dissolve or disperse.

As regards of toners used in the present invention, external additives may be optionally added in order to improve flowability, developing ability, or charging ability of colored particles. The external additives may be favorably selected from inorganic fine particles.

The primary particle diameter of the inorganic fine particles is preferably 5 nm to 2 μm, more preferably 5 to 500 nm. The specific surface area of the inorganic fine particles is preferably 20 to 500 m²/g measured in accordance with BET method. The amount of the inorganic fine particles is preferably 0.01% to 5.0% by mass in the toner, more preferably 0.01% to 2.0% by mass.

Specific examples of the inorganic fine particles useful for the external additive include silica, alumina, titanium oxide, barium titanate, magnesium titanate, calcium titanate, strontium titanate, zinc oxide, tin oxide, quartz sand, clay, mica, silicic pyroclastic rock, diatomaceous earth, chromic oxide, cerium oxide, iron oxide red, antimony trioxide, magnesium oxide, zirconium oxide, barium sulfate, barium carbonate, calcium carbonate, silicon carbide, silicon nitride, and the like.

Among these, the combination of hydrophobic silica fine particles and hydrophobic titanium oxide fine particles is preferable as the flowability improver. It has become apparent in particular that when these particles, of which average particle diameter being no more than 50 nm, are used in combination and mixed and stirred, high quality images may be obtained while far from separating the flowability improver from toners without voids even under stirring and mixing inside developing devices to attain a desirable charge level since electrostatic force and Van der Waals force with toners are considerably enhanced and also residual toners after transfer may be reduced.

It may be considered that the titanium oxide particles adversely affect on charge rising property when the amount on the titanium oxide particles is larger than the amount of the silica fine particles since the titanium oxide particles is likely to be poor in charge rising property in contrast to excellent environmental stability and image density stability. It has been found, however, that the amount of hydrophobic silica fine particles and hydrophobic titanium oxide fine particles in a range of 0.3% to 1.5% by mass may not impair significantly the charge rising property and bring about desirable charge rising property, that is, stable image quality is obtainable and toner blowout may be suppressed even under repeated copies.

The resin for toner binder may be produced by the processes as follows.

A polyol (PO) and a polycarboxylic acid (PC) are heated to 150° C. to 280° C. in the presence of conventional esterification catalyst such as tetrabutoxy titanate and dibutyltinoxide, and the generating water is distilled away under reduced pressure as required thereby to prepare a polyester having a hydroxyl group. Then the polyester is reacted with polyisocyanate (PIC) at 40° C. to 140° C. to prepare a polyester prepolymer (A) having an isocyanate group. Further, the prepolymer (A) is reacted with an amine (B) at 0° C. to 140° C., to prepare a urea-modified polyester (UMPE).

The number average molecular mass of the modified polyester is 1,000 to 10,000, preferably 1,500 to 6,000. When the polyisocyanate (PIC) is reacted or the polyester prepolymer (A) and the amine (B) are reacted, a solvent may be used as required.

The useful solvents are those inactive with isocyanates (PIC), and specific examples thereof include aromatic solvents such as toluene and xylene; ketones such as acetone, methyl ethyl ketone and methyl isobutyl ketone; esters such as ethyl acetate; amides such as dimethylformamide and dimethylacetoaminde; and ethers such as tetrahydrofuran. When a urea-unmodified polyester (PE) is used in combination, the polyester (PE) is produced in a similar manner as the polyester having a hydroxyl group, then which is dissolved and mixed with the solution of the reacted urea-modified polyethylene.

The inventive toner may be produced by the methods as follows, but is not limited thereto.

### Toner Production Method in Aqueous Medium

Suitable aqueous media for use in the production method of the inventive toner may be water itself or water and solvents soluble therewith. Examples of the soluble solvent include alcohols such as methanol, isopropanol, and ethylene glycol; dimethylformamide, tetrahydrofuran; cellosolves such as methyl cellosolve; and lower ketones such as acetone and methyl ethyl ketone.

In the present invention, reactive modified polyesters such as polyester prepolymers (A) having an isocyanate group are reacted with amines (B) in aqueous media thereby to prepare urea-modified polyesters (UMPE). As regards the process to prepare stably a dispersion of modified polyesters such as urea-modified polyesters or reactive modified polyesters such as polyester prepolymers (A) in aqueous media, toner ingredients including modified polyesters such as urea-modified polyesters or reactive modified polyesters such as polyester prepolymers (A) are added to the aqueous media and dispersed by action of shear force. The reactive modified polyesters such as polyester prepolymers (A) and other toner ingredients (hereinafter referred to as “toner raw materials”) such as a colorant, colorant masterbatch, releasing agent, charge control agent, and unmodified polyester resin may be mixed while the dispersion is formed; preferably, the toner raw materials are preliminarily mixed, then the mixture is added to the aqueous medium to disperse them. The toner raw materials such as colorants, release agents, and charge controlling agents are not necessarily added to the aqueous media when particles are formed, and may be added after particles are prepared in the aqueous medium. For example, particles are previously formed with no colorant, then a colorant may be added by conventional coloring processes.

The dispersing process is not limited specifically, and conventional devices for low speed shearing, high-speed shearing, friction, high-pressure jet, and ultrasonic processes are available. The high-speed shearing processes are preferable in order to prepare dispersion having a particle diameter of 2 to 20 μm. In cases where high-speed shearing dispersing devices are employed, the rotating number is typically 1,000 to 30,000 rpm, preferably 5,000 to 20,000 rpm, but is not limited thereto. The dispersion is typically 0.1 to 5 minutes in batch systems, but is not limited thereto. The temperature at dispersing steps is typically 0° C. to 150° C. (under pressure), and preferably 40° C. to 98° C. The higher is the temperature the lower is the viscosity of dispersion of the urea-modified polyesters or prepolymers (A), and which is more favorable since dispersing process is easier.

The amount of the aqueous media is typically 50 to 2,000 parts by mass based on 100 parts by mass of the toner ingredients containing urea-modified polyesters and/or polyesters such as prepolymers (A), preferably 100 to 1,000 parts by mass. The amount of below 50 parts by mass possibly leads to inferior dispersing condition of toner ingredients and toner particles are far from intended particle diameters. The amount of above 20,000 parts by mass is undesirable in view of cost. A dispersant may be added as required and favorably used to narrow the particle diameter distribution and make the dispersion stable.

A dispersant may be selected from various ones to emulsify or disperse the liquid that contains water and an oily phase into which the toner ingredients being dispersed. The dispersant may be surfactants, dispersants for inorganic fine particles, or dispersants for polymer fine particles.

Examples of the surfactants include anionic surfactants such as alkylbenzene sulfonic acid salts, α-olefin sulfonic acid salts, phosphoric acid esters; cationic surfactants like amine salt surfactants such as alkyl amine salts, aminoalcohol fatty acid derivatives, polyamine fatty acid derivatives, and imidazoline and like quaternary ammonium salt surfactants such as alkyltrimethyl ammonium salts, dialkyldimethyl ammonium salts, alkyldimethyl benzyl ammonium salts, pyridinium salts, alkyl isoquinolinium salts, and benzethonium chloride; non-anionic surfactants such as fatty acid amide derivatives and polyhydric alcohol derivatives; and ampholytic surfactants such as alanine, dodecyldi(aminoethyl)glycin, di(octylaminoethyl)glycin, and N-alkyl-N,N-dimethylammonium betaine.

Surfactants having a fluoroalkyl group may exhibit the effect even in a very small amount. Preferable examples of anionic surfactants having a fluoroalkyl group are fluoroalkyl carboxylic acids of C₂ to C₁₀ or metal salts thereof, disodium perfluorooctane sulfonylglutamate, 3-[ω-fluoroalkyl(C₆ to C₁₁)oxy]-1-alkyl(C3 to C₄)sodium sulfonate, 3-[ω-fluoroalkanoyl(C₆ to C₈)-N-ethylamino]-1-sodium propanesulfonate, fluoroalkyl(C₁₁ to C₂₀)carboxylic acids or metal salts thereof, perfluoroalkyl(C₇ to C₁₃)carboxylic acids or metal salts thereof, perfluoroalkyl(C₄ to C₁₂)sulfonic acid or metal salts thereof, perfluorooctanesulfonic acid diethanol amide, N-propyl-N-(2-hydroxyethyl)perfluorooctanesulfone amide, perfluoroalkyl(C₆ to C₁₀)sulfoneamide propyltrimethyl ammonium salts, perfluoroalkyl(C₆ to C₁₀)-N-ethylsulfonyl glycin salts, and monoperfluoroalkyl(C₆ to C₁₆)ethylphosphate ester, and the like.

Examples of commercially available anionic surfactants are Surflon S-111, S-112 and S-113 (by Asahi Glass Co.); Frorard FC-93, FC-95, FC-98 and FC-129 (by Sumitomo 3M Ltd.); Unidyne DS-101 and DS-102 (by Daikin Industries, Ltd.); Megafac F-110, F-120, F-113, F-191, F-812 and F-833 (by Dainippon Ink and Chemicals, Inc.); ECTOP EF-102, 103, 104, 105, 112, 123A, 123B, 306A, 501, 201 and 204 (by Tohchem Products Co.); Futargent F-100 and F150 (by Neos Co.).

Specific examples of the cationic surfactants are primary, secondary and tertiary aliphatic amines having a fluoroalkyl group, aliphatic quaternary ammonium salts such as of perfluoroalkyl(C₆ to C₁₀)sulfoneamide propyltrimethyl ammonium salts, benzalkonium salts, benzetonium chloride, pyridinium salts, imidazolinium salts, etc.

Article names of the commercially available products thereof are exemplified by SURFLON S-121 (by Asahi Glass Co.); FRORARD FC-135 (by Sumitomo 3M Co.); UNIDYNE DS-202 (by Daikin Industries, Ltd.); MEGAFACE F-150 and F-824 (by Dainippon Ink and Chemicals, Inc.); ECTOP EF-132 (by Tohchem Products Co.); FUTARGENT F-300 (by Neos Co.), and the like.

In addition, dispersants of inorganic compounds hardly soluble in water are available, such as tricalcium phosphate, calcium carbonate, titanium oxide, colloidal silica, and hydroxyapatite.

In addition, certain polymers of fine particles may exhibit similar effects as the inorganic dispersants; examples thereof include MMA polymer fine particles of 1 μm and 3 μm, styrene fine particles of 0.5 μm and 2 μm, and styrene-acrylonitrile polymer fine particles of 1 μm (PB-200H (by Kao Co.), SGP (JRI Solutions, Ltd.), Techno Polymer SB (Sekisui Plastics Co.), SGP-3G (JRI Solutions, Ltd.), and Micropal (Sekisui Fine Chemical Co.).

In addition, as regards dispersants available in combination with the inorganic dispersants or the polymers of fine particles, the dispersed liquid droplets may be stabilized by use of polymer protective colloid; specific examples of such protective colloids include acids such as acrylic acid, methacrylic acid, α-cyanoacrylic acid, α-cyanomethacrylic acid, itaconic acid, crotonic acid, fumaric acid, maleic acid, and maleic anhydride; (meth)acrylic monomers having a hydroxyl group such as β-hydroxyethyl acrylate, β-hydroxypropyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethyleneglycolmonoacrylic acid esters, diethyleneglycolmonomethacrylic acid esters, glycerinmonoacrylic acid esters, N-methylolacrylamide, and N-methylolmethacrylamide; vinyl alcohol and its ethers such as vinyl methyl ether, vinyl ethyl ether, and vinyl propyl ether; esters of vinyl alcohol with a compound having a carboxyl group such as vinyl acetate, vinyl propionate, and vinyl butyrate; acrylic amides such as acrylamide, methacrylamide, and diacetoneacrylamide and their methylol compounds; acid chlorides such as acrylic acid chloride and methacrylic acid chloride; homopolymers or copolymers of monomers having a nitrogen atom or a heterocycle having a nitrogen atom such as of vinyl pyridine, vinyl pyrrolidone, vinyl imidazole, and ethylene imine; polyoxyethylene compounds such as polyoxyethylene, polyoxypropylene, polyoxyethylenealkyl amines, polyoxypropylenealkyl amines, polyoxyethylenealkyl amides, polyoxypropylenealkyl amides, polyoxyethylene nonylphenyl ethers, polyoxyethylene laurylphenyl ethers, polyoxyethylene stearylphenyl esters, and polyoxyethylene nonylphenyl esters; and cellulose compounds such as methyl cellulose, hydroxyethyl cellulose, and hydroxypropyl cellulose.

The resulting emulsified dispersion (reaction product) is stirred and converged at a certain temperature range below the glass transition temperature of the resin at a certain concentration range in the organic solvent to prepare coagulated particles and the entire reactant is heated gradually while stirring under a laminar flow to remove the solvent thereby deformed toner particles may be prepared. When alkali- and acid-soluble substances such as calcium phosphate are used as a dispersion stabilizer, the calcium phosphate is removed by way that the calcium phosphate is dissolved using acids such as hydrochloric acid and rinsed by water, for example. The calcium phosphate may also be removed by decomposing using enzymes. When dispersants are used, the toner may be used in the condition that the dispersants remain on surface of toner particles.

In addition, solvents capable of dissolving polyesters such as urea-modified polyester and prepolymer (A) can be used for decreasing viscosity of dispersing media containing toner ingredients. The solvent may be favorably used in order to narrow the particle diameter distribution. The solvent is volatile such that its boiling point is lower than 100° C. so as to be easily removed.

The solvent may be exemplified by toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone and methyl isobutyl ketone. These may be used alone or in combination of two or more. Among these, preferable are aromatic solvents such as toluene and xylene and halogenated hydrocarbons such as methylene chloride, 1,2-dichloroethane, chloroform, and carbon tetrachloride.

The amount of the solvent is typically 0 to 300 parts based on 100 parts of the prepolymer (A), preferably 0 to 100 parts, more preferably 25 to 70 parts. After the solvents are used for elongation and/or cross-linking reaction of modified polyesters (prepolymer) with amines, the solvents are removed from the resulting reaction product under normal or reduced pressure.

The period for elongation and/or cross-linking reaction may be properly selected based on reactivity that depends on the combination between structure of an isocyanate group that the prepolymer (A) has and an amine (B), typically the period is 10 minutes to 40 hours, preferably 2 to 24 hours. The reaction temperature is typically 0° C. to 150° C., preferably 40° C. to 98° C. Conventional catalysts may be employed as required; examples thereof include dibutyltin laurate and dioctyltin laurate. The amines (B) are used as an elongating agent and/or cross-linking agent.

It is preferred in the present invention that the dispersion liquid is stirred and converged at a certain temperature range below the glass transition temperature of the resin at a certain concentration range in the organic solvent to prepare coagulated particles and the shape is confirmed before removing the solvent from the dispersion liquid (reactant liquid) after the elongation and/or cross-linking reaction, then the solvent is removed at 10° C. to 50° C. The stirring of the liquid before removing the solvent may lead to deformation of the toner. The deformation can be assured in the present invention since the layered inorganic mineral of which at least a part of ions between layers being modified by an organic ion is contained in particular.

The conditions to form particles are not defined absolutely, thus the conditions should be selected properly. In this relation, when the concentration of organic solvents is higher in the stage of forming particles, the viscosity of the emulsion liquid is lower and the particle shape of coagulated droplets tends to be spherical, thus the viscosity should be appropriately adjusted.

In addition, when the concentration of organic solvents is lower in the stage of forming particles, the viscosity of the emulsion liquid is higher and the particle shape is out of complete one particle. Thus an optimum condition should be defined and selection of conditions can lead to appropriate adjustment of the toner shape.

The particle shape can also be adjusted in the present invention by the content of the layered inorganic mineral of which at least a part of ions between layers being modified by an organic ion (organic-modified layered inorganic mineral). The content of the organic-modified layered inorganic mineral is preferably 0.05% to 10% in the solid content of the solution or dispersion liquid. When the content is below 0.05%, the intended viscosity of the oil phase is unobtainable and the intended shape is also unobtainable. Since the viscosity of liquid droplets is lower, the shape comes to spherical rather than intended coagulated particles even when liquid droplets coagulate while stirring and conversing. When the content is above 10%, the productivity is deteriorated, excessively high viscosity prevents particles to coagulate each other and also fixability degrades.

On the other hand, the ratio Dv/Dn of the volume average particle diameter Dv and the number average particle diameter Dn of the toner may be controlled by adjusting the viscosity of water phase, viscosity of oil phase, properties or amount of resin fine particles, etc. Dv and Dn may be controlled by adjusting properties or amount of resin fine particles, etc.

The process cartridge, the image forming apparatus, and the image forming method will be explained in the following.

### Image Forming Apparatus and Process Cartridge

FIG. 4 exemplarily shows a construction of an inventive process cartridge that contains an inventive electrophotographic developer.

As shown in FIG. 4, the inventive process cartridge 10 supports integratedly a photoconductor 11 and at least one developing device selected from a charging unit 12, a developing unit 13, and a cleaning unit 14, and is constructed detachably with a main body of an image forming apparatus.

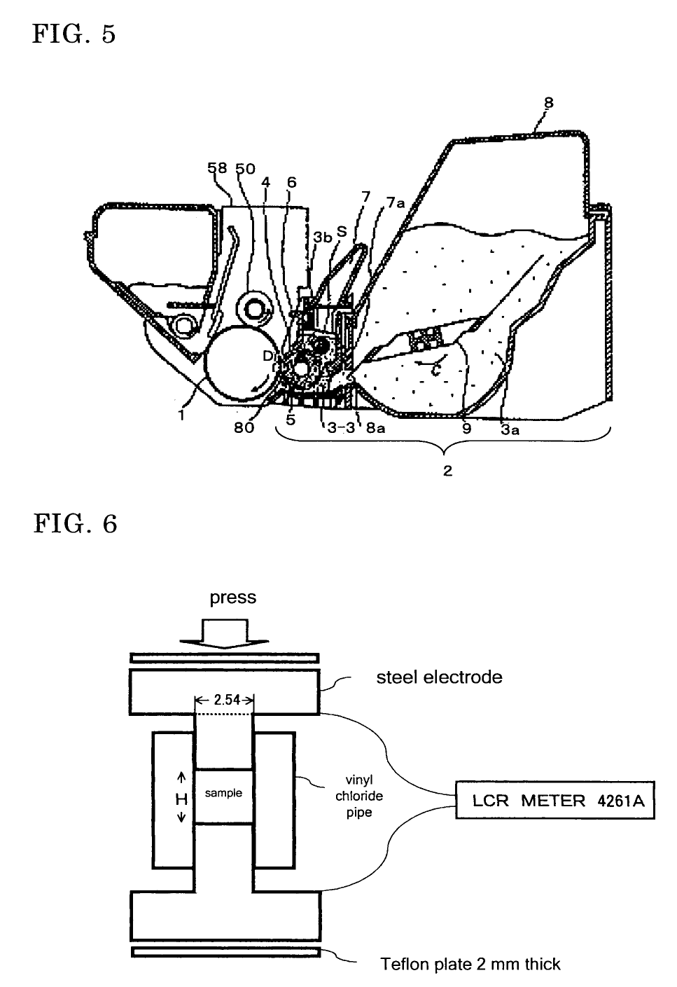

FIG. 5 exemplarily shows a construction of an inventive image forming apparatus that mounts an inventive process cartridge.

The inventive image forming apparatus is equipped with at least a photoconductor, a developing unit to form images on the photoconductor, a transfer unit to transfer the images on the photoconductor onto a transfer material, and a fixing unit to fix the images on the transfer material. In the present invention, the photoconductor, the developing unit to use the inventive developer, and one or more of other units of the elemental units including the charging unit and the cleaning unit are integratedly constructed as the process cartridge, and the process cartridge is detachably attached to main bodies of image forming apparatuses such as copiers and printers.

In FIG. 5, there appear a photoconductor 1 (photoconductor drum), developing unit 2, residual developer 3-3, toner 3a, magnetic carrier 3b, developing sleeve 4, magnetic roller 5, doctor blade 6, developer-containing case 7, pre-doctor 7a, toner hopper 8, toner supply inlet 8a, toner-conveying stirring puddle 9, charging roller 50, cleaning device 58, magnetic field-forming unit 80, developing region D, and developer containing portion S.

In the image forming apparatus equipped with the inventive process cartridge, which having the developing unit that uses the inventive developer, a photoconductor is driven to rotate under a predetermined circumferential velocity. The photoconductor is uniformly charged to a certain positive or negative voltage at the circumferential surface by a charging device, then exposed by image light from image exposing devices such as of slit exposure and laser beam scanning exposure. In this way, electrostatic latent images are formed sequentially on the circumferential surface of the photoconductor, the resulting electrostatic latent images are developed using toners by developing devices, and the developed toner images are sequentially transferred by transferring devices onto transfer materials fed from paper feed portions between the photoconductor and the transferring devices in synchronization with the photoconductor. The transfer materials, onto which images being transferred, are separated from the surface of photoconductors and printed out from the apparatuses as copies. The surface of photoconductors after image transfer is cleaned for the remaining toners by cleaning devices and charge-eliminated, then the photoconductors are repeatedly used for forming images.

That is the inventive image forming method, which uses the inventive image forming apparatus, comprises a step to form a latent electrostatic image on the photoconductor, a step to form a visible image by developing the latent electrostatic image using a developer containing at least a carrier and a toner, and a step to transfer and fix the resulting visible image onto a recording material; the developer is the electrophotographic developer described above.

### EXAMPLES

The present invention will be explained more specifically with respect to Examples in the following, but to which the present invention should be in no way limited. In the descriptions below, all parts and percentages are expressed by mass unless indicated otherwise.

### Production Example A-1

### Production of Resin Fine Particle Dispersion

Into a reaction vessel equipped with a stirring rod and a thermometer, 683 parts of water, 11 parts of sodium salt of methacrylic acid-ethylene oxide adduct sulfate ester (Eleminol RS-30, by Sanyo Chemical Industries, Ltd.), 83 parts of styrene, 83 parts of methacrylic acid, 110 parts of butyl acrylate, and 1 part of ammonium persulfate were added and the mixture was stirred at 400 rpm for 15 minutes to prepare a white emulsion, which was then heated to 75° C. to react for 5 hours. In addition, 30 parts of aqueous solution of 1% ammonium persulfate was added to age the reactant at 75° C. for 5 hours to prepare an aqueous dispersion of Resin Fine Particle Dispersion A-1 of a vinyl resin (copolymer of styrene-methacrylic acid-butyl acrylate-sodium salt of methacrylic acid-ethylene oxide adduct sulfate ester). The Resin Fine Particle Dispersion A-1 was measured by Laser Diffraction, Scattering, Particle Size Distribution Analyzer LA-920 (by Horiba, Ltd.), consequently the volume average particle diameter was 105 nm. A part of the Resin Fine Particle Dispersion A-1 was dried and the resin component was separated. Glass transition temperature Tg of the resin component was 59° C. and the mass average molecular mass was 150,000.

### Production of Low Molecular-Mass Polyester A-1

Into a reaction vessel equipped with a condenser, a stirrer, and nitrogen gas inlet, 229 parts of bisphenol A ethylene oxide two-mole adduct, 529 parts of bisphenol A propylene oxide three-mole adduct, 208 parts of terephthalic acid, 46 parts of adipic acid, and 2 parts of dibutyltin oxide were poured, and the mixture was heated to 230° C. for 5 hours to allow to react under normal pressure. Then the mixture was allowed to react for 5 hours under a reduced pressure of 10 to 15 mm Hg, followed by adding 44 parts of trimellitic acid anhydride and further allowed to react at 180° C. for 2 hours under normal pressure thereby to prepare Low Molecular-Mass Polyester A-1. The resulting Low Molecular-Mass Polyester A-1 had a mass-average-molecular mass Mw of 5,200 for THF-soluble content, a glass transition temperature Tg of 45° C., and an acid value of 20 mgKOH/g.

### Production of Prepolymer

Into a reaction vessel equipped with a condenser, a stirrer, and a nitrogen gas inlet, 795 parts of bisphenol A ethylene oxide two-mole adduct, 200 parts of isophthalic acid, 65 parts of terephthalic acid, and 2 parts of dibutyltin oxide were poured and the mixture was heated to 210° C. for 8 hours under nitrogen gas flow at normal pressure to allow condensation reaction. Then the reactant was allowed to react for 5 hours while dewatering under reduced pressure of 10 to 15 mmHg and then cooled to 80° C., then was allowed to react with 170 parts of isophorone diisocyanate in ethyl acetate thereby to prepare Prepolymer A-1. The mass average molecular mass of the resulting Prepolymer A-1 was 5,000.

### Production of Organic-Modified Layered Inorganic Mineral A-1

One hundred grams of montmorillonite was dispersed in 50 mL of water, and 39 g of dimethyl stearyl benzyl ammonium chloride previously dissolved in water was added to the solution to prepare a mixture, then the mixture was mixed, rinsed, dewatered, and dried to prepare Organic-Modified Layered Inorganic Mineral A-1.

### Preparation of Masterbatch A-1

A total of 1200 parts of water, 174 parts of Organic-Modified Layered Inorganic Mineral A-1, and 1570 parts of Low Molecular-Mass Polyester A-1 were mixed by use of Henschel mixer (by Mitsui Mining Co.). The resulting mixture was kneaded at 150° C. for 30 minutes by use of twin rolls, then calendered and cooled, and milled by use of a pulverizer (by Hosokawa Micron Co.), thereby to prepare Masterbatch A-1.

### Preparation of Toner Ingredient Oily Dispersion A-1

Into a beaker, 23.4 parts of Prepolymer A-1, 123.6 parts of Low Molecular-Mass Polyester A-1, 20 parts of Masterbatch A-1, and 80 parts of ethyl acetate were poured and mixed to prepare a solution. Separately, 15 parts of carnauba wax as a releasing agent, 20 parts of carbon black as a pigment, and 120 parts of ethyl acetate were introduced into a bead mill to disperse them for 30 minutes. These two liquids were mixed and stirred at 12,000 rpm for 5 minutes by use of TK homomixer, followed by dispersing 10 minutes by use of the bead mill. The resulting dispersion was added with 2.9 parts of isophorone diamine and stirred at 12,000 rpm for 5 minutes by use of TK homomixer thereby to prepare Toner Ingredient Oily Dispersion A-1.

### Example A-1

### Production of Toner A-1

Into a beaker, 529.5 parts of deionized water, 70 parts of Resin Fine Particle Dispersion A-1, and 0.5 part of sodium dodecylbenzene sulfonate were introduced, the mixture was stirred at 12,000 rpm for 5 minutes by use of TK homomixer to prepare a dispersion, and the dispersion was added with 405.1 parts of Toner Ingredient Oily Dispersion A-1 and allowed to react for 30 minutes while stirring. Then the reactant was charged into a flask with a condenser and aged in a hot-water bath. The aged dispersion was removed for organic solvent therein, followed by filtering, rinsing, drying, and air-classifying to prepare a toner base material. One hundred parts of the resulting particles of the toner base material and 0.25 part of a charge control agent Bontron E-84 (by Orient Chemical Industries, Ltd.) were introduced into a Q-type mixer (by Mitsui Mining Co.) and mixed at circumferential velocity 50 m/sec of turbine blades. In this mixing step, the operation was 2 minutes of running and 1 minute of pausing per cycle, and this cycle was repeated 5 times totally for 15 minutes; thereafter, 0.5 part of hydrophobic silica H2000 (by Clariant (Japan) K.K.) was further added and mixed. In this mixing step, the operation was 30 seconds of running at circumferential velocity 15 m/sec and 1 minute of pausing per cycle, and this cycle was repeated 5 times to prepare Toner A-1. The resulting Toner A-1 was evaluated in terms of volume average particle diameter, particle diameter distribution, low temperature fixability, hot offset resistance, and image quality.

### Production of Organic-Modified Layered Inorganic Mineral A-2

One hundred grams of montmorillonite was dispersed in 50 mL of water, and 47 g of dimethyl stearyl benzyl ammonium chloride previously dissolved in water was added to the solution to prepare a mixture, then the mixture was mixed, rinsed, dewatered, and dried to prepare Organic-Modified Layered Inorganic Mineral A-2.

### Preparation of Masterbatch A-2

A total of 1200 parts of water, 174 parts of Organic-Modified Layered Inorganic Mineral A-2, and 1570 parts of Low Molecular-Mass Polyester A-1 were mixed by use of Henschel mixer (by Mitsui Mining Co.). The resulting mixture was kneaded at 150° C. for 30 minutes by use of twin rolls, then calendered and cooled, and milled by use of a pulverizer (by Hosokawa Micron Co.), thereby to prepare Masterbatch A-2.

### Preparation of Toner Ingredient Oily Dispersion A-2

Into a beaker, 23.4 parts of Prepolymer A-1, 123.6 parts of Low Molecular-Mass Polyester A-1, 20 parts of Masterbatch A-2, and 80 parts of ethyl acetate were poured and mixed to prepare a solution. Separately, 15 parts of carnauba wax as a releasing agent, 20 parts of carbon black as a pigment, and 120 parts of ethyl acetate were introduced into a bead mill to disperse them for 30 minutes. These two liquids were mixed and stirred at 12,000 rpm for 5 minutes by use of TK homomixer, followed by dispersing 10 minutes by use of the bead mill. The resulting dispersion was added with 2.9 parts of isophorone diamine and stirred at 12,000 rpm for 5 minutes by use of TK homomixer thereby to prepare Toner Ingredient Oily Dispersion A-2.

### Example A-2

### Production of Toner A-2

Toner A-2 was produced in the same manner as Toner A-1 except that 405.1 parts of Toner Ingredient Oily Dispersion A-1 was changed into 405.1 parts of Toner Ingredient Oily Dispersion A-2.

### Production Example A-3

### Production of Organic-Modified Layered Inorganic Mineral A-3

One hundred grams of montmorillonite was dispersed in 50 mL of water, and 32 g of trimethyl stearyl ammonium chloride previously dissolved in water was added to the solution to prepare a mixture, then the mixture was mixed, rinsed, dewatered, and dried to prepare Organic-Modified Layered Inorganic Mineral A-3.

### Preparation of Masterbatch A-3

A total of 1200 parts of water, 174 parts of Organic-Modified Layered Inorganic Mineral A-3, and 1570 parts of Low Molecular-Mass Polyester A-1 were mixed by use of Henschel mixer (by Mitsui Mining Co.). The resulting mixture was kneaded at 150° C. for 30 minutes by use of twin rolls, then calendered and cooled, and milled by use of a pulverizer (by Hosokawa Micron Co.), thereby to prepare Masterbatch A-3.

### Preparation of Toner Ingredient Oily Dispersion A-3

Into a beaker, 23.4 parts of Prepolymer A-1, 123.6 parts of Low Molecular-Mass Polyester A-1, 20 parts of Masterbatch A-3, and 80 parts of ethyl acetate were poured and mixed to prepare a solution. Separately, 15 parts of carnauba wax as a releasing agent, 20 parts of carbon black as a pigment, and 120 parts of ethyl acetate were introduced into a bead mill to disperse them for 30 minutes. These two liquids were mixed and stirred at 12,000 rpm for 5 minutes by use of TK homomixer, followed by dispersing 10 minutes by use of the bead mill.

The resulting dispersion was added with 2.9 parts of isophorone diamine and stirred at 12,000 rpm for 5 minutes by use of TK homomixer thereby to prepare Toner Ingredient Oily Dispersion A-3.

### Example A-3

### Production of Toner A-3

Toner A-3 was produced in the same manner as Toner A-1 except that 405.1 parts of Toner Ingredient Oily Dispersion A-1 was changed into 405.1 parts of Toner Ingredient Oily Dispersion A-3.

### Production Example A-4

### Production of Organic-Modified Layered Inorganic Mineral A-4

One hundred grams of montmorillonite was dispersed in 50 mL of water, and 44 g of trimethyl stearyl ammonium chloride previously dissolved in water was added to the solution to prepare a mixture, then the mixture was mixed, rinsed, dewatered, and dried to prepare Organic-Modified Layered Inorganic Mineral A-4.

### Preparation of Masterbatch A-4

A total of 1200 parts of water, 174 parts of Organic-Modified Layered Inorganic Mineral A-4, and 1570 parts of Low Molecular-Mass Polyester A-1 were mixed by use of Henschel mixer (by Mitsui Mining Co.). The resulting mixture was kneaded at 150° C. for 30 minutes by use of twin rolls, then calendered and cooled, and milled by use of a pulverizer (by Hosokawa Micron Co.), thereby to prepare Masterbatch A-4.

### Preparation of Toner Ingredient Oily Dispersion A-4

Into a beaker, 23.4 parts of Prepolymer A-1, 123.6 parts of Low Molecular-Mass Polyester A-1, 20 parts of Masterbatch A-4, and 80 parts of ethyl acetate were poured and mixed to prepare a solution. Separately, 15 parts of carnauba wax as a releasing agent, 20 parts of carbon black as a pigment, and 120 parts of ethyl acetate were introduced into a bead mill to disperse them for 30 minutes. These two liquids were mixed and stirred at 12,000 rpm for 5 minutes by use of TK homomixer, followed by dispersing 10 minutes by use of the bead mill. The resulting dispersion was added with 2.9 parts of isophorone diamine and stirred at 12,000 rpm for 5 minutes by use of TK homomixer thereby to prepare Toner Ingredient Oily Dispersion A-4.

### Example A-4

### Production of Toner A-4

Toner A-4 was produced in the same manner as Toner A-1 except that 405.1 parts of Toner Ingredient Oily Dispersion A-1 was changed into 405.1 parts of Toner Ingredient Oily Dispersion A-4.

### Production Example A-5

### Preparation of Toner Ingredient Oily Dispersion A-5

Into a beaker, 23.4 parts of Prepolymer A-1, 141.1 parts of Low Molecular-Mass Polyester A-1, and 80 parts of ethyl acetate were poured and mixed to prepare a solution. Separately, 15 parts of carnauba wax as a releasing agent, 20 parts of carbon black as a pigment, and 120 parts of ethyl acetate were introduced into a bead mill to disperse them for 30 minutes. These two liquids were mixed and stirred at 12,000 rpm for 5 minutes by use of TK homomixer, followed by dispersing 10 minutes by use of the bead mill. The resulting dispersion was added with 2.9 parts of isophorone diamine and stirred at 12,000 rpm for 5 minutes by use of TK homomixer thereby to prepare Toner Ingredient Oily Dispersion A-5.

### Comparative Example A-1

### Production of Toner A-5

Toner A-5 was produced in the same manner as Toner A-1 except that 405.1 parts of Toner Ingredient Oily Dispersion A-1 was changed into 405.1 parts of Toner Ingredient Oily Dispersion A-5.

### Production Example A-6

### Production of Organic-Modified Layered Inorganic Mineral A-5

One hundred grams of montmorillonite was dispersed in 50 mL of water, and 29 g of dimethyl stearyl benzyl ammonium chloride previously dissolved in water was added to the solution to prepare a mixture, then the mixture was mixed, rinsed, dewatered, and dried to prepare Organic-Modified Layered Inorganic Mineral A-5.

### Preparation of Masterbatch A-5

A total of 1200 parts of water, 174 parts of Organic-Modified Layered Inorganic Mineral A-5, and 1570 parts of Low Molecular-Mass Polyester A-1 were mixed by use of Henschel mixer (by Mitsui Mining Co.). The resulting mixture was kneaded at 150° C. for 30 minutes by use of twin rolls, then calendered and cooled, and milled by use of a pulverizer (by Hosokawa Micron Co.), thereby to prepare Masterbatch A-5.

### Preparation of Toner Ingredient Oily Dispersion A-6

Into a beaker, 23.4 parts of Prepolymer A-1, 123.6 parts of Low Molecular-Mass Polyester A-1, 20 parts of Masterbatch A-5, and 80 parts of ethyl acetate were poured and mixed to prepare a solution. Separately, 15 parts of carnauba wax as a releasing agent, 20 parts of carbon black as a pigment, and 120 parts of ethyl acetate were introduced into a bead mill to disperse them for 30 minutes. These two liquids were mixed and stirred at 12,000 rpm for 5 minutes by use of TK homomixer, followed by dispersing 10 minutes by use of the bead mill. The resulting dispersion was added with 2.9 parts of isophorone diamine and stirred at 12,000 rpm for 5 minutes by use of TK homomixer thereby to prepare Toner Ingredient Oily Dispersion A-6.

### Comparative Example A-2

### Production of Toner A-6

Toner A-6 was produced in the same manner as Toner A-1 except that 405.1 parts of Toner Ingredient Oily Dispersion A-1 was changed into 405.1 parts of Toner Ingredient Oily Dispersion A-6.

### Production Example A-7

### Production of Organic-Modified Layered Inorganic Mineral A-6

One hundred grams of montmorillonite was dispersed in 50 mL of water, and 62 g of dimethyl stearyl benzyl ammonium chloride previously dissolved in water was added to the solution to prepare a mixture, then the mixture was mixed, rinsed, dewatered, and dried to prepare Organic-Modified Layered Inorganic Mineral A-6.

### Preparation of Masterbatch A-6

A total of 1200 parts of water, 174 parts of Organic-Modified Layered Inorganic Mineral A-6, and 1570 parts of Low Molecular-Mass Polyester A-1 were mixed by use of Henschel mixer (by Mitsui Mining Co.). The resulting mixture was kneaded at 150° C. for 30 minutes by use of twin rolls, then calendered and cooled, and milled by use of a pulverizer (by Hosokawa Micron Co.), thereby to prepare Masterbatch A-6.

### Preparation of Toner Ingredient Oily Dispersion A-7

Into a beaker, 23.4 parts of Prepolymer A-1, 123.6 parts of Low Molecular-Mass Polyester A-1, 20 parts of Masterbatch A-6, and 80 parts of ethyl acetate were poured and mixed to prepare a solution. Separately, 15 parts of carnauba wax as a releasing agent, 20 parts of carbon black as a pigment, and 120 parts of ethyl acetate were introduced into a bead mill to disperse them for 30 minutes. These two liquids were mixed and stirred at 12,000 rpm for 5 minutes by use of TK homomixer, followed by dispersing 10 minutes by use of the bead mill. The resulting dispersion was added with 2.9 parts of isophorone diamine and stirred at 12,000 rpm for 5 minutes by use of TK homomixer thereby to prepare Toner Ingredient Oily Dispersion A-7.

### Comparative Example A-3

### Production of Toner A-7

Toner A-7 was produced in the same manner as Toner A-1 except that 405.1 parts of Toner Ingredient Oily Dispersion A-1 was changed into 405.1 parts of Toner Ingredient Oily Dispersion A-7.

### Production Example A-8

### Production of Organic-Modified Layered Inorganic Mineral A-7

One hundred grams of montmorillonite was dispersed in 50 mL of water, and 22 g of trimethyl stearyl ammonium chloride previously dissolved in water was added to the solution to prepare a mixture, then the mixture was mixed, rinsed, dewatered, and dried to prepare Organic-Modified Layered Inorganic Mineral A-7.

### Preparation of Masterbatch A-7

A total of 1200 parts of water, 174 parts of Organic-Modified Layered Inorganic Mineral A-7, and 1570 parts of Low Molecular-Mass Polyester A-1 were mixed by use of Henschel mixer (by Mitsui Mining Co.). The resulting mixture was kneaded at 150° C. for 30 minutes by use of twin rolls, then calendered and cooled, and milled by use of a pulverizer (by Hosokawa Micron Co.), thereby to prepare Masterbatch A-7.

### Preparation of Toner Ingredient Oily Dispersion A-8

Into a beaker, 23.4 parts of Prepolymer A-1, 123.6 parts of Low Molecular-Mass Polyester A-1, 20 parts of Masterbatch A-7, and 80 parts of ethyl acetate were poured and mixed to prepare a solution. Separately, 15 parts of carnauba wax as a releasing agent, 20 parts of carbon black as a pigment, and 120 parts of ethyl acetate were introduced into a bead mill to disperse them for 30 minutes. These two liquids were mixed and stirred at 12,000 rpm for 5 minutes by use of TK homomixer, followed by dispersing 10 minutes by use of the bead mill. The resulting dispersion was added with 2.9 parts of isophorone diamine and stirred at 12,000 rpm for 5 minutes by use of TK homomixer thereby to prepare Toner Ingredient Oily Dispersion A-8.

### Comparative Example A-4

### Production of Toner A-8

Toner A-8 was produced in the same manner as Toner A-1 except that 405.1 parts of Toner Ingredient Oily Dispersion A-1 was changed into 405.1 parts of Toner Ingredient Oily Dispersion A-8.

### Production Example A-9

### Preparation of Toner Ingredient Oily Dispersion A-9

Into a beaker, 23.4 parts of Prepolymer A-1, 141.6 parts of Low Molecular-Mass Polyester A-1, 7 parts of Organo-silica sol MEK-ST (solid content: 30%, average primary particle diameter: 15 nm, by Nissan Chemical Industries, Ltd.), and 64 parts of ethyl acetate were poured and mixed to prepare a solution. Separately, 15 parts of carnauba wax as a releasing agent, 20 parts of carbon black as a pigment, and 120 parts of ethyl acetate were introduced into a bead mill to disperse them for 30 minutes. These two liquids were mixed and stirred at 12,000 rpm for 5 minutes by use of TK homomixer, followed by dispersing 10 minutes by use of the bead mill. The resulting dispersion was added with 2.9 parts of isophorone diamine and stirred at 12,000 rpm for 5 minutes by use of TK homomixer thereby to prepare Toner Ingredient Oily Dispersion A-9.

### Comparative Example A-5

### Production of Toner A-9

Toner A-9 was produced in the same manner as Toner A-1 except that 405.1 parts of Toner Ingredient Oily Dispersion A-1 was changed into 405.1 parts of Toner Ingredient Oily Dispersion A-9.

The properties of the organic-modified layered inorganic minerals in Production Examples A-1 to A-4 and A-6 to A-8 are shown in Table A-1.

Montmorillonite is generally expressed by the compositional formula below and ion-exchange is very likely to occur at R. R═Na⁺, K⁺, Mg²⁺, or Ca²⁺ in natural montmorillonite, and R is distributed between layers in the configuration. Water coordinate at R can be dewatered by heating at no higher than 200° C., for example.

Al₄(Si_{7.33}A_{10.67})O₂₀(OH)₄R_{0.33}.nH₂O

In Production Examples A-1 to A-4 and A-6 to A-8, neat montmorillonite, of which hydrate being removed by heating, was used; the neat montmorillonite was considered as a layered inorganic mineral having the compositional formula below (formula mass: 734 g/mole) and the number of moles of metal ions between layers was calculated.

compositional formula of montmorillonite used in Examples:

Si₈(Al_{3.34}Mg_{0.66})O₂₀ (OH)₄Na_{0.66}

number of moles of metal ions=[montmorillonite(g)/734(g/mole)]×0.66

Then introduced number of moles of organic ions was calculated from the mass of organic salt in use.

Finally, modification rate of organic ion was calculated from Formula (A-1).

TABLE A-1

| organic- | | | | |
|---|---|---|---|---|
| modified | metal ion between | | | |
| layered | layers of layered | | organic | organic ion |
| inorganic | inorganic mineral | | ion | modification |
| mineral | (mol) | organic salt | (mol) | rate (%) |
| 1 | montmorillonite | DSBAC 39 g | 0.092 | 102% |
| 2 | pure content | DSBAC 47 g | 0.111 | 123% |
| 3 | 100 g ≈ 0.090 mol | TSAC 32 g | 0.092 | 102% |
| 4 | | TSAC 44 g | 0.127 | 141% |
| 5 | | DSBAC 29 g | 0.068 | 76% |
| 6 | | DSBAC 62 g | 0.146 | 162% |
| 7 | | TSAC 22 g | 0.063 | 70% |

DSBAC: dimethyl stearyl benzyl ammonium chloride M = 423.5 g/mol
TSAC: trimethyl stearyl ammonium chloride M = 347.5 g/mol

Properties of toners in Production Examples A-1 to A-9 are shown in Table A-2.

TABLE A-2

| | | particle diameter | | | | | | |
|---|---|---|---|---|---|---|---|---|
| | | distribution | | | | | | glass |
| | | | | particle | | | acid value | transition |
| toner | | Dv (μm) | Dv/Dn | rate*¹⁾ | SF-1 | SF-2 | (KOHmg/g) | Tem. (° C.) |
| 1 | OLIM-1 | 5.3 | 1.15 | 3.2 | 135 | 126 | 18.5 | 53.2 |
| 2 | OLIM-2 | 5.2 | 1.14 | 4.3 | 130 | 120 | 18.4 | 54.4 |
| 3 | OLIM-3 | 5.2 | 1.14 | 3.6 | 110 | 112 | 18.2 | 53.5 |
| 4 | OLIM-4 | 5.0 | 1.13 | 3.5 | 118 | 115 | 17.5 | 51.6 |
| 5 | — | 5.1 | 1.13 | 2.5 | 103 | 102 | 17.4 | 51.0 |
| 6 | OLIM-5 | 5.4 | 1.14 | 3.3 | 104 | 105 | 18.1 | 53.5 |
| 7 | OLIM-6 | 5.5 | 1.15 | 5.5 | 115 | 115 | 17.5 | 52.4 |
| 8 | OLIM-7 | 5.2 | 1.13 | 3.2 | 104 | 106 | 17.8 | 53.2 |
| 9 | OSS | 5.8 | 1.15 | 5.6 | 130 | 120 | 18.1 | 55.0 |

OLIM: organic-modified layered inorganic mineral
OSS: organosilica sol
*¹⁾rate of particles of no more than 2 μm

Toners prepared in Examples A-1 to A-4 and Comparative Examples A-1 to A-5 were evaluated as follows. The evaluation results are shown in Table A-3.

Evaluation items and evacuation methods of toners in Examples and Comparative Examples are shown below.

### Diameter of Particles Dispersed in Masterbatch (Volume Average Particle Diameter)

### Preparation of Measuring Sample

To ethyl acetate, which dissolving 5% of a dispersant Disperbyk-167 (by BYK Chemie Co.), a masterbatch and a binder resin are added in a ratio of (amount of organic cation-modified layered mineral in masterbatch)/(amount of binder resin in masterbatch) 1/10. The total amount of the masterbatch and the binder resin is adjusted to 5% by mass. The prepared sample is stirred for 12 hours. Acid Value (mgKOH/g)

The acid value is measured in accordance with JIS K0070, in which dioxane or THF is used as the solvent when the sample is insoluble.

The acid value may be determined by the following procedures.

Measuring device: Potentiometric Automatic Titrator DL-53 (by Mettler-Toledo K.K.)

Electrode: DG113-SC (Mettler-Toledo K. K.)

Analysis software: LabX Light Version 1.00.000

Correction: use of mixture solvent of toluene 120 mL and ethanol 30 mL

Measuring temperature: 23° C.
Measuring conditions are as follows:

Stir
Speed (%): 25
Time (s): 15

EQP titration
Titrant/Se nsor
   Titrant: CH₃ONa
   Concentration (mole/L): 0.1
   Sensor: DG115
   Unit of measurement: mV
Predispensing to volume
   Volume (mL): 1.0
   Wait time (s): 0
Titrant addition: Dynamic
   dE (set) (mV): 8.0
   dV (min) (mL): 0.03
   dV (max) (mL): 0.5
Measure mode: Equilibrium controlled
   dE (mV): 0.5
   dt (s): 1.0
   t (min) (s): 2.0
   t (max) (s): 20.0
Recognition
   Threshold: 100.0
   Steepest jump only: No
   Range: No
   Tendency: None
Termination
   At maximum volume (mL): 10.0
   at potential: No
   at slope: No
   after number EQPs: Yes
      n=1
   comb. Termination conditions: No
Evaluation
   Procedure: Standard
   Potential 1: No
   Potential 2: No
   Stop for reevaluation: No

### Method to Measure Acid Value

The acid value was measured in accordance with the procedures described in JIS K0070-1992 as follows. As regards sample preparation, a toner of 0.5 g (component soluble in ethyl acetate: 0.3 g) was added to 120 mL of toluene and the toner was dissolved by stirring at room temperature (23° C.) for 10 hours, to which 30 mL of ethanol was added to prepare a sample solution.

The acid value may be calculated in the measuring device described above, specifically, the calculation was as follows. The solution was titrated with pre-determined N/10 potassium hydroxide alcohol solution and the acid value was obtained from the consumed amount of the potassium hydroxide alcohol solution in accordance with the calculation as follows.

acid value=KOH(mL)×N×56.1/sample mass

in which, N: a factor of N/10 KOH.

### Glass Transition Temperature Tg (° C.)

The glass transition temperature Tg was measured under a temperature rising rate of 10° C./min using Rigaku THRMOFLEX TG8110 (by Rigaku Co.).

The procedures to measure Tg will be generally explained. The system to measure Tg was TG-DSC system TAS-100 (by Rigaku Co.).

Initially, a sample of about 10 mg was filled in a sample container made of aluminum, and the sample container was placed on a holder unit and set in an electric furnace. The sample container was heated from room temperature to 150° C. under a temperature rising rate of 10° C./min, maintained at 150° C. for 10 minutes, then was cooled to room temperature and allowed to stand for 10 minutes, then heated again in nitrogen gas atmosphere to 150° C. under a temperature rising rate of 10° C./min to measure DSC. Tg was calculated from a tangent line of an endothermic curve in the vicinity of Tg and a contact point of the base line using an analysis system in TAS-100 system.

### Background Smear

After running printing 30,000 sheets of an image chart with 50% image area in monochrome mode by use of a digital full-color copier imagio Color 2800 (by Ricoh Co.), the printing was stopped on the way to develop a white paper image, then the developer on the photoconductor after development was transferred on a tape and the difference of image densities between the transferred tape and a non-transferred tape was measured using 938 SpectroDensitometer (by X-Rite Co.). The lower is the difference between image densities, the better is the background smear. The results were ranked from the best as A, B, C, and D in sequence.

### Toner Scattering

After continuous printing of 50,000 sheets by use of a digital full-color copier imagio Color 2800 (by Ricoh Co.), the degree of pollution in the copier was evaluated and ranked as A: no problem, B: toner exist but no problem in practical use, and C: significant smear and problematic.

### Cleaning Property

Transfer-residual toner on a photoconductor after a cleaning step was transferred onto a white paper by use of a scotch tape (by Sumitomo 3M Ltd.), and the white paper was measured by use of MacBeth reflective densitometer model RD514. The cleaning property was evaluated as A (good) when the difference from that of blank was no more than 0.01 and as B (inferior) when the difference was more than 0.01.

### Evaluation of Charge Amount

### i) Charge Amount Upon Stirring 15 Seconds

Ten grams of each of the resulting toners and 100 g of a ferrite carrier were filled into a stainless pot up to its 30% by volume in a condition of temperature 28° C. and RH 80%, and the developer of the mixture was stirred for 15 seconds at a stirring velocity of 100 rpm then to measure the charge amount (μC/g) of the developer by use of TB-200 (by Kyocera Chemical Co.).

Charge amount of toners was measured by a blow-off method.

### ii) Charge Amount Upon Stirring 5 Minutes

Charge amount was measured after 5 minutes similarly stirring as 1).

### ii) Charge Amount Upon Stirring 10 Minutes

Charge amount was measured after 10 minutes similarly stirring as 1).

### Charge Stability

### (i) Charge Stability Under High Temperature High Humidity Condition

While running printing 100,000 sheets of an image chart with 7% image area in monochrome mode by use of a digital full-color copier imagio Color 2800 (by Ricoh Co.) under condition of temperature 40° C. and RH 90%, a part of developer was sampled per 1,000 sheets and charge amount was measured by a blow-off method to evaluate charge stability and ranked such as A: change of charge amount being 5 μC/g or less, B: 10 μC/g or less, C: above 10 μC/g.

### (ii) Charge Stability Under Low Temperature Low Humidity Condition

While running printing 100,000 sheets of an image chart with 7% image area in monochrome mode by use of a digital full-color copier imagio Color 2800 (by Ricoh Co.) under condition of temperature 10° C. and RH 15%, a part of developer was sampled per 1,000 sheets and charge amount was measured by a blow-off method to evaluate charge stability and ranked such as A: change of charge amount being 5 μC/g or less, B: 10 μC/g or less, C: above 10 μC/g.

The charge amount was measured in the blow-off method (i) and (ii) as follows. Ten grams of each toner and 100 g of a ferrite carrier were filled into a stainless pot up to its 30% by volume in a laboratory of temperature 20° C. and RH 50%, and the developer of the mixture was stirred for 10 minutes at a stirring velocity of 100 rpm then to measure the charge amount (μC/g) of the developer by use of TB-200 (by Kyocera Chemical Co.).

### Evaluation of Fixability

Copy test was carried out by use of a copier MF2200 (by Ricoh Co.), of which fixing device was modified and equipped with a fixing roller of Teflon® roller, to which type 6200 paper (by Ricoh Co.) was set. Cold offset temperature (minimum fixing temperature) and hot offset temperature (hot offset resistant temperature) were determined while changing the fixing temperature. Minimum fixing temperature of conventional low-temperature fixing toners is about 140° C. to 150° C. The conditions to evaluate low temperature fixability were such as linear velocity of paper feed: 120 to 150 mm/sec, surface pressure: 1.2 kgf/cm², and nip width: 3 mm; and the conditions to evaluate hot offset were such as linear velocity of paper feed: 50 mm/sec, surface pressure: 2.0 kgf/cm², and nip width: 4.5 mm.

### Low Temperature Fixability (Evaluation in 5 Steps)

A: minimum fixing temperature (MFT) <140° C.: excellent

B: 140° C.≦MFT<150° C.

C: 150° C.≦MFT<160° C.

D: 160° C.≦MFT<170° C.

E: 170° C.≦MFT: inferior

### Hot Offset Property (Evaluation in 5 Steps)

A: 201° C.≦hot offset temperature (HOT): excellent

B: 191° C.≦HOT<201° C.

C: 181° C.≦HOT<191° C.

D: 171° C.≦HOT<181° C.

E: HOT<171° C.: inferior

### High-Temperature Storage Stability

Each of the toners was kept at 50° C. for 8 hours then sieved through a screen of 42 mesh for 2 minutes; and high-temperature storage stability was evaluated on the basis of the rate of toners remaining on the screen. The more excellent is the high-temperature storage stability, the less is the rate of residual toner. Evaluation was in accordance with 4 steps as follows.

A: residual rate (RR)<10%

B: 10%≦RR<20%

C: 20%≦RR<30%

D: 30%≦RR

TABLE A-3

| | | | | | | | | | | lower limit | hot offset | |
|---|---|---|---|---|---|---|---|---|---|---|---|---|
| | | | | | charge amount | | | charge | charge | fixing tem. | Resistance | |
| | toner | BGS | TS | CP | 15 sec | 5 min | 10 min | stability*¹⁾ | stability*²⁾ | (° C.) | (° C.) | HTS |
| Ex. 1 | 1 | A | A | A | −47.2 | −49.2 | −48.9 | A | A | 130, A | 210, A | B |
| Ex. 2 | 2 | A | A | A | −41.3 | −44.3 | −43.2 | A | A | 130, A | 210, A | B |
| Ex. 3 | 3 | B | A | A | −33.3 | −35.9 | −36.1 | A | A | 130, A | 210, A | B |
| Ex. 4 | 4 | B | A | A | −30.2 | −32.8 | −33.0 | A | A | 130, A | 210, A | B |
| Com. Ex. 1 | 5 | C | B | B | −20.3 | −23.3 | −25.5 | B | B | 130, A | 210, A | B |
| Com. Ex. 2 | 6 | C | B | B | −24.3 | −25.0 | −26.8 | B | B | 130, A | 210, A | B |
| Com. Ex. 3 | 7 | C | B | A | −20.2 | −24.3 | −24.9 | B | B | 130, A | 210, A | B |
| Com. Ex. 4 | 8 | C | B | B | −19.5 | −21.7 | −22.8 | B | B | 130, A | 210, A | B |
| Com. Ex. 5 | 9 | C | B | A | −21.2 | −25.5 | −27.7 | B | B | 145, B | 210, A | B |

BGS: background smear
TS: toner scattering
CP: cleaning property
HTS: high temperature storage stability
*¹⁾under high temperature high humidity
*²⁾under low temperature low humidity

### Industrial Applicability

The inventive toner has attained an adequate deformation in shape, thus can exhibit excellent low temperature stability and form high quality images, and also represent stably cleaning property for a long period, thus is favorably used for forming high quality images in electrophotographic systems. The inventive toner for developing electrostatic images that uses the inventive toner, the process cartridge that use the toner, the inventive toner producing method, the inventive image forming method, and the inventive image forming apparatus may be favorably used for forming high quality images.

### EXAMPLES

The present invention will be explained more specifically with respect to Examples and Comparative Examples, but to which the present invention should be in no way limited. In the descriptions below, all parts and percentages are expressed by mass unless indicated otherwise.

### Example B-1

Initially, a carrier and a toner were produced in the conditions below.

### Carrier B-1

The ingredients below were dispersed for 10 minutes by a homomixer to prepare a solution for forming carrier coating film (solution for forming silicone resin coating film).

Ingredients of Solution for Forming Carrier Coating Film

| | |
|---|---|
| silicone resin solution (solid content: 23%)*¹⁾ | 432.2 parts |
| aminosilane (solid content: 100%)*²⁾ | 1.50 parts |
| conductive inorganic oxide EC-700*³⁾ | 110 parts |
| toluene | 900 parts |

*¹⁾SR2410, by Dow Corning Toray Silicone Co.
*²⁾SH6020, by Dow Corning Toray Silicone Co.
*³⁾particle diameter: 0.40 μm, specific gravity: 4.2, powder resistivity: 5 Ω · cm, by Titankogyo Co.

Calcined ferrite powder (specific gravity: 5.5) having an average particle diameter of 35 μm was used as a carrier core material in an amount of 5,000 parts, the solution for forming carrier coating film was coated on the surface of the core material using Spira coater (by Okada Seiko Co.) and dried at 40° C. within the coater to form a film thickness of 0.30 μm. The resulting dry particles were calcinated at 200° C. for 1 hour in an electric furnace. After cooling, the bulk of the ferrite powder was loosed by passing through a screen of opening size 63 μm, thereby to prepare Carrier B-1 of D/h: 1.3, volume resistivity: 13.9 [log (ohm·cm)], and magnetization: 68 Am²/kg. The coating rate of the inorganic oxide particles was 63% to the core material in the resin coating layer.

The resistivity of the powder of the conductive fine particles was measured by use of the powder resistivity meter of FIG. 6 that schematically shows its construction. Average particle diameter of the carrier core material was measured using Microtrack particle size analyzer of SRA type (by Nikkiso Co.); the range setting was 0.7 μm to 125 μm. The average particle diameter is expressed as D50.

Film thickness of the binder resin was obtained by way of observing cross section of the carrier using a transmission electron microscope, inspecting coating film on the carrier surface, and determining an average value of the film thicknesses.

Magnetization was measured using VSM-P7-15 (Toei Industry Co.) in such procedures as weighing about 0.15 g of a sample, filling the sample within a cell of inner diameter 2.4 mmΦ and height 8.5 mm, and applying a magnetic field of 1000 Oersted (Oe); 1000 Oersted (Oe) corresponds to 1000 (10³/4π·A/m).

### Toner (Toner B-1)

Into a reaction vessel equipped with a condenser, a stirrer, and a nitrogen gas inlet, 229 parts of bisphenol A ethylene oxide two-mole adduct, 529 parts of bisphenol A propylene oxide three-mole adduct, 208 parts of terephthalic acid, 46 parts of adipic acid, and 2 parts of dibutyltin oxide were poured and the mixture was heated to react at 230° C. for 8 hours under normal pressure, followed by reacting for 5 hours under a reduced pressure of 10 to 15 mmHg; then 44 parts of trimellitic anhydride was added to the reaction vessel to allow to react at 180° C. for 2hours under normal pressure thereby to synthesize an unmodified polyester resin.

The resulting unmodified polyester resin had a number average molecular mass of 2,500, mass average molecular mass of 6,700, glass transition temperature of 43° C., and acid value of 25 mgKOH/g.

1200 parts of water, 540 parts of carbon black Printex 35 (DBP absorption number: 42 mL/100 g, pH: 9.5, by Deggusa Co.), and 1200 parts of the unmodified polyester resin were mixed in a Henschel mixer (by Mitsui Mining Co.). The resulting mixture was kneaded at 150° C. for 30 minutes by use of twin rolls, then calendered and cooled, and milled by use of a pulverizer (by Hosokawa Micron Co.), thereby to prepare a masterbatch.

Into a reaction vessel equipped with a stirring rod and a thermometer, 378 parts of the unmodified polyester resin, 110 parts of carnauba wax, 22 parts of salicylic acid metal complex E-84 (by Orient Chemical Industries, Ltd.), and 947 parts of ethyl acetate were introduced, the mixture was heated to 80° C. while stirring and maintained at 80° C. for 5 hours, then cooled to 30° C. over 1 hour. Then 500 parts of the masterbatch and 500 parts of ethyl acetate were introduced into the reaction vessel and the mixture was stirred for 1 hour to prepare a raw material solution.

Then 1324 parts of the resulting raw material solution was poured into a reaction vessel, C.I. pigment red and carnauba wax were dispersed into the raw material solution by use of a bead mill (Ultra Visco Mill, by Aymex Co.) in a condition of liquid-feed rate: 1 kg/hr, disc-circumferential velocity: 6 m/sec, amount of zirconia beads (0.5 mm): 80% by volume, and pass times: 3 to prepare a wax dispersion.

Then 1324 parts of an ethyl acetate solution of 65% unmodified polyester resin was added to the wax dispersion. To 200 parts of the dispersion liquid, which passed one time through the Ultra Visco Mill under the similar conditions described above, 3 parts of a layered inorganic mineral of montmorillonite at least a part of which being modified with a quaternary ammonium salt having a benzyl group (Clayton APA, by Southern Clay Products, Inc.) was added, and the mixture was stirred for 30 minutes using T. K. Homodisper (Tokushu Kika Kogyo Co.) to prepare a dispersion of toner ingredients.

Viscosity of the resulting dispersion of toner ingredients was measured as follows. Using a rheometer AR 2000 (by TA Instruments Japan Co.) of parallel plate type with parallel plates of diameter 20 mm, viscosity was measured in a condition that the gap was set to 30 μm and a shear force is applied to the dispersion of toner ingredients of 25° C. at shearing speed of 30,000 sec⁻¹ for 30 seconds and then the shearing speed was changed from 0 sec⁻¹ to 70 sec⁻¹ over 20 seconds (viscosity A). In addition, viscosity was measured in a condition that a shear force is applied to the dispersion of toner ingredients of 25° C. at shearing speed of 30,000 sec⁻¹ for 30 seconds using the rheometer AR 2000 of parallel plate type (viscosity B). The results are shown in Table B-1.

Into a reaction vessel equipped with a condenser, a stirrer, and a nitrogen gas inlet, 682 parts of bisphenol A ethylene oxide two-mole adduct, 81 parts of bisphenol A propylene oxide two-mole adduct, 283 parts of terephthalic acid, 22 parts of trimellitic anhydride, and 2 parts of dibutyltin oxide were poured and the mixture was heated to react at 230° C. for 8 hours under normal pressure, then was allowed to react for 5 hours under a reduced pressure of 10 to 15 mmHg thereby to synthesize an intermediate polyester resin.

The resulting intermediate polyester resin had a number average molecular mass of 2,100, mass average molecular mass of 9,500, glass transition temperature of 55° C., acid value of 0.5 mgKOH/g, and OH value of 51 mgKOH/g.

Into a reaction vessel equipped with a condenser, a stirrer, and a nitrogen gas inlet, 410 parts of the intermediate polyester resin, 89 parts of isophorone diisocyanate, and 500 parts of ethyl acetate were introduced to react at 100° C. for 5 hours to prepare a prepolymer. The content of free isocyanate was 1.53% in the resulting prepolymer.

Into a reaction vessel equipped with a stirring rod and a thermometer, 170 parts of isophorone diamine and 75 parts of methyl ethyl ketone were introduced to react at 50° C. for 5 hours to prepare a ketimine compound. The ketimine compound had an amine value of 418 mgKOH/g.

Into a reaction vessel, 749 parts of the dispersion of toner ingredients, 115 parts of the prepolymer, and 2.9 parts of the ketimine compound were introduced to mix by use of TK homomixer (by Tokushu Kika Kogyo Co.) at 5,000 rpm for 1 minute to prepare a oil-phase mixture liquid.

Into a reaction vessel equipped with a stirring rod and a thermometer, 683 parts of water, 11 parts of a reactive emulsifier Eleminol RS-30 (sodium salt of sulfate ester of methacrylic acid ethylene oxide adduct, by Sanyo Chemical Industries, Ltd.), 83 parts of styrene, 83 parts of methacrylic acid, 110 parts of butyl acrylate, and 1 part of ammonium persulfate were introduced, and the mixture was stirred at 400 rpm for 15 minutes to prepare an emulsion. The emulsion was heated to 75° C. to react for 5 hours. Then 30 parts of 1% of ammonium persulfate aqueous solution was added to the reactant and the reactant was aged at 75° C. for 5 hours thereby to prepare a dispersion of resin particles.

### Particle Diameter of Dispersion Particles and Particle Diameter Distribution in Dispersion of Toner Ingredients

In the present invention, the particle diameter of dispersion particles and the particle diameter distribution in the dispersion of toner ingredients were measured by use of Microtrack UPA-150 (by Nikkiso Co.) and analyzed by use of an analysis software of Microtrack particle size analyzer Ver.10.1.2-016EE (by Nikkiso Co.). Specifically, the dispersion of toner ingredient was added into a 30 mL glass tube and also the solvent of the dispersion was added to prepare a dispersion liquid of 10%. The dispersion liquid was dispersed for 2 minutes using an ultrasonic dispersing device (W-113MK-II, by Honda Electric Co.).

After background was measured as to the solvent for the dispersion of toner ingredients, the dispersion liquid is dropped, and the diameter of dispersion particles was measured in a condition that the value of sample loading of the meter was in the range of 1 to 10. It is important in this method that measurement is carried out in a condition that the value of sample loading of the meter is in the range of 1 to 10 from the viewpoint of repeatability to measure the diameter of dispersion particles. In order to assure the value of sample loading, the dropping rate of the dispersion liquid is necessary to be adjusted.

The measuring and analyzing conditions were defined as distribution type: volume, selection of particle diameter section: standard, channel number: 44, measuring period: 60 seconds, measuring times: one, particle permeability: transparent, refractive index of particles: 1.5, particle shape: non-spherical, density: 1 g/cm³, refractive index of solvent: the value of the solvent for the dispersion of toner ingredients noted in “guide line for input conditions at measuring” edited by Nikkiso Co.

990 parts of water, 83 parts of the dispersion of resin particles, 37 parts of 48.5% aqueous solution of sodium dodecyldiphenylether disulfonate (Eleminol MON-7, by Sanyo Chemical Industries, Ltd.), 135 parts of 1% aqueous solution of polymer dispersant of sodium carboxymethylcellulose (Cellogen BS-H-3, by Dai-ichi Kogyo Seiyaku Co.), and 90 parts of ethyl acetate were mixed and stirred to prepare an aqueous medium.

867 parts of the oil-phase mixture liquid was added to 1,200 parts of the aqueous medium, the mixture was mixed at 13,000 rpm for 20 minutes by use of TK homomixer to prepare a dispersion liquid of emulsion slurry.

Then the emulsion slurry was poured into a reaction vessel equipped with a stirrer and a thermometer and aged at 45° C. for 4 hours after removing the solvent at 30° C. for 8 hours thereby to prepare a dispersion slurry.

Volume average particle diameter (Dv) and number average particle diameter (Dn) of the toners used in the present invention were measured by use of a particle size analyzer (Multisizer III, by Beckman Coulter Co.) at aperture diameter 100 μm, and analyzed using an analysis software of Beckman Coulter Multisizer 3 Version 3.51.

Specifically, to a 100 mL glass beaker, 0.5 mL of a 10% surfactant (alkylbenzene sulfonate Neogen SC-A, by Daiichi Kogyo Seiyaku Co.) was added, then 0.5 g of each toner was added thereto and stirred with Microspartel, and 80 mL of deionized water was poured into the beaker. The resulting dispersion was dispersed in an ultrasonic dispersing apparatus (W-113MK-II, by Honda Electronics Co.) for 10 minutes. The dispersion was measured using the Multisizer III and Isoton III (by Beckman Coulter Co.) as a solution for measurement. The toner sample dispersion was titrated and measured in a condition that the concentration, indicated by the apparatus, was 8%±2%. It is important for the measurement that the concentration of the toner sample is 8%±2% from the viewpoint of measurement repeatability; the concentration range may result in less error in the measurement.

After filtering 100 parts of the dispersion slurry under a reduced pressure, 100 parts of deionized water was added to the filtered cake, and the mixture was mixed at 12,000 rpm for 10 minutes by use of TK homomixer.

10% hydrochloric acid was added to the resulting filtered cake to adjust its pH to 2.8, and the mixture was mixed at 12,000 rpm for 10 minutes by use of TK homomixer and then filtered.

300 parts of deionized water was added to the resulting cake, and the mixture was mixed at 12,000 rpm for 10 minutes by use of TK homomixer and then filtered, these procedures were repeated one more time to prepare a final filtered cake. The resulting final filtered cake was dried at 45° C. for 48 hours using an air-circulating drier then sieved through a mesh of opening size 75 μm to obtain a toner base particle.

As external additives, 1.0 parts of hydrophobic silica and 0.5 parts of hydrophobic titanium oxide were added to 100 parts of the toner base particle, and the mixture was mixed using a Henschel mixer (by Mitsui Mining Co.) to prepare a toner, which being referred to Toner B-1.

The resulting 7 parts of Toner B-1 and 93 parts of Carrier B-1 were mixed and stirred to prepare a developer having a toner concentration of 7%, which was evaluated with respect to color smear, carrier adhesion, image density, and durability (amount of charge decrease, amount of resistance change). Main properties of developer such as circularity of toner, volume resistivity of carrier, coating rate, D/h, and magnetic moment are shown in Table B-1 and evaluation results are shown in Table B-2.

### Procedures and Conditions in Examples are Shown Below.

### Cleaning Property

Residual toner on a photoconductor through a cleaning step, at initial stage and after printing 1,000 or 100,000 sheets, was transferred onto a white paper by use of a scotch tape (by Sumitomo 3M Ltd.), and the white paper was measured by use of MacBeth reflective densitometer model RD514. The cleaning property was evaluated as A (good) when the difference from that of blank was no more than 0.01 and as B (inferior) when the difference was more than 0.01.

### Color Smear

After running printing 30,000 sheets of an image chart with 0.5% image area by use of a digital full-color printer imagio Neo C455 (modified type, by Ricoh Co.), a value of AE was evaluated as for a simple color image. The simple color image was output at initial stage and after printing 30,000 sheets, then ΔE was calculated in accordance with the following criteria. A: ΔE≦2, no color smear; B: 2<ΔE≦4, discreet color smear, unnoticeable change of color tone; C: 4≦ΔE, apparent color smear, noticeable change of color tone.

After outputting the image, image density was measured by use of X-Rite 938 (by X-Rite Co.). CIEL*, CIEa*, and CIEb* were measured three times respectively at a yellow image density of 1.4±0.5 to average the measurements and to insert into the following formula, and the value of ΔE was calculated.

ΔE=((initial L*)²+(initial a*)²+(initial b*)²)^{1/2}−((after running L*)²+(after running a*)²+(after running b*)²)^{1/2}

A developer was set in a commercially available digital full-color printer imagio Neo C455 (modified type, by Ricoh Co.), which was adjusted a charge voltage of DC 740V and developing bias of 600 V (background potential: constant 140 V), and carrier adhesion on edge was determined as the number of adhering carriers per 100 cm² on average by way that the number of carriers (NC) adhering on surface of a photoconductor, upon developing dots formed in half tone, was counted for 5 viewing fields by observing with a loupe. Evaluation was in accordance with the following criteria of A: NC≦20; B: 21≦NC≦60; C: 61≦NC≦80; D: 81≦NC; in which A, B, and C: pass, and D: rejection.

White void (image portion) was determined in a way of adjusting a charge voltage of DC 740V and a developing bias of 600 V (background potential: constant 140 V), outputting an entire solid image (A3 size), and counting the number of white voids (NWC) on the image. Evaluation was in accordance with the following criteria of A: NWC≦5; B: 6≦NWC≦10; C: 11≦NWC≦20; D: 21≦NWC; in which A, B, and C: pass, and D: rejection.

### Image Density

After running printing 300,000 sheets of an image chart with 50% image area in monochrome mode, a solid image was output on 6000 paper (by Ricoh Co.), and image density (ID) was measured by use of X-Rite 938 (by X-Rite Co.). Evaluation was in accordance with the following criteria of A: 1.8≦ID<2.2; B: 1.4≦ID<1.8; C: 1.2≦ID<1.4; D: ID<1.2.

### Durability

A developer was set in a commercially available digital full-color printer imagio Neo C455 (modified type, by Ricoh Co.), and running printing was carried out on 300,000 sheets for an image chart with 50% image area in monochrome mode. Evaluation was on the basis of amount of charge decrease of carrier upon the running. Amount of resistance change was evaluated by running 300,000 sheets for an image chart with 0.5% image area in monochrome mode. Evaluation was on the basis of amount of resistance change of carrier upon the running.

The amount of charge decrease in this specification is measured in a way that a virgin carrier and a toner are humidity-conditioned in a normal temperature normal humidity chamber (temperature: 23.5° C., humidity: 60% RH) under unsealed condition for 30 minutes or longer, and 6.000 g of the carrier and 0.452 g of the are filled into a stainless container and sealed; then the stainless container is shaken about 1,100 times for 5 minutes using YS-LD shaker (by Yayoi Co.) at graduation 150 to frictionally charge the sample, then the sample is measured by a typical blow-off method using TB-200 (by Kyocera Chemical Co.) thereby to obtain a charge amount (Q1); separately, the toner in the developer sample after running is removed by the blow-off device to take the carrier, which is measured by the same method described above to obtain a charge amount (Q2); and the difference is defined as the amount of charge decrease, of which the target is less than 10.0 μC/g.

The amount of resistance change in this specification is measured in a way that the virgin carrier is measured by the method to measure resistance described above to obtain a resistance (R1); separately, the toner in the developer sample after running is removed by the blow-off device to take the carrier, which is measured by the same method described to obtain a the charge amount (R2); and the difference is defined as the amount of resistance change, of which the target is less than 3.0 [log (Ω·cm)]. The resistance change is caused by film scraping of the binder resin of carrier, spent of toner ingredients, detachment of particles in carrier-coating film, etc., therefore, the resistance change can be reduced by suppressing these factors.

### Example B-2

Carrier B-2 of D/h: 1.3, volume resistivity: 13.1 [log(Ω·cm)], and magnetization: 68 Am²/kg was obtained in the same manner as Example B-1 except that the ingredients of solution for forming carrier coating film were changed into a mixture resin containing an acrylic resin and a silicone resin shown below. The coating rate of fine particles in the resin coating layer was 83% over the core material.

Ingredients of Solution for Forming Carrier Coating Film

| | | |
|---|---|---|
| acrylic resin solution (solid content: 50%) | 25.7 | parts |
| guanamine solution (solid content: 70%) | 7.3 | parts |
| acidic catalyst (solid content: 40%) | 0.14 | part |
| silicone resin solution (solid content: 20%)*¹⁾ | 324.2 | parts |
| aminosilane (solid content: 100%)*²⁾ | 1.5 | parts |
| conductive inorganic oxide EC-700*³⁾ | 145 | parts |

*¹⁾SR2410, by Dow Corning Toray Silicone Co.
*²⁾SH6020, by Dow Corning Toray Silicone Co.
*³⁾particle diameter: 0.40 μm, specific gravity: 4.2, powder resistivity: 5 Ω · cm, by Titankogyo Co.

Using the Carrier B-2 and Toner B-1, images were formed and evaluated in the same manner as Example B-1. Main properties of developer such as circularity of toner, volume resistivity of carrier, coating rate, D/h, and magnetic moment are shown in Table B-1 and evaluation results are shown in Table B-2.

### Example B-3

Carrier B-3 of D/h: 1.9, volume resistivity: 13.1 [log(Ω·cm)], and magnetization: 68 Am²/kg was obtained in the same manner as Example B-2 except that the ingredients of solution for forming carrier coating film were changed into a mixture resin containing an acrylic resin and a silicone resin shown below. The coating rate of fine particles in the resin coating layer was 83% over the core material.

Ingredients of Solution for Forming Carrier Coating Film

| | | |
|---|---|---|
| acrylic resin solution (solid content: 50%) | 17.1 | parts |
| guanamine solution (solid content: 70%) | 4.85 | parts |
| acidic catalyst (solid content: 40%) | 0.10 | part |
| silicone resin solution (solid content: 20%)*¹⁾ | 216.2 | parts |
| aminosilane (solid content: 100%)*²⁾ | 1.68 | parts |
| conductive inorganic oxide EC-700*³⁾ | 145 | parts |
| toluene | 600 | parts |

*¹⁾SR2410, by Dow Corning Toray Silicone Co.
*²⁾SH6020, by Dow Corning Toray Silicone Co.
*³⁾particle diameter: 0.40 μm, specific gravity: 4.2, powder resistivity: 5 Ω · cm, by Titankogyo Co.

Using the Carrier B-3 and Toner B-1, images were formed and evaluated in the same manner as Example B-1. Main properties of developer such as circularity of toner, volume resistivity of carrier, coating rate, D/h, and magnetic moment are shown in Table B-1 and evaluation results are shown in Table B-2.

### Example B-4

Carrier B-4 of D/h: 0.4, volume resistivity: 9.5 [log(Ω·cm)], and magnetization: 68 Am²/kg was obtained in the same manner as Example B-2 except that the ingredients of solution for forming carrier coating film were changed into a mixture resin containing an acrylic resin and a silicone resin shown below. The coating rate of fine particles in the resin coating layer was 83% over the core material.

Ingredients of Solution for Forming Carrier Coating Film

| | | |
|---|---|---|
| acrylic resin solution (solid content: 50%) | 158.8 | parts |
| guanamine solution (solid content: 70%) | 49.6 | parts |
| acidic catalyst (solid content: 40%) | 0.88 | part |
| silicone resin solution (solid content: 20%)*¹⁾ | 743.2 | parts |
| aminosilane (solid content: 100%)*²⁾ | 1.68 | parts |
| conductive inorganic oxide EC-700*³⁾ | 145 | parts |
| toluene | 1600 | parts |

*¹⁾SR2410, by Dow Corning Toray Silicone Co.
*²⁾SH6020, by Dow Corning Toray Silicone Co.
*³⁾particle diameter: 0.40 μm, specific gravity: 4.2, powder resistivity: 5 Ω · cm, by Titankogyo Co.

Using the Carrier B-4 and Toner B-1, images were formed and evaluated in the same manner as Example B-1. Main properties of developer such as circularity of toner, volume resistivity of carrier, coating rate, D/h, and magnetic moment are shown in Table B-1 and evaluation results are shown in Table B-2.

### Example B-5

Carrier B-5 of D/h: 0.9 and volume resistivity: 16.5 [log(Ω·cm)] was obtained in the same manner as Example B-2 except that conductive inorganic oxide EC-700 of the ingredient of solution for forming carrier coating film was changed into 110 parts of titanium oxide C (anatase) (powder resistivity: 32 Ω·cm, particle diameter: 0.35 μm, specific gravity: 5.0). The coating rate of fine particles in the resin coating layer was 73% over the core material.

Using the Carrier B-5 and Toner B-1, images were formed and evaluated in the same manner as Example B-1. Main properties of developer such as circularity of toner, volume resistivity of carrier, coating rate, D/h, and magnetic moment are shown in Table B-1 and evaluation results are shown in Table B-2.

### Example B-6

Carrier B-6 of D/h: 0.9, volume resistivity: 12.7 [log(Ω·cm)], and magnetization: 66 Am²/kg was obtained in the same manner as Example B-1 except the carrier core material was changed into one having a volume average particle diameter of 18 μm (specific gravity: 5.7) and the ingredients of solution for forming carrier coating film were changed into those shown below. The coating rate of fine particles in the resin coating layer was 61% over the core material.

Ingredients of Solution for Forming Carrier Coating Film

| | | |
|---|---|---|
| acrylic resin solution (solid content: 50%) | 68.4 | parts |
| guanamine solution (solid content: 70%) | 19.4 | parts |
| acidic catalyst (solid content: 40%) | 0.38 | part |
| silicone resin solution (solid content: 20%)*¹⁾ | 864.4 | parts |
| aminosilane (solid content: 100%)*²⁾ | 0.46 | part |
| conductive inorganic oxide EC-700*³⁾ | 200 | parts |
| toluene | 800 | parts |

*¹⁾SR2410, by Dow Corning Toray Silicone Co.
*²⁾SH6020, by Dow Corning Toray Silicone Co.
*³⁾particle diameter: 0.40 μm, specific gravity: 4.2, powder resistivity: 5 Ω · cm, by Titankogyo Co.

Using the Carrier B-6 and Toner B-1, images were formed and evaluated in the same manner as Example B-1. Main properties of developer such as circularity of toner, volume resistivity of carrier, coating rate, D/h, and magnetic moment are shown in Table B-1 and evaluation results are shown in Table B-2.

### Example B-7

Carrier B-7 of D/h: 0.6, volume resistivity: 14.5 [log (Ω·cm)], and magnetization: 69 Am²/kg was obtained in the same manner as Example B-1 except the carrier core material was changed into one having a volume average particle diameter of 71 μm (specific gravity: 5.3) and the ingredients of solution for forming carrier coating film were changed into those shown below. The coating rate of fine particles in the resin coating layer was 95% over the core material.

Ingredients of Solution for Forming Carrier Coating Film

| | | |
|---|---|---|
| acrylic resin solution (solid content: 50%) | 34.2 | parts |
| guanamine solution (solid content: 70%) | 9.7 | parts |
| acidic catalyst (solid content: 40%) | 0.19 | part |
| silicone resin solution (solid content: 20%)*¹⁾ | 292.9 | parts |
| aminosilane (solid content: 100%)*²⁾ | 0.42 | part |
| conductive inorganic oxide EC-700*³⁾ | 85 | parts |
| toluene | 800 | parts |

*¹⁾SR2410, by Dow Corning Toray Silicone Co.
*²⁾SH6020, by Dow Corning Toray Silicone Co.
*³⁾particle diameter: 0.40 μm, specific gravity: 4.2, powder resistivity: 5 Ω · cm, by Titankogyo Co.

Using the Carrier B-7 and Toner B-1, images were formed and evaluated in the same manner as Example B-1. Main properties of developer such as circularity of toner, volume resistivity of carrier, coating rate, D/h, and magnetic moment are shown in Table B-1 and evaluation results are shown in Table B-2.

### Example B-8

Carrier B-8 of D/h: 0.9 and volume resistivity: 13.9 [log (Ω·cm)] was obtained in the same manner as Example B-2 except that a low-magnetized calcined ferrite of 35 μm (specific gravity: 5.4) was used and the magnetization came to 35 Am²/kg. The coating rate of fine particles in the resin coating layer was 82% over the core material.

Using the Carrier B-8 and Toner B-1, images were formed and evaluated in the same manner as Example B-1. Main properties of developer such as circularity of toner, volume resistivity of carrier, coating rate, D/h, and magnetic moment are shown in Table B-1 and evaluation results are shown in Table B-2.

### Example B-9

Carrier B-9 of D/h: 0.9 and volume resistivity: 14.1 [log(Ω·cm)] was obtained in the same manner as Example B-2 except that a high-magnetized calcined ferrite of 35 μm (specific gravity: 5.5) was used and the magnetization came to 93 Am²/kg. The coating rate of fine particles in the resin coating layer was 83% over the core material.

Using the Carrier B-9 and Toner B-1, images were formed and evaluated in the same manner as Example B-1. Main properties of developer such as circularity of toner, volume resistivity of carrier, coating rate, D/h, and magnetic moment are shown in Table B-1 and evaluation results are shown in Table B-2.

### Example B-10

Carrier B-10 of D/h: 1.1, volume resistivity: 13.5 [log(Ω·cm)], and magnetization: 69 Am²/kg was obtained in the same manner as Example B-1 except that the amount of the inorganic fine particles was reduced from 110 parts to 75 parts. The coating rate of fine particles in the resin coating layer was 43% over the core material.

Using the Carrier B-10 and Toner B-1, images were formed and evaluated in the same manner as Example B-1. Main properties of developer such as circularity of toner, volume resistivity of carrier, coating rate, D/h, and magnetic moment are shown in Table B-1 and evaluation results are shown in Table B-2.

### Comparative Example B-1

The ingredients shown below were dispersed for 10 minutes using a homomixer to prepare a liquid for forming a silicone resin coating film for a carrier coating layer.

Ingredients of Solution for Forming Carrier Coating Film

| | | |
|---|---|---|
| silicone resin solution (solid content: 23%)*¹⁾ | 432.2 | parts |
| aminosilane (solid content: 100%)*²⁾ | 0.66 | part |
| carbon black MR100R*³⁾ | 20 | parts |
| toluene | 300 | parts |

*¹⁾SR2410, by Dow Corning Toray Silicone Co.
*²⁾SH6020, by Dow Corning Toray Silicone Co.
*³⁾by Mitsubishi Chemical Co.

Calcined ferrite powder (specific gravity: 5.5) having an average particle diameter of 35 μm was used as a carrier core material in an amount of 5,000 parts, the solution for forming carrier coating film was coated on the surface of the core material using Spira coater (by Okada Seiko Co.) and dried at 40° C. within the coater to form a film thickness of 0.35 μm. The resulting dry particles were calcinated at 200° C. for 1 hour in an electric furnace. After cooling, the bulk of the ferrite powder was loosed by passing through a screen of opening size 63 μm, thereby to prepare Carrier B-11 of volume resistivity: 12.9 [log(Ω·cm)] and magnetization: 68 Am²/kg.

Using the Carrier B-11 and Toner B-1, images were formed and evaluated in the same manner as Example B-1. Main properties of developer such as circularity of toner, volume resistivity of carrier, coating rate, D/h, and magnetic moment are shown in Table B-1 and evaluation results are shown in Table B-2.

### Comparative Example B-2

Toner B-2 was prepared in the same manner as Example B-1 to produce the toner B-1 except that Clayton APA (by Southern Clay Products, Inc.) was changed into 45 parts of MEK-ST-UP (Nissan Chemical Industries Ltd.).

Using the Carrier B-1 and Toner B-2, images were formed and evaluated in the same manner as Example B-1. Main properties of developer such as circularity of toner, volume resistivity of carrier, coating rate, D/h, and magnetic moment are shown in Table B-1 and evaluation results are shown in Table B-2.

### Method to Evaluate Toner and Evaluation Result

The resulting toners were measured in terms of volume average particle diameter (Dv), number average particle diameter (Dn), particle diameter distribution Dv/Dn, average circularity, shape factor SF-1, and cleaning property as follows.

Dv and Dn were measured by use of a particle size analyzer Multisizer III (by Beckman Coulter Co.) at aperture diameter 100 μm. Dv/Dn was calculated from the result.

In the present invention, toners of super-fine particles were measured by use of a flow-type particle image analyzer FPIA-2100 (by Sysmex Co.) and analyzed by use of an analysis software FPIA-2100 Data Processing program for FPIA version 00-10. Specifically, into a 100 mL glass beaker, 0.1 to 0.5 mL of a 10% surfactant (alkylbenzene sulfonate Neogen SC-A, by Daiichi Kogyo Seiyaku Co.) was added, then 0.1 to 0.5 g of each toner was added thereto and stirred with Microspartel, and 80 mL of deionized water was poured into the beaker. The resulting dispersion was dispersed in an ultrasonic dispersing device (by Honda Electronics Co.) for 3 minutes. The dispersion was measured with respect to toner shape and distribution in a concentration of 5,000 to 15,000/μL using the FPIA-2100. It is important for the measurement that the concentration of the toner sample is 5,000 to 15,000/μL from the viewpoint of repeatability to measure the average circularity.

In order to adjust the concentration of the dispersion, the conditions of the dispersion such as amount of the surfactants and amount of the toners are required to adjust. The adequate amount of the surfactants depends on the hydrophobicity of toners similarly as the measurement of particle diameter of toners, excessively large amount leads to noise due to bubbles, and excessively small amount leads to insufficient dispersibility because of insufficient wettability with toners. The amount of toners also depends on particle diameters, i.e. it is necessary that the amount is smaller for smaller particle diameters and larger for larger particle diameters. When the particle diameter of toners is 3 to 7 μm, the concentration of dispersion can be adjusted to 5,000 to 15,000/μL by adding toners in an amount of 0.1 to 0.5 g.

SF-1 was measured as follows. After vapor-depositing a toner, 100 or more of toner particles were observed by use of super-high resolution FE-SEM S-5200 (by Hitachi Co.) at an accelerating voltage of 2.5 keV. Then SF-1 was calculated by use of Luzex AP image analyzer and an image processing software (by Nireco Co.).

TABLE B-1

| | | | | carrier | | | |
|---|---|---|---|---|---|---|---|
| | | | | | coating rate | | |
| | | | | | on surface | | |
| | | | | volume | of core | | magnetic |
| | | | toner | resistivity | material | | moment |
| | carrier | toner | circularity | (log ohm · cm) | (%) | D/h | (Am²/kg) |
| Ex. 1 | 1 | 1 | 0.955 | 13.9 | 63 | 1.3 | 68 |
| Ex. 2 | 2 | 1 | 0.955 | 13.1 | 83 | 1.3 | 68 |
| Ex. 3 | 3 | 1 | 0.955 | 13.1 | 83 | 1.9 | 68 |
| Ex. 4 | 4 | 1 | 0.955 | 9.5 | 83 | 0.4 | 68 |
| Ex. 5 | 5 | 1 | 0.955 | 16.5 | 73 | 0.9 | 68 |
| Ex. 6 | 6 | 1 | 0.955 | 12.7 | 61 | 0.9 | 66 |
| Ex. 7 | 7 | 1 | 0.955 | 14.5 | 95 | 0.6 | 69 |
| Ex. 8 | 8 | 1 | 0.955 | 13.9 | 82 | 0.9 | 35 |
| Ex. 9 | 9 | 1 | 0.955 | 14.1 | 83 | 0.9 | 93 |
| Ex. 10 | 10 | 1 | 0.955 | 13.5 | 43 | 1.1 | 69 |
| Com. Ex. 1 | 11 | 1 | 0.955 | 12.9 | — | — | 68 |
| Com. Ex. 2 | 1 | 2 | 0.975 | 13.9 | 63 | 1.3 | 68 |

TABLE B-2

| | initial evaluation | | | | | durability (23.5° C., 60% RH) after 300,000 sheets | | | | |
|---|---|---|---|---|---|---|---|---|---|---|
| | | carrier adhesion | | cleaning | color | | | carrier adhesion | | |
| | | | white | evaluation | smear | | | | white | |
| | | | void | after | after | amount of | amount of | | void | |
| | image | edge | (image | 100,000 | 30,000 | charge | resistance | edge | (image | image |
| | density | portion | portion) | sheets | sheets | decrease | change | portion | portion) | density |
| Ex. 1 | A | A | A | A | A | 5 | 1.5 | A | A | A |
| Ex. 2 | A | A | A | A | A | 6 | 1.2 | A | A | A |
| Ex. 3 | A | A | A | A | A | 4 | 3.8 | A | A | A |
| Ex. 4 | A | C | A | A | A | 9 | 1.1 | A | A | A |
| Ex. 5 | A | C | A | A | A | 3 | 1.2 | B | A | A |
| Ex. 6 | A | B | A | A | A | 4 | 1.2 | A | A | A |
| Ex. 7 | A | A | A | A | A | 7 | 3.6 | A | A | A |
| Ex. 8 | A | B | A | A | A | 4 | 1.3 | B | A | A |
| Ex. 9 | B | A | A | A | A | 8 | 2.8 | A | A | B |
| Ex. 10 | A | A | A | A | A | 8 | 3.4 | A | B | A |
| Com. Ex. 1 | A | A | A | A | B | — | — | — | — | — |
| Com. Ex. 2 | A | A | A | B | — | — | — | — | — | — |

### Evaluation Result

The results of Table B-2 demonstrate that Examples B-1 to B-10 of the present invention are far from color smear due to carriers and bring about excellent results in terms of every evaluation items such as image density, carrier adhesion, amount of charge decrease, and amount of resistance change. The toners in Examples represent superior cleaning property for a long period from initial stage.

In contrast, the toner of Comparative Example B-1 generated color smear and was inadequate for practical use. The toner of Comparative Example B-2 occurred inferior cleaning property from initial stage and was impossible to evaluate for a long time.

As described above, the technologies for forming images using the developers shown in Examples can result in high quality images stably for a long period.

While Examples of the present invention have been illustrated specifically above, it is to be understood that the present invention is in no way limited to Examples. Additions, omissions, substitutions, and other modifications can be made thereto without departing from the spirit or scope of the present invention.

What is claimed is:

1. A toner for developing electrostatic image, comprising particles of oil phase containing at least a toner composition and/or toner composition precursor in an aqueous medium, wherein the toner composition and/or toner composition precursor comprises an organic-modified layered inorganic mineral prepared by modifying at least partially an ion of a layered inorganic mineral into an organic ion, and the organic ion-modification ratio X satisfies the relation of 100<X(%)≦150 in the organic-modified layered inorganic mineral.

2. The toner for developing electrostatic image according to claim 1, wherein the oil phase comprises a kneaded mixture of the organic-modified layered inorganic mineral and a binder resin.

3. The toner for developing electrostatic image according to claim 1, wherein the oil phase comprises an organic solvent.

4. A toner for developing electrostatic image,
wherein the toner is produced by way of dissolving or dispersing at least a polymer having a site capable of reacting with a compound having an active hydrogen group, a binder resin, a colorant, a releasing agent, and a kneaded mixture of an organic-modified layered inorganic mineral, prepared by modifying at least partially an ion of a layered inorganic mineral into an organic ion, and a binder resin in an organic solvent, dispersing the solution or dispersion in an aqueous medium containing resin fine particles, and removing the organic solvent while or after reacting the polymer having a site capable of reacting with the compound having an active hydrogen group, then rinsing and drying,
wherein the organic ion-modification ratio X satisfies the relation of 100<X(%)≦150 in the organic-modified layered inorganic mineral.

5. The toner for developing electrostatic image according to claim 1, wherein the toner has a shape factor SF-1 of 110 to 200 and a shape factor SF-2 of 110 to 300.

6. The toner for developing electrostatic image according to claim 1, wherein the content of the organic-modified layered inorganic mineral is 0.1% to 5% by mass in the toner for developing electrostatic image.

7. The toner for developing electrostatic image according to claim 1, wherein the organic ion for modifying the organic-modified layered inorganic mineral is a quaternary ammonium ion.

8. The toner for developing electrostatic image according to claim 1, wherein the toner for developing electrostatic image has a volume average particle diameter Dv of 3 μm to 7 μm.

9. The toner for developing electrostatic image according to claim 1, wherein the toner for developing electrostatic image has a ratio (volume average particle diameter Dv)/(number average particle diameter Dn) of 1.00 to 1.20.

10. The toner for developing electrostatic image according to claim 1, wherein content of particles having a particle diameter of no more than 2 μm is 1% to 10% by number.

11. The toner for developing electrostatic image according to claim 1, wherein the binder resin comprises a polyester resin.

12. The toner for developing electrostatic image according to claim 11, wherein content of the polyester resin is 50% to 100% by mass in the binder resin.

13. The toner for developing electrostatic image according to claim 11, wherein mass average molecular mass of THF soluble matter of the polyester resin is 1,000 to 30,000.

14. The toner for developing electrostatic image according to claim 11, wherein acid value of the polyester resin is 1.0 mgKOH/g to 50.0 mgKOH/g.

15. The toner for developing electrostatic image according to claim 11, wherein the polyester resin has a glass transition temperature of 35° C. to 65° C.

16. The toner for developing electrostatic image according to claim 1, wherein the polymer, having a site capable of reacting with a compound having an active hydrogen group, has a mass average molecular mass of 3,000 to 20,000.

17. The toner for developing electrostatic image according to claim 1, wherein the toner for developing electrostatic image has an acid value of 0.5 mgKOH/g to 40.0 mgKOH/g.

18. The toner for developing electrostatic image according to claim 1, wherein the toner for developing electrostatic image has a glass transition temperature of 40° C. to 70° C.

19. The toner for developing electrostatic image according to claim 1, wherein the toner for developing electrostatic image is used for a two-component developer.

20. A method for producing a toner for developing electrostatic image, comprising dispersing an oil phase containing at least a toner composition and/or toner composition precursor in an aqueous medium to form particles,
wherein the oil phase comprises a kneaded mixture of an organic-modified layered inorganic mineral and a binder resin, and
the organic ion-modification ratio X satisfies the relation of 100<X(%)≦150 in the organic-modified layered inorganic mineral.

21. A method for producing a toner for developing electrostatic image, comprising:
dissolving or dispersing at least a polymer having a site 20 capable of reacting with a compound having an active hydrogen group, a binder resin, a colorant, a releasing agent, and a kneaded mixture of an organic-modified layered inorganic mineral and a binder resin in an organic solvent,
dispersing the solution or dispersion in an aqueous medium containing resin fine particles, and
removing the organic solvent while or after reacting the polymer having a site capable of reacting with a compound having an active hydrogen group, then rinsing and drying,
wherein the organic ion-modification ratio X satisfies the relation of 100<X(%)≦150 in the organic-modified layered inorganic mineral.

22. An image forming method, comprising a transfer step to transfer a toner image on a toner image bearing member onto a transfer material and a cleaning step to clean the toner remaining on surface of the toner image bearing member after the transfer step by use of a blade,
wherein the toner is one for developing electrostatic image that comprises particles of oil phase containing at least a toner composition and/or toner composition precursor in an aqueous medium, the toner composition and/or toner composition precursor comprises an organic-modified layered inorganic mineral prepared by modifying at least partially an ion of a layered inorganic mineral into an organic ion, and the organic ion-modification ratio X satisfies the relation of 100<X(%)≦150 in the organic-modified layered inorganic mineral.

23. An image forming apparatus, comprising a transfer unit configured to transfer a toner image on a toner image bearing member onto a transfer material and a cleaning unit configured to clean the toner remaining on surface of the toner image bearing member after the transfer step by use of a blade,
wherein the toner is one for developing electrostatic image that comprises particles of oil phase containing at least a toner composition and/or toner composition precursor in an aqueous medium, the toner composition and/or toner composition precursor comprises an organic-modified layered inorganic mineral prepared by modifying at least partially an ion of a layered inorganic mineral into an organic ion, and the organic ion-modification ratio X satisfies the relation of 100<X(%)≦150 in the organic-modified layered inorganic mineral.

24. A process cartridge, equipped with ones selected from a toner bearing member, a charging unit, a developing unit, and a cleaning unit, constructing together with at least the toner bearing member and the developing unit, and being detachably attached to a main body of an image forming apparatus,
wherein the developing unit is provided with a toner, the toner is one for developing electrostatic image that comprises particles of oil phase containing at least a toner composition and/or toner composition precursor in an aqueous medium, the toner composition and/or toner composition precursor comprises an organic-modified layered inorganic mineral prepared by modifying at least partially an ion of a layered inorganic mineral into an organic ion, and the organic ion-modification ratio X satisfies the relation of 100<X(%)≦150 in the organic-modified layered inorganic mineral.
